(19) United States
(12) Patent Application Publication
(10) Pub. No.: US 2007/0150333 A1
(43) Pub. Date: Jun. 28, 2007

(54) Energy and chemical species utility management system

(76) Inventors: Roger Hurst, Houston, TX (US); Johan A. Kritzinger, The Woodlands, TX (US); Peter Allan, Houston, TX (US); Brent Ellison, Houston, TX (US); Ajay Khater, Houston, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 11/515,957

(22) Filed: Sep. 5, 2006

Related U.S. Application Data
(60) Provisional application No. 60/714,038, filed on Sep. 2, 2005.

(51) Int. Cl. G06F 9/44; G06F 17/50; G06F 17/30

(52) U.S. Cl. 705/10; 705/7

(57) ABSTRACT

A method for energy and chemical species utility management having an integrated software system and infrastructure arrangements configured to manage one or more levels of utilities operation, arranged in co-operative fashion to achieve collective goals.

### STATEMENT OF RELATED CASES

This application claims the benefit of U.S. Provisional Application No. 60/714,038, filed Sep. 2, 2005.

### FIELD OF THE INVENTION

The present invention relates generally to methods for technical and economic performance management of industrial plants and, more particularly, to management at one or more levels of utilities, energy, and chemical processing, where the levels comprise plants, across a plurality of plants, and interfaces to utilities markets.

### BACKGROUND OF THE INVENTION

Utilities operation (generation, distribution, and consumption) and plant design is common in industrial plants designed specifically for power generation as well as plants that are associated with product manufacture. Optimal utility operation at a plant may be influenced by many factors, including factors outside the immediate technical operation. Factors may include manufacture of product, contractual pricing, environmental objectives, or byproduct production. The problem is that optimization of outside factors may ignore individual efficiency differences. A further problem is that optimization of outside factors or local operation at one plant may cause suboptimal performance across a plurality of plants or suboptimal performance in providing utilities to a utilities grid. A further problem is that the typically small-generation-capacity of individual plants are not large or reliable enough to attract bargaining position in selling utilities to a grid. A further problem is that optimization of utilities generation requires knowledge of past performances of the plants and overall system and ability to apply such past knowledge to model current performance options, even though individual components and the system itself is constantly changing over time.

The present invention solves these problems and others by providing a methodology and integrated software system to optimize performance at one or more levels of utilities generation.

### BRIEF DESCRIPTION OF THE SEVERAL DRAWINGS

The present invention and its advantages will be better understood by referring to the following detailed description and the attached drawings.

FIG. 1 is a hierarchy chart showing an aspect of the present invention.

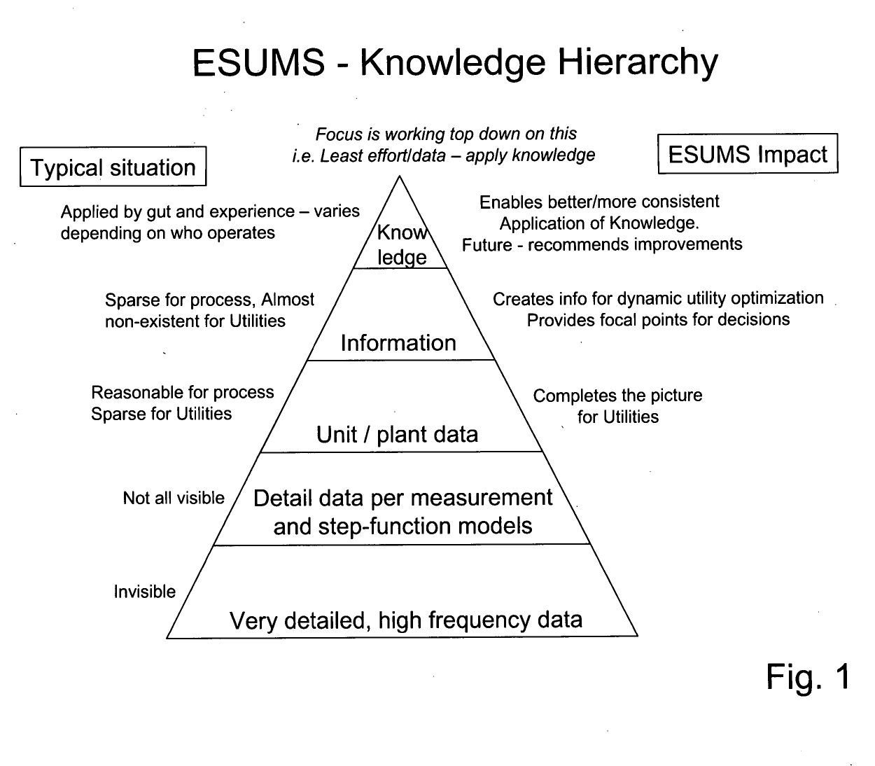

FIG. 2 is a hierarchy chart showing an aspect of the present invention.

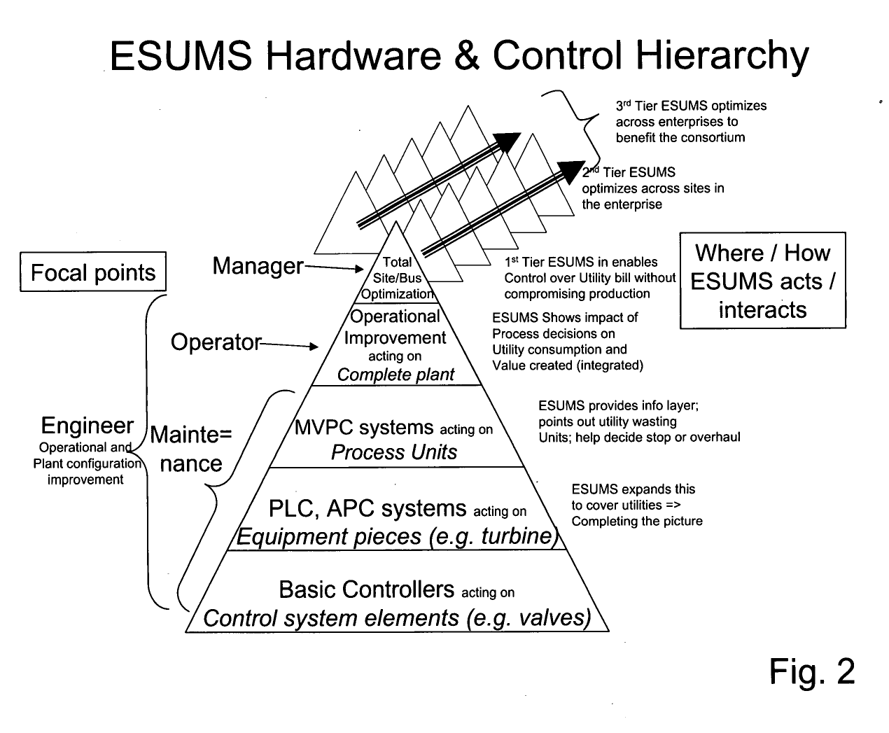

FIG. 3 is a schematic relationship chart showing an aspect of the present invention.

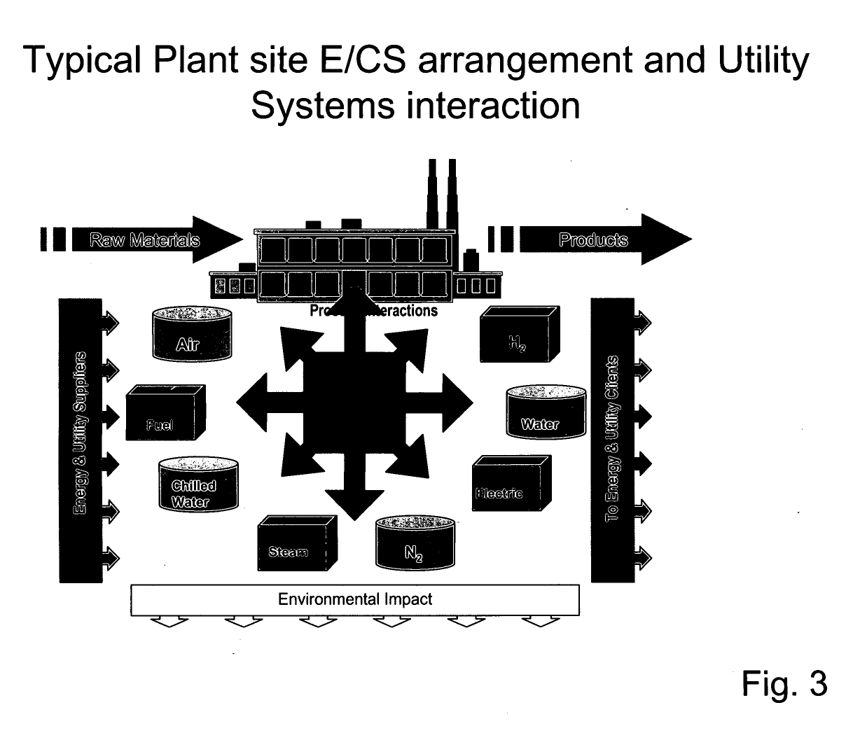

FIG. 4 is a hierarchy chart showing an aspect of the present invention.

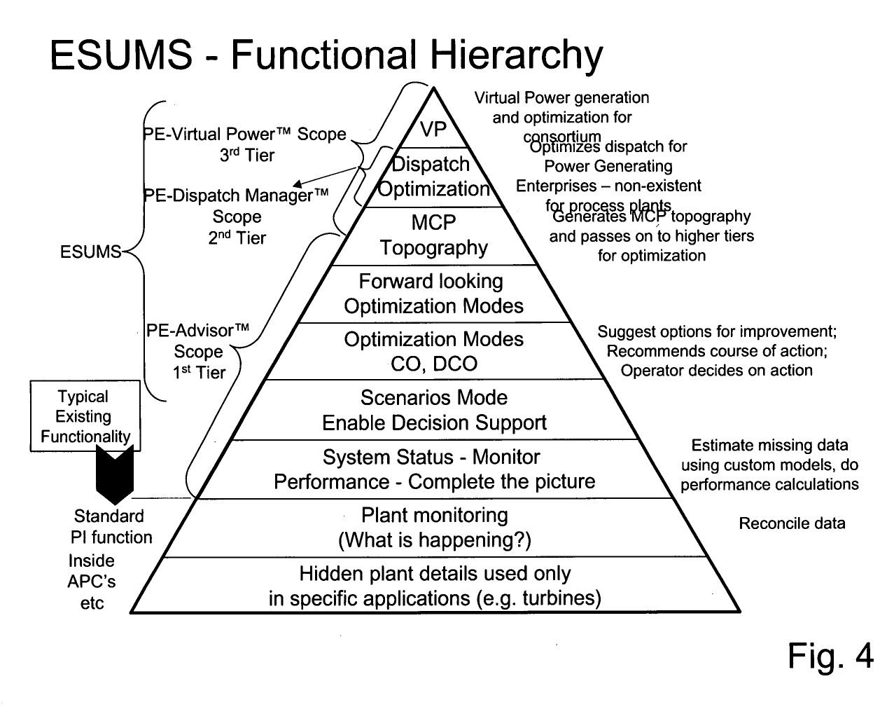

FIG. 5 is a schematic relationship chart showing an aspect of the present invention.

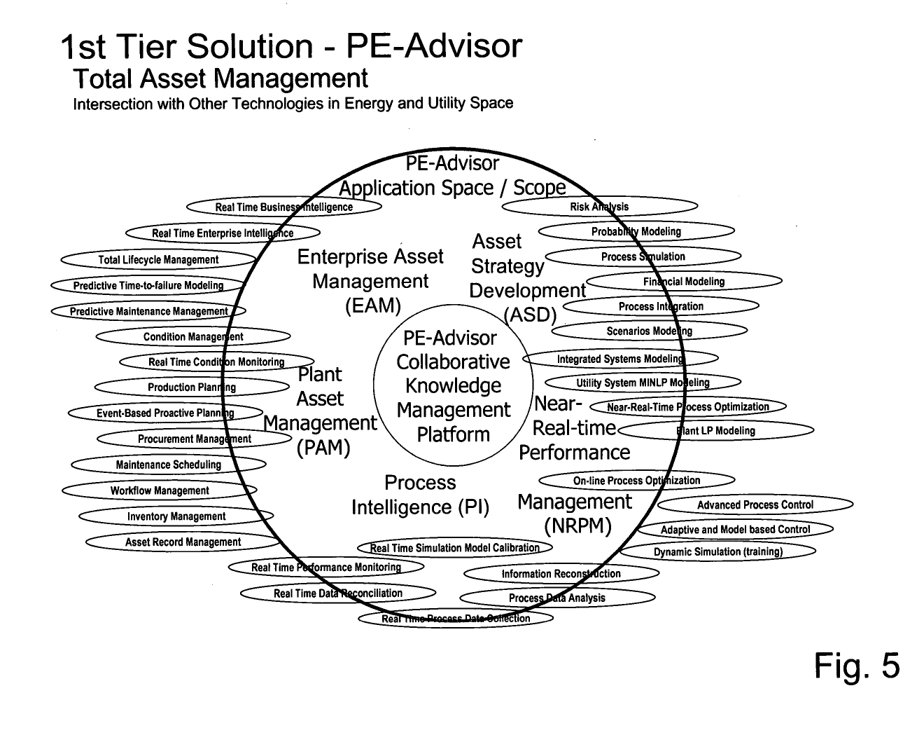

FIG. 6 is a schematic flow chart showing an aspect of the present invention.

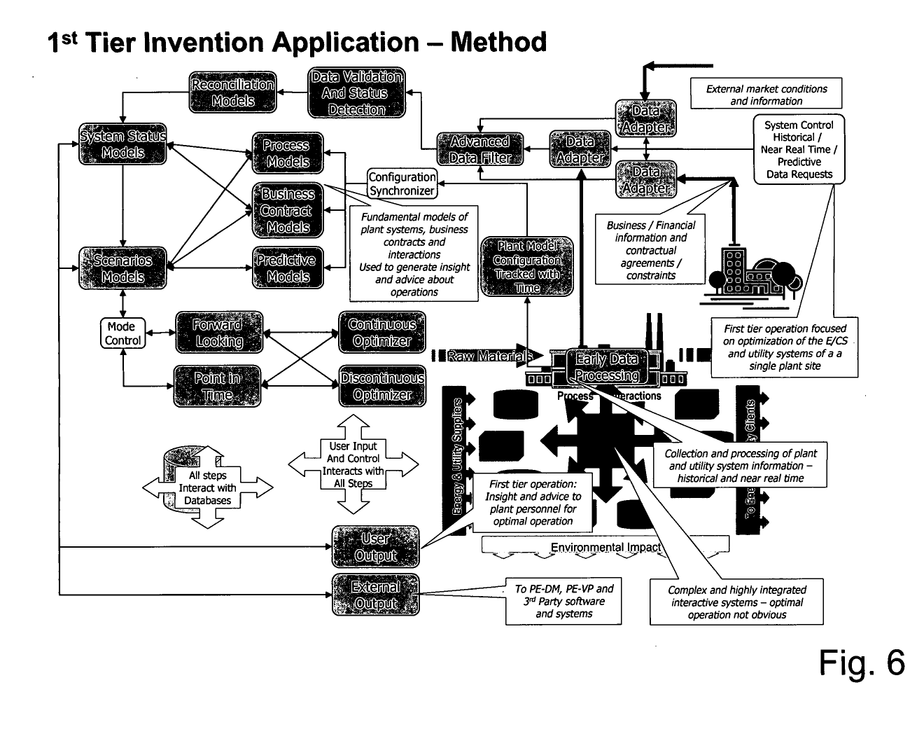

FIG. 7 is a schematic flow chart showing an aspect of the present invention.

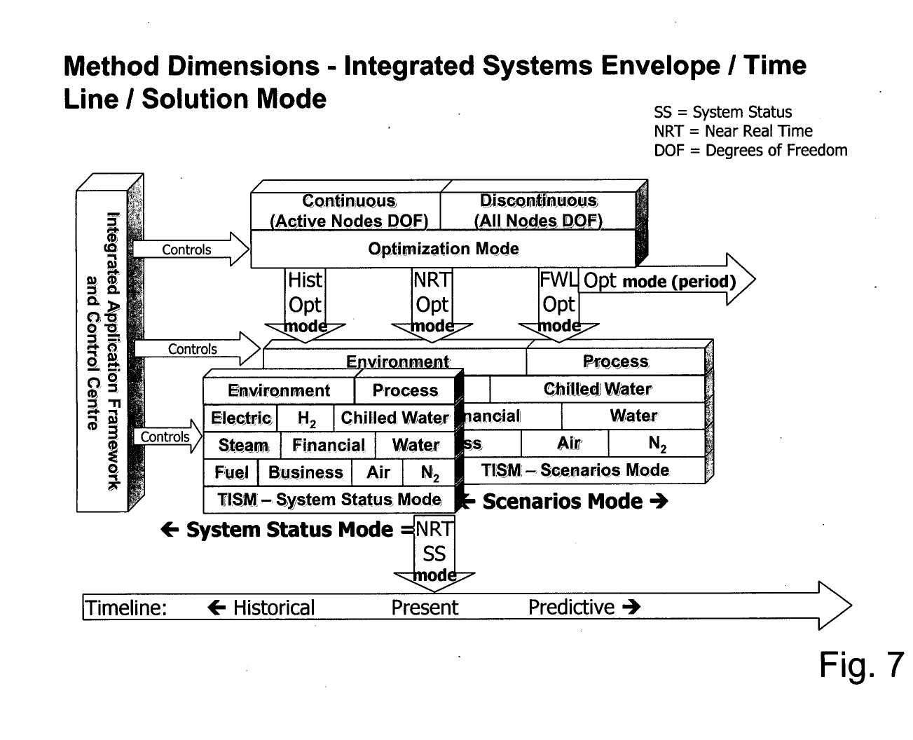

FIG. 8 is a tabular flow chart showing an aspect of the present invention.

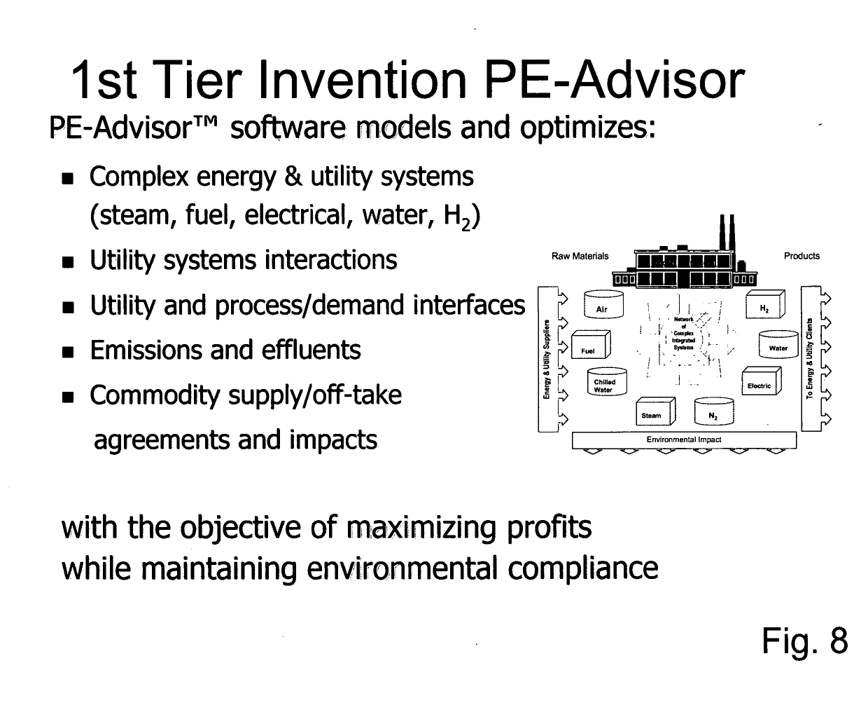

FIG. 9 is a schematic relationship chart showing an aspect of the present invention.

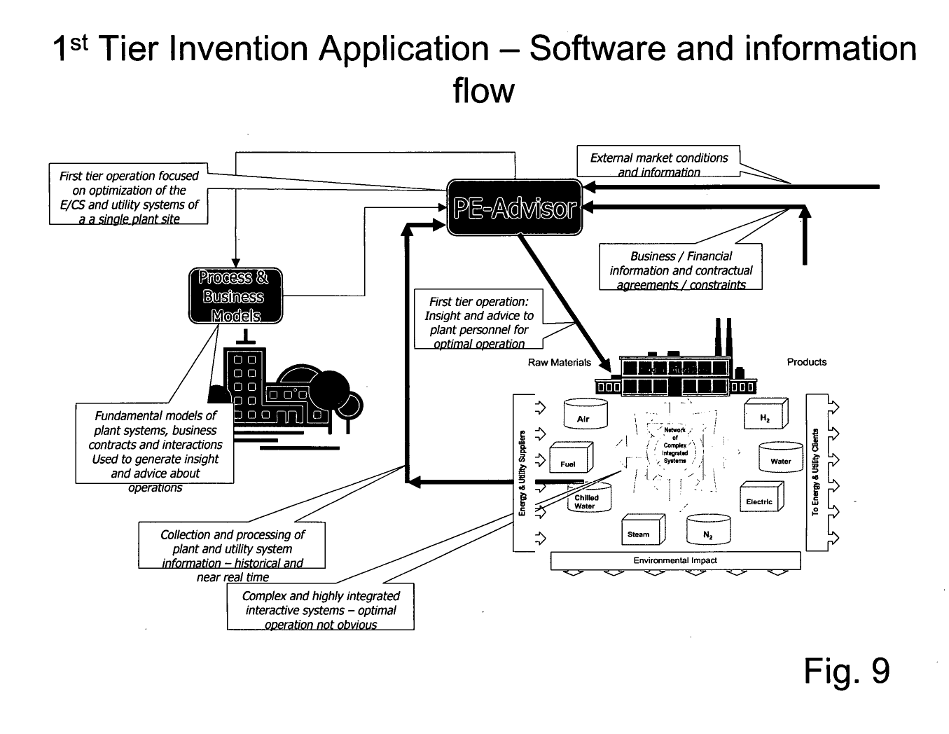

FIG. 10 is a schematic relationship chart showing an aspect of the present invention.

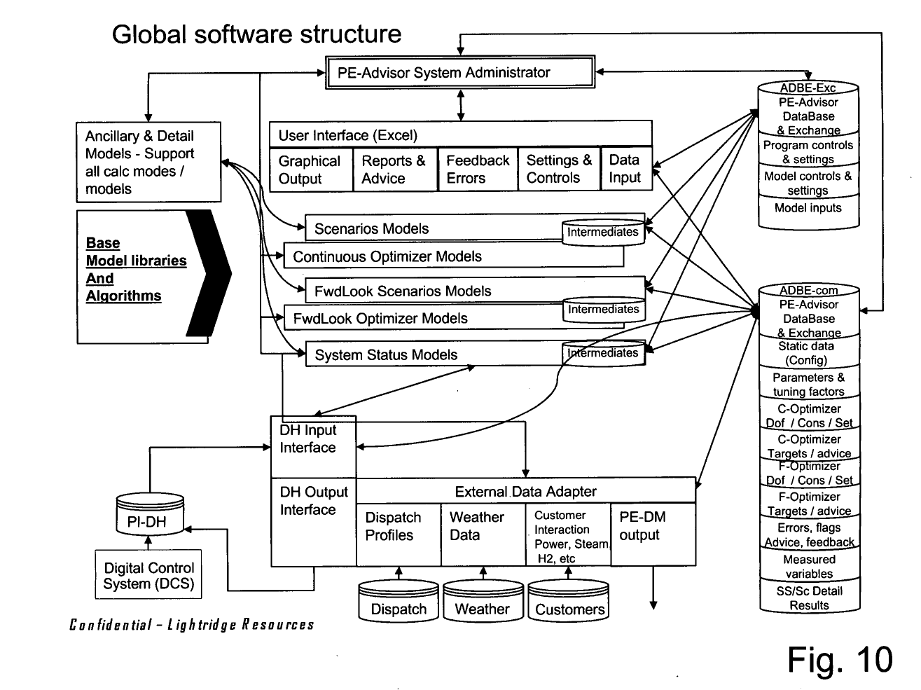

FIG. 11 is a schematic flow chart showing an aspect of the present invention.

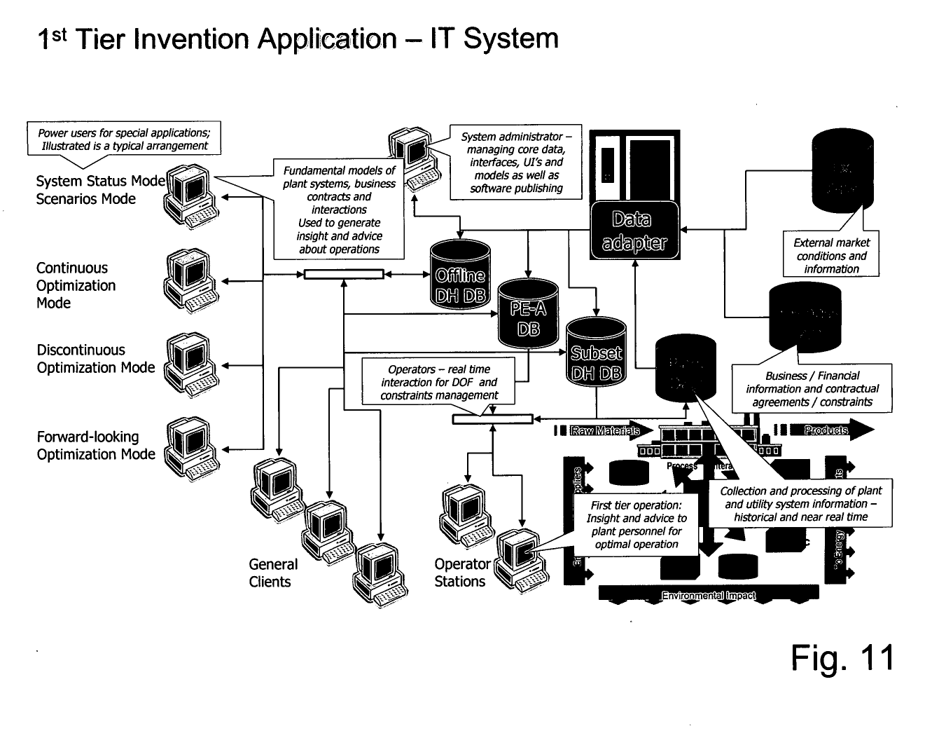

FIG. 12 is a schematic relationship chart showing an aspect of the present invention.

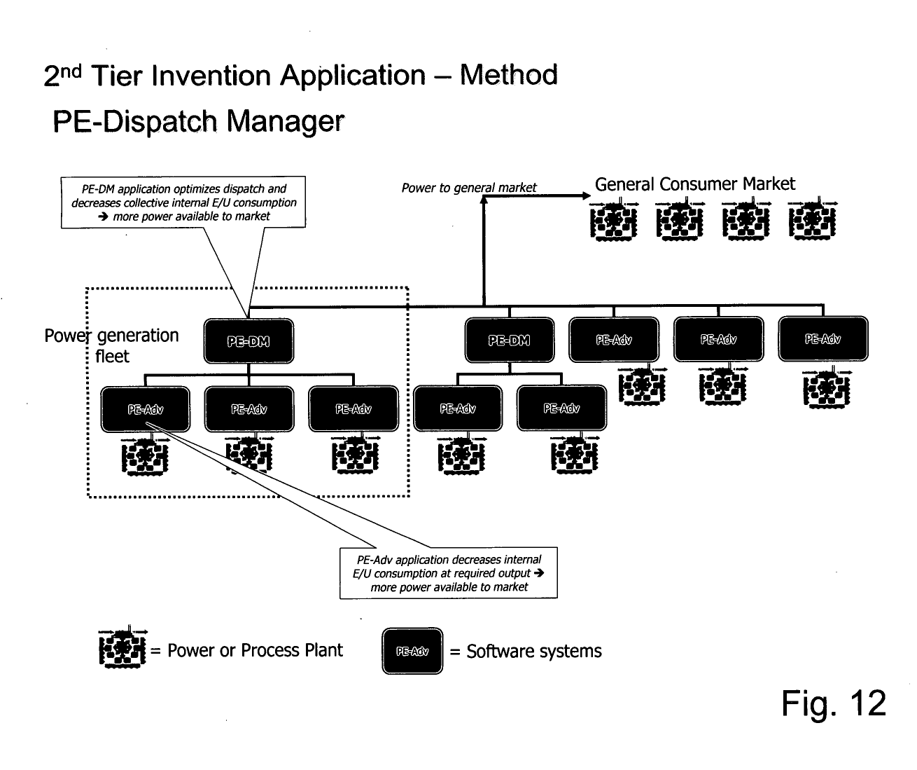

FIG. 13 is a schematic relationship chart showing an aspect of the present invention.

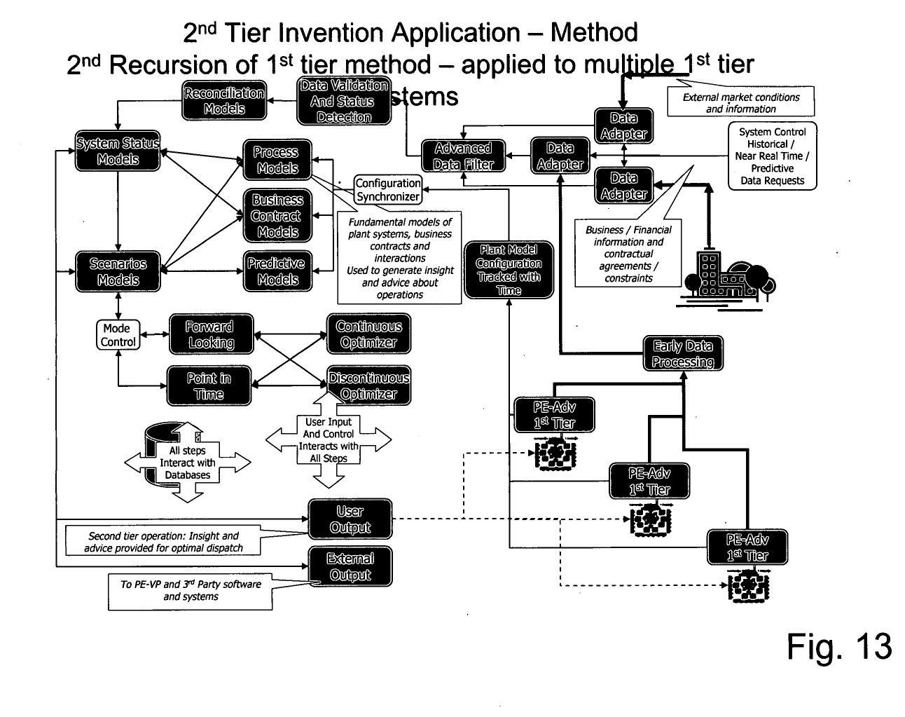

FIG. 14 is a schematic relationship chart showing an aspect of the present invention.

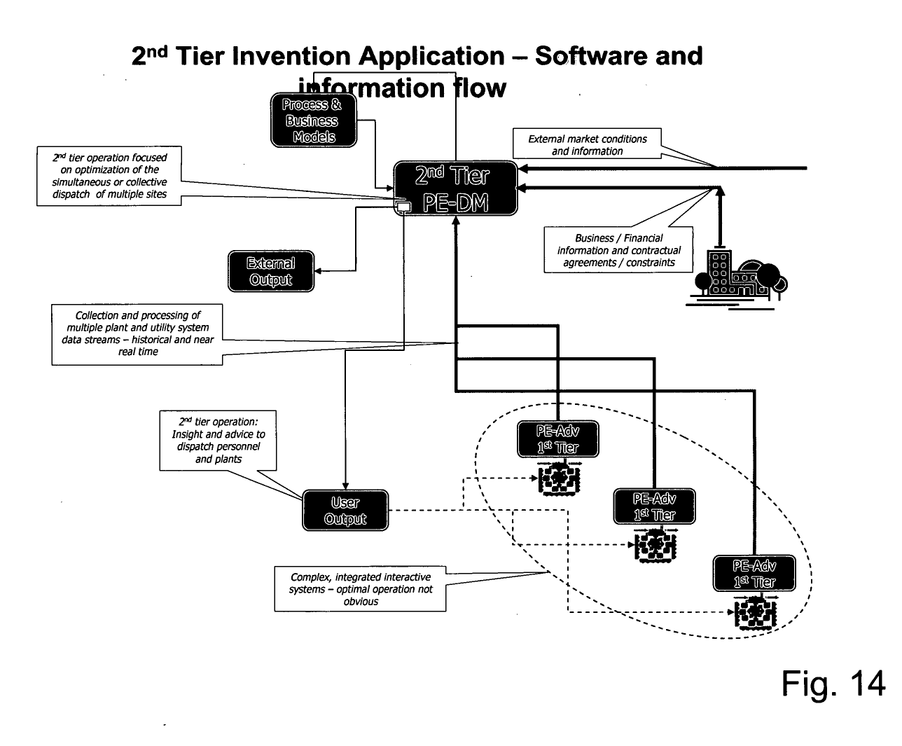

FIG. 15 is a schematic relationship chart showing an aspect of the present invention.

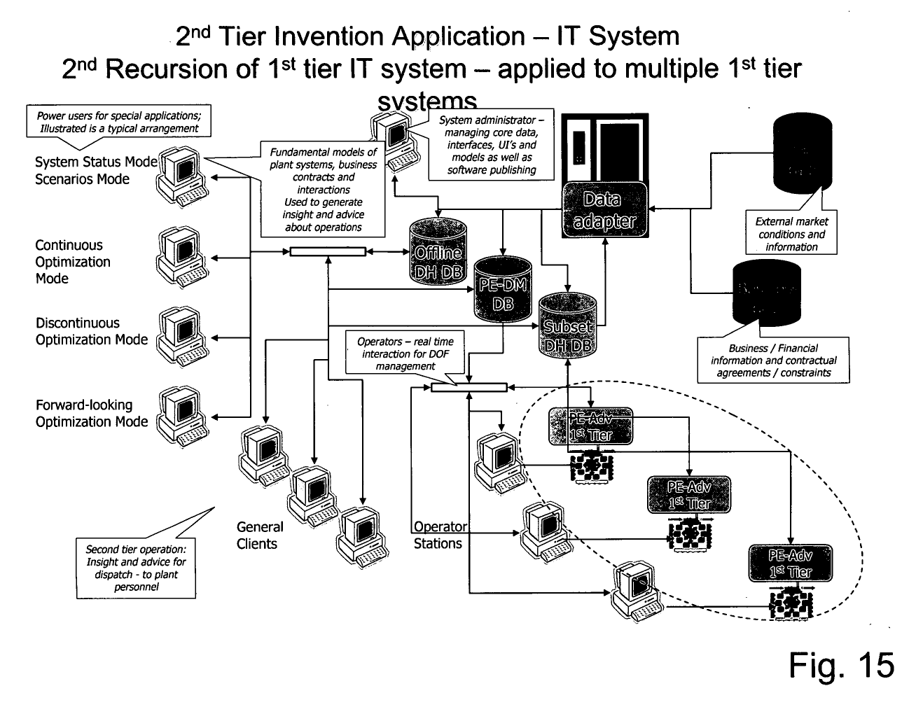

FIG. 16 is a multi-dimensional graph showing an aspect of the present invention.

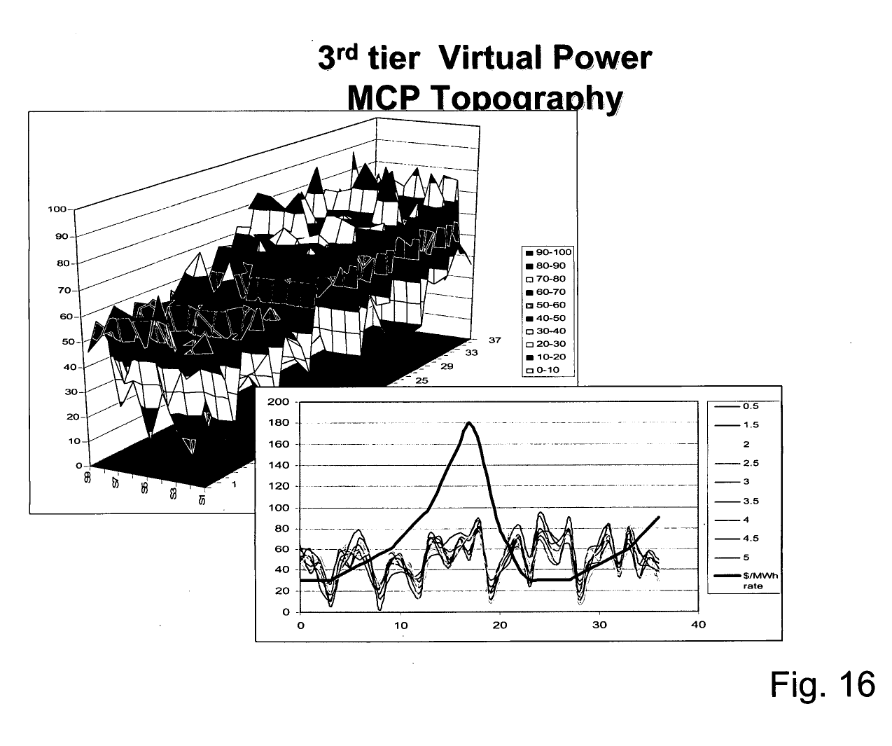

FIG. 17 is a schematic flow chart showing an aspect of the present invention.

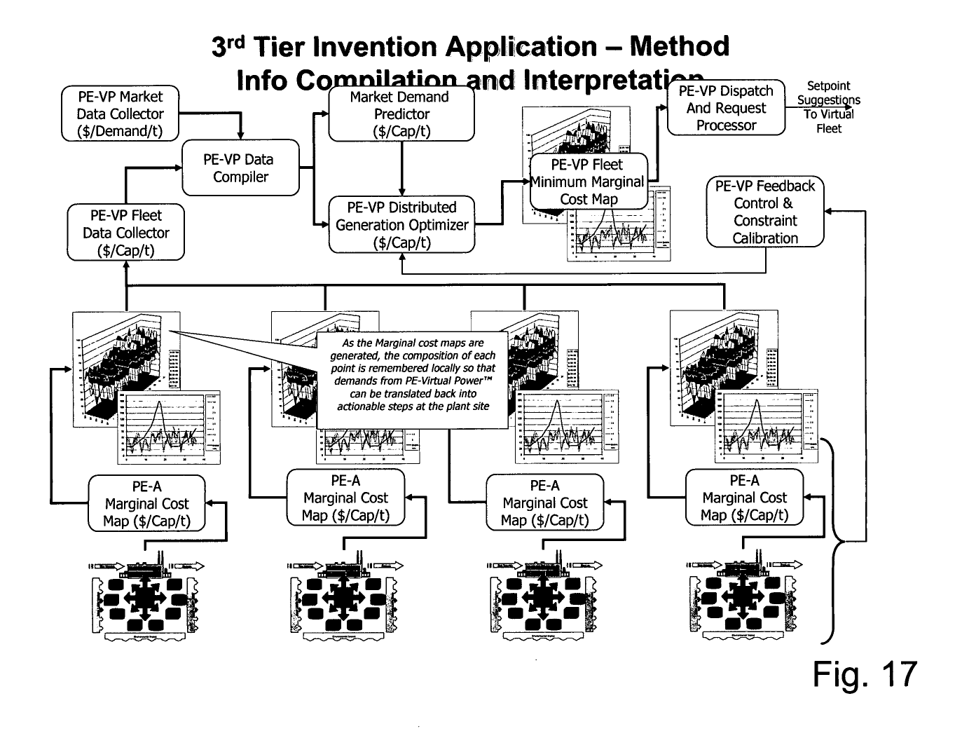

FIG. 18 is a schematic relationship chart showing an aspect of the present invention.

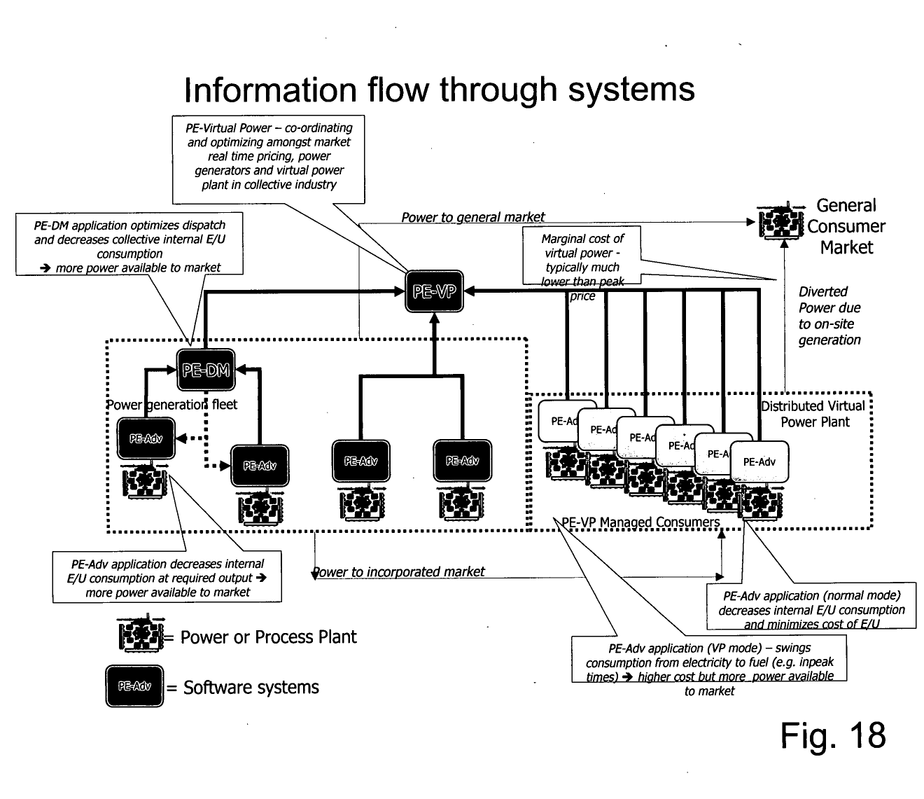

FIG. 19 is a schematic relationship chart showing an aspect of the present invention.

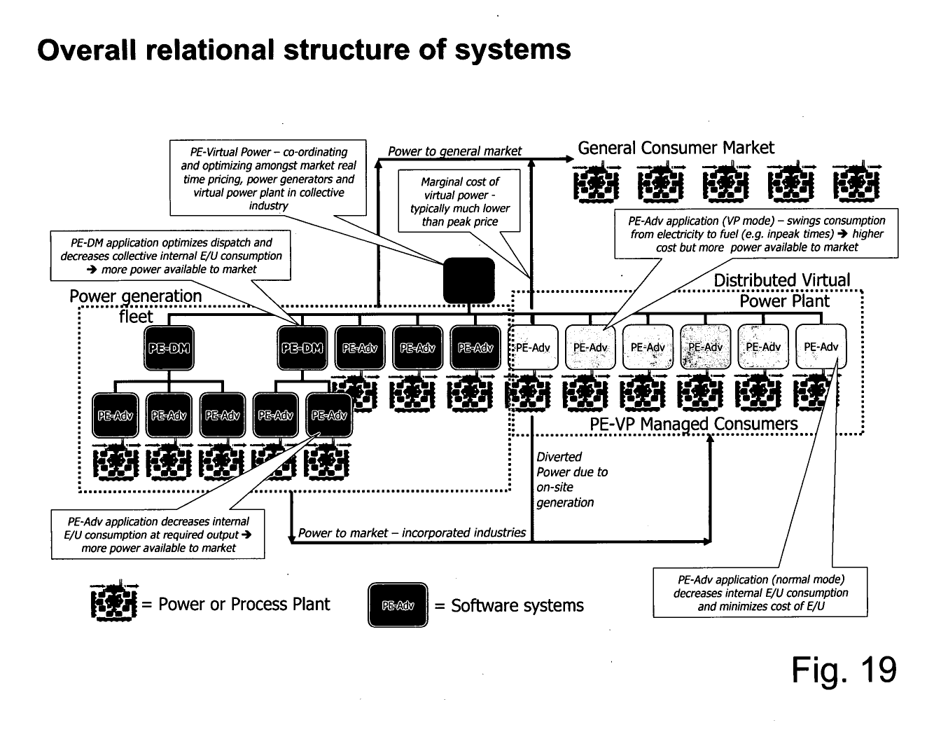

FIG. 20 is a schematic relationship chart showing an aspect of the present invention.

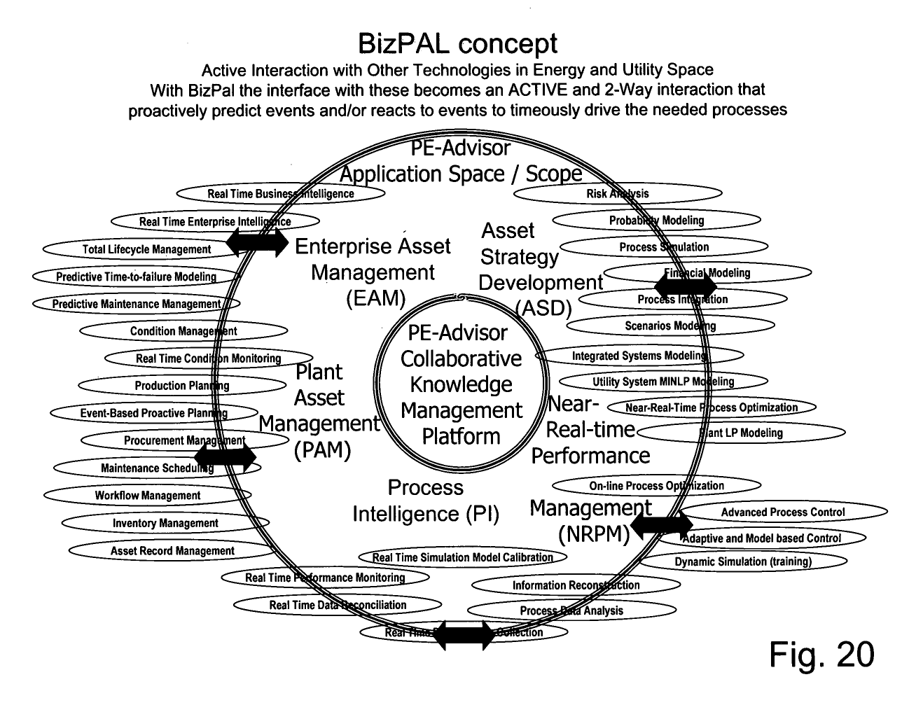

FIG. 21 is an output graph showing an aspect of the present invention.

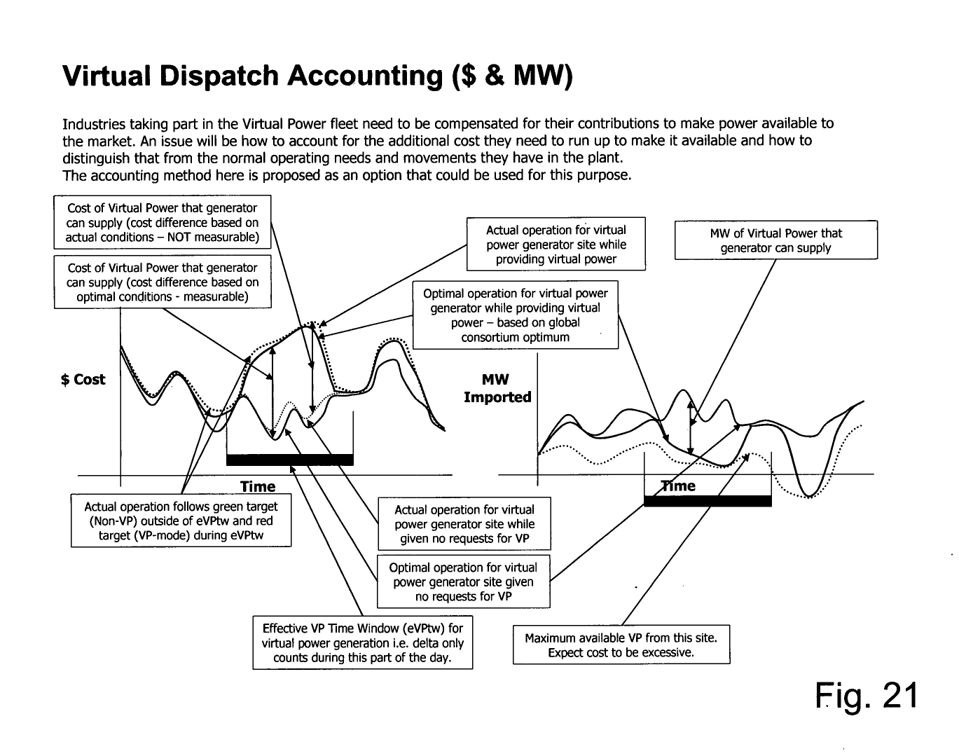

FIG. 22 is an output graph showing an aspect of the present invention.

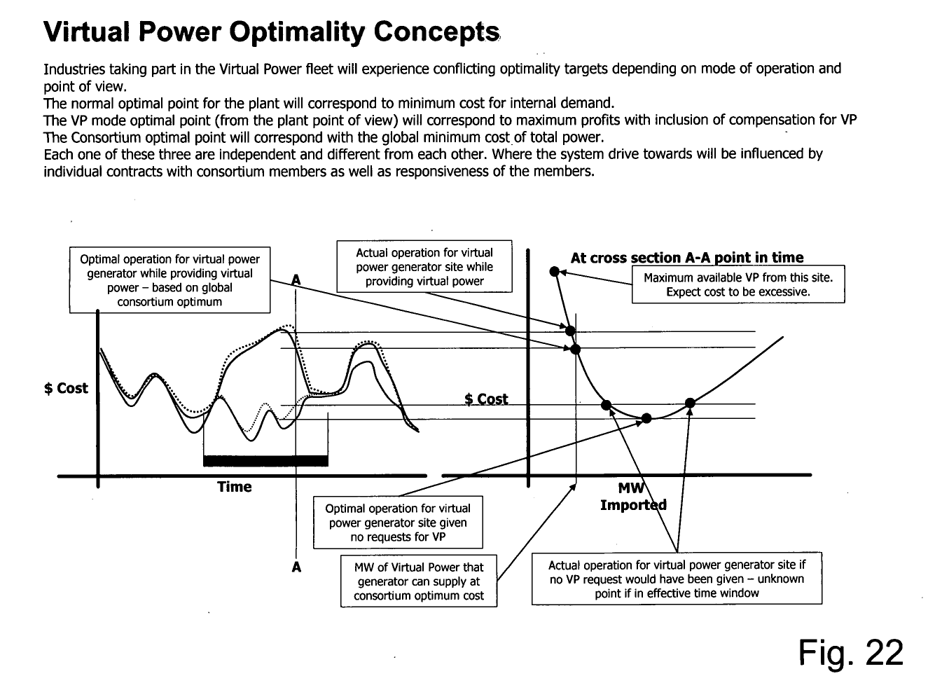

FIG. 23 is a schematic relationship chart showing an aspect of the present invention.

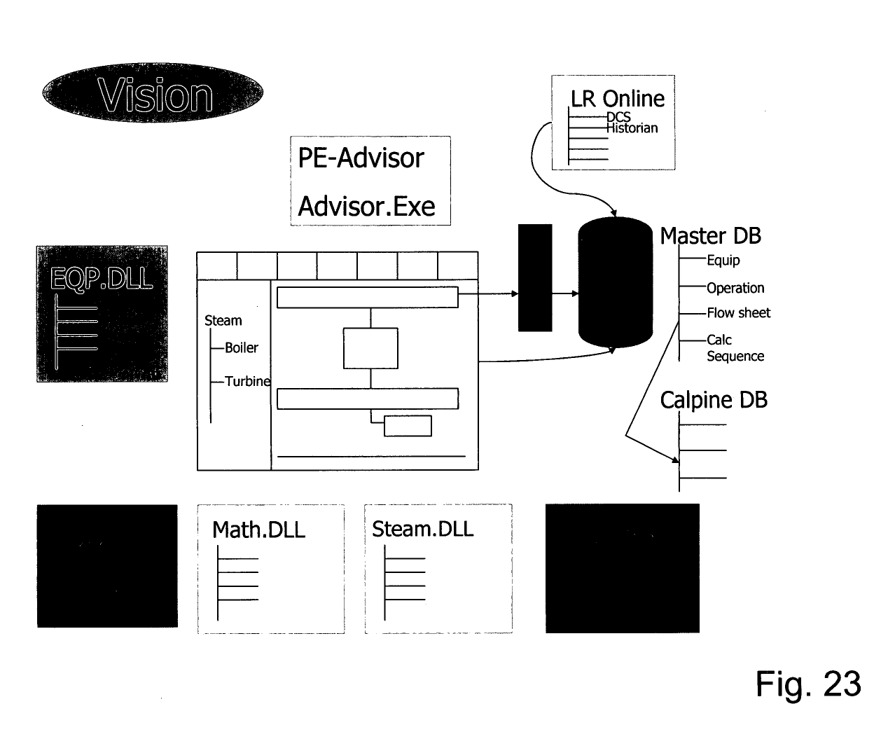

FIG. 24 is a schematic flow chart showing an aspect of the present invention.

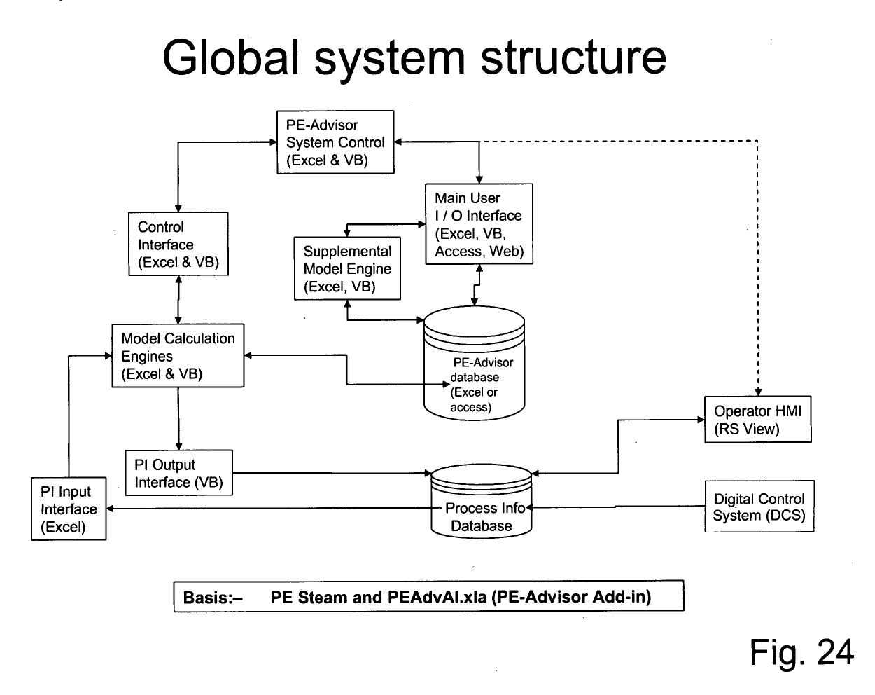

FIG. 25 is a schematic flow chart showing an aspect of the present invention.

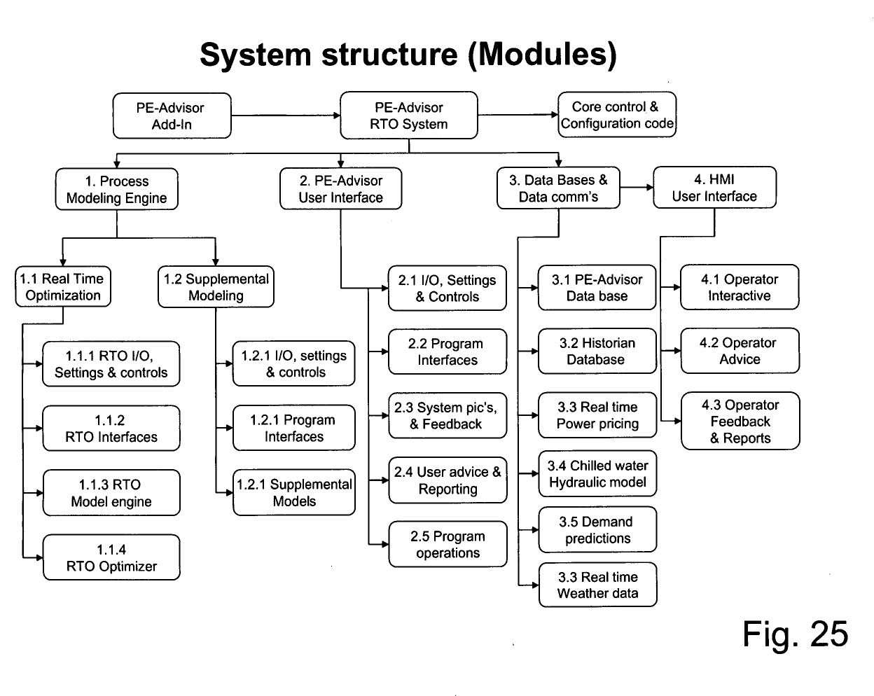

FIG. 26 is a schematic flow chart showing an aspect of the present invention.

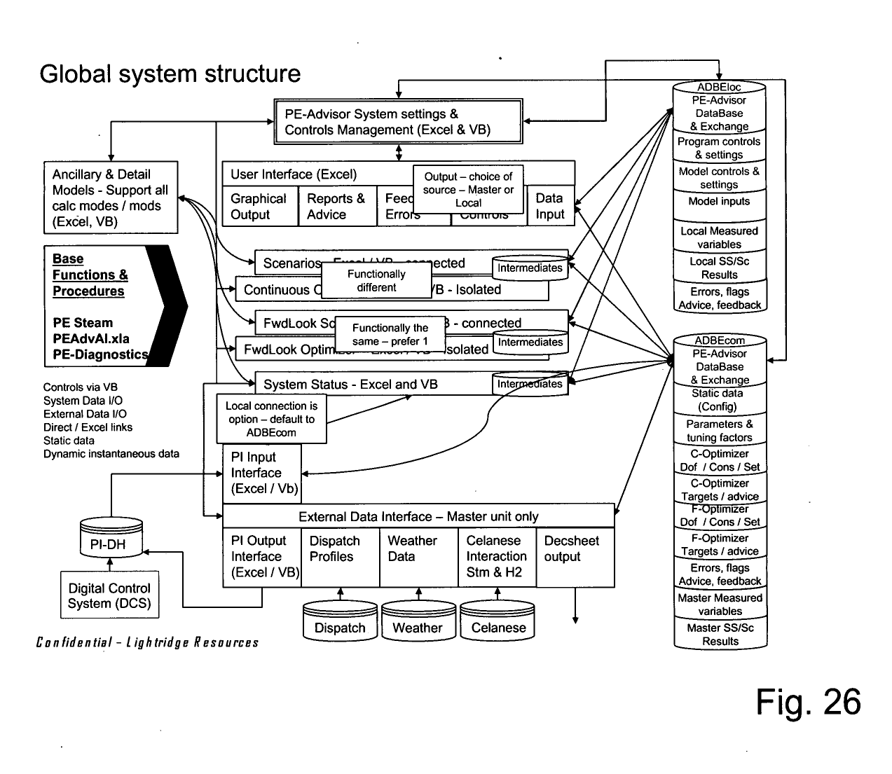

FIG. 27 is a flow chart showing an aspect of the present invention.

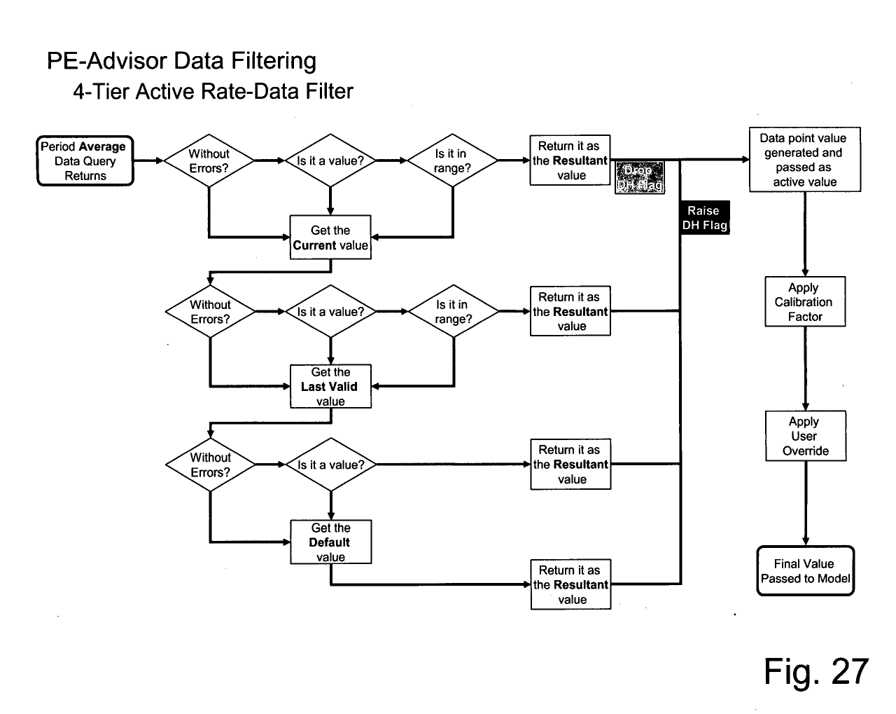

FIG. 28 is a flow chart showing an aspect of the present invention.

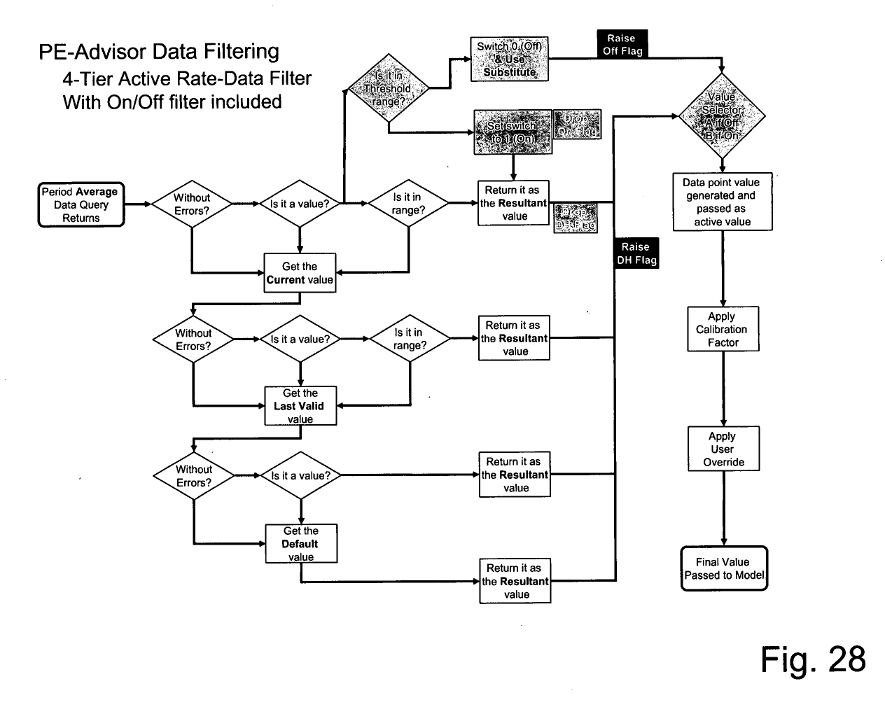

FIG. 29 is a flow chart showing an aspect of the present invention.

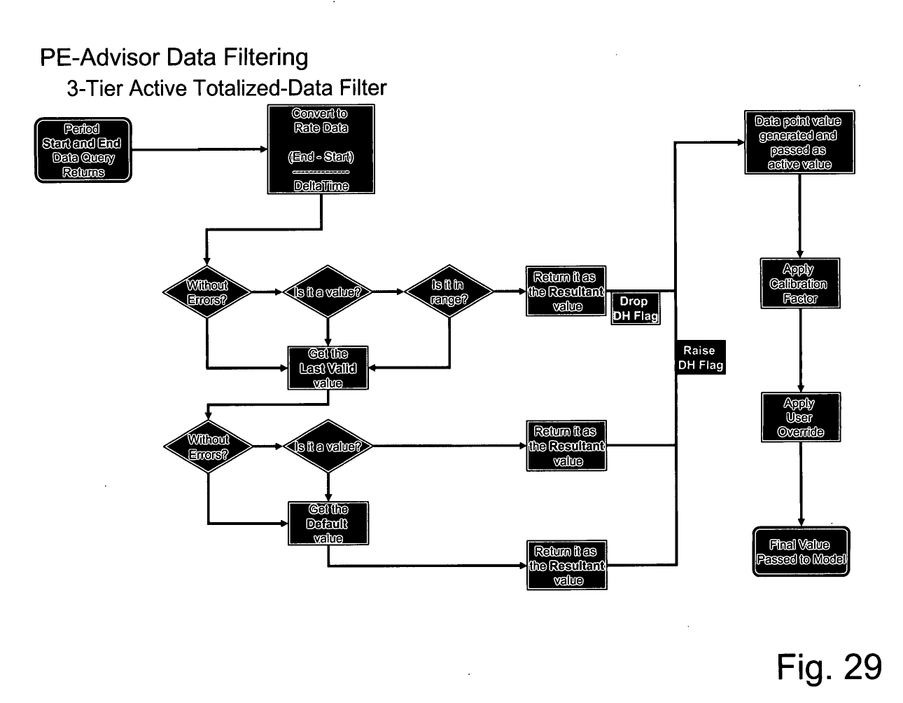

FIG. 30 is a flow chart showing an aspect of the present invention.

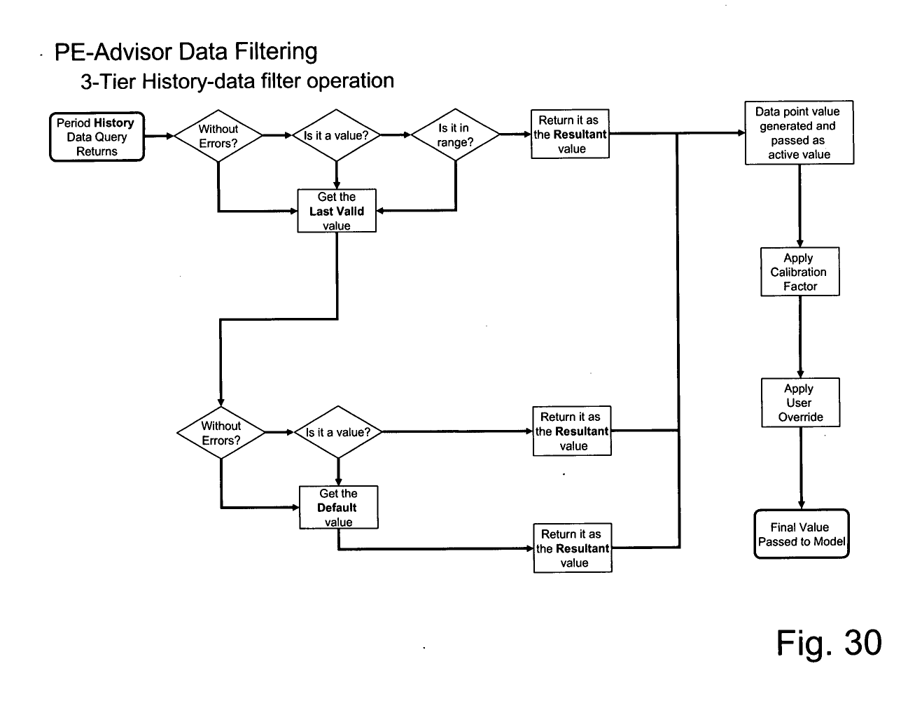

FIG. 31 is a schematic flow chart showing an aspect of the present invention.

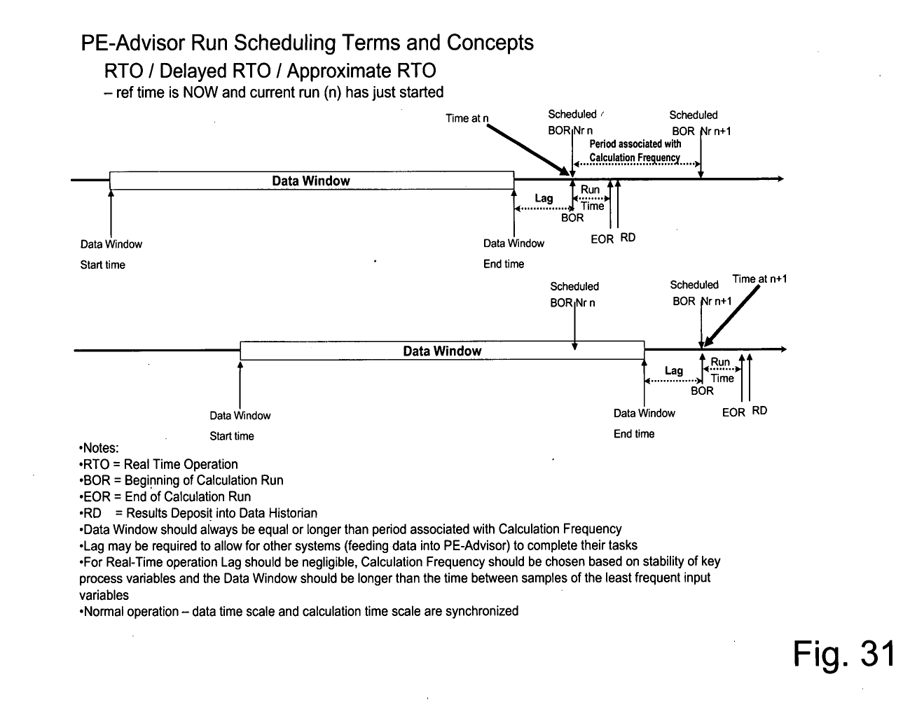

FIG. 32 is a schematic flow chart showing an aspect of the present invention.

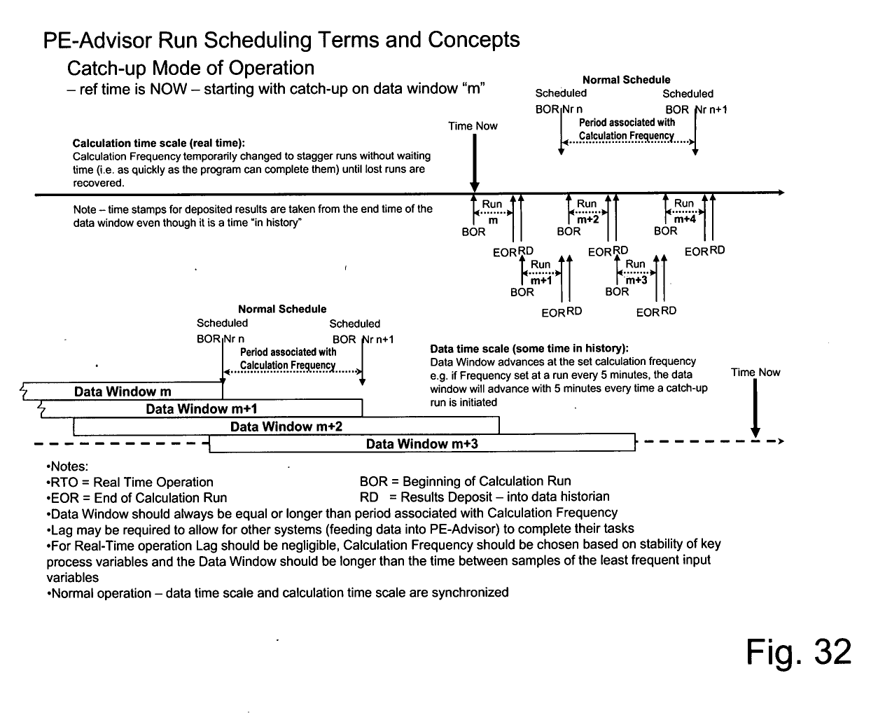

FIG. 33 is an output graph showing an aspect of the present invention.

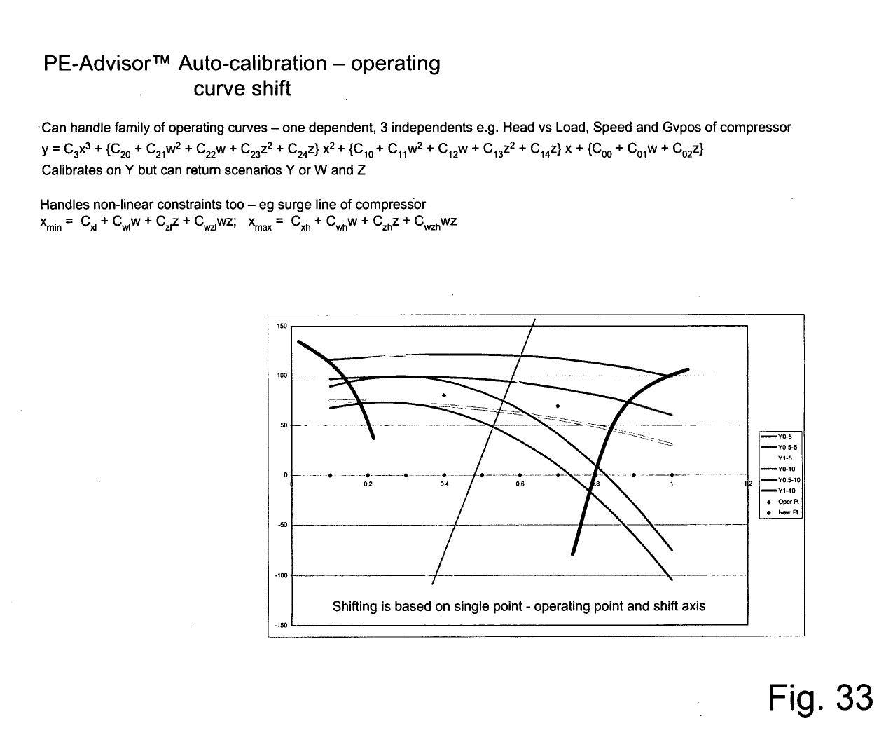

FIG. 34 is a flow chart showing an aspect of the present invention.

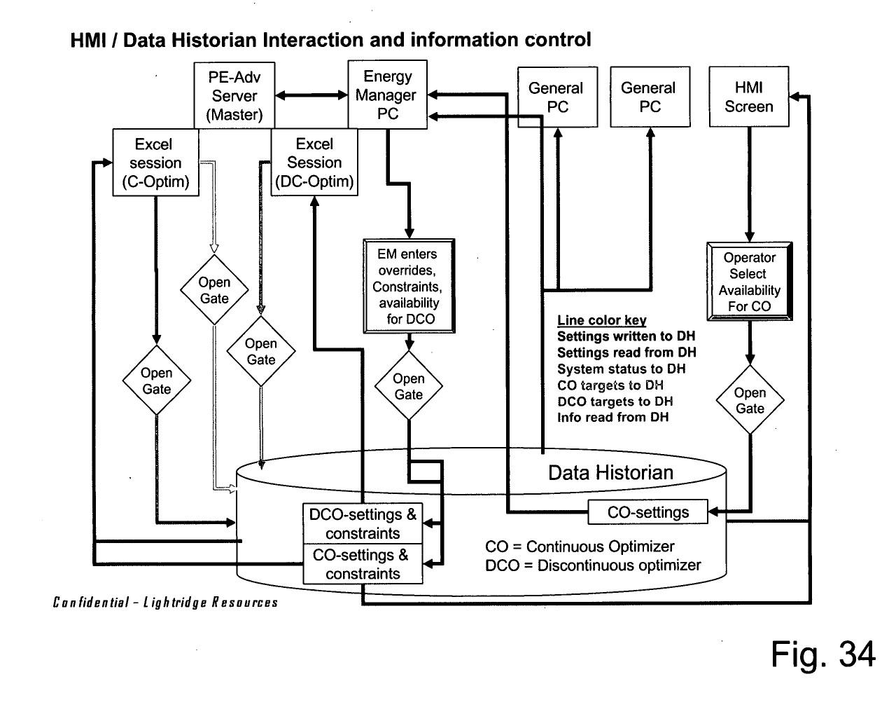

FIG. 35 is a flow chart showing an aspect of the present invention.

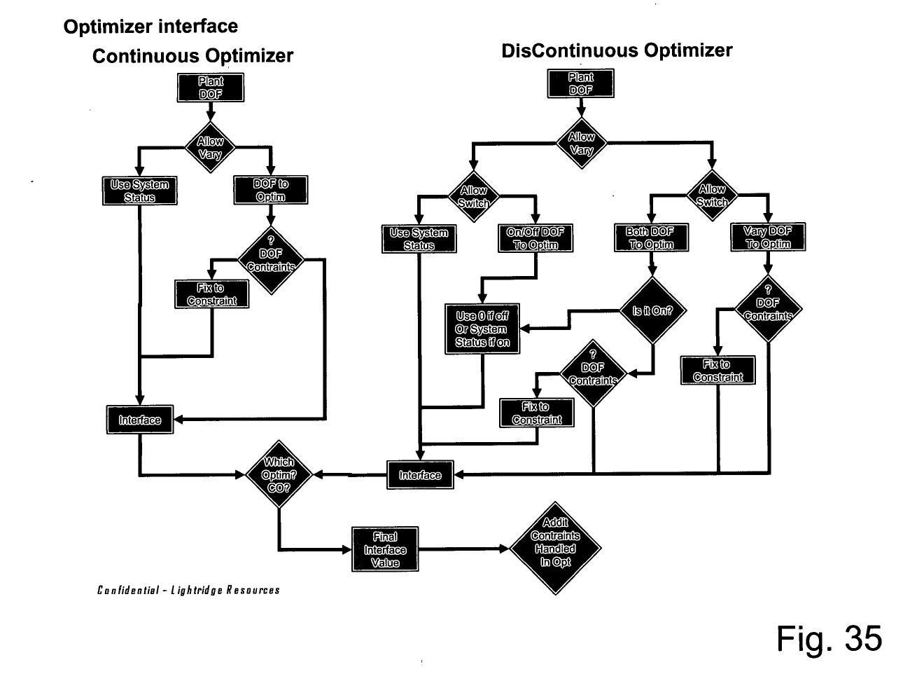

FIG. 36 is a flow chart showing an aspect of the present invention.

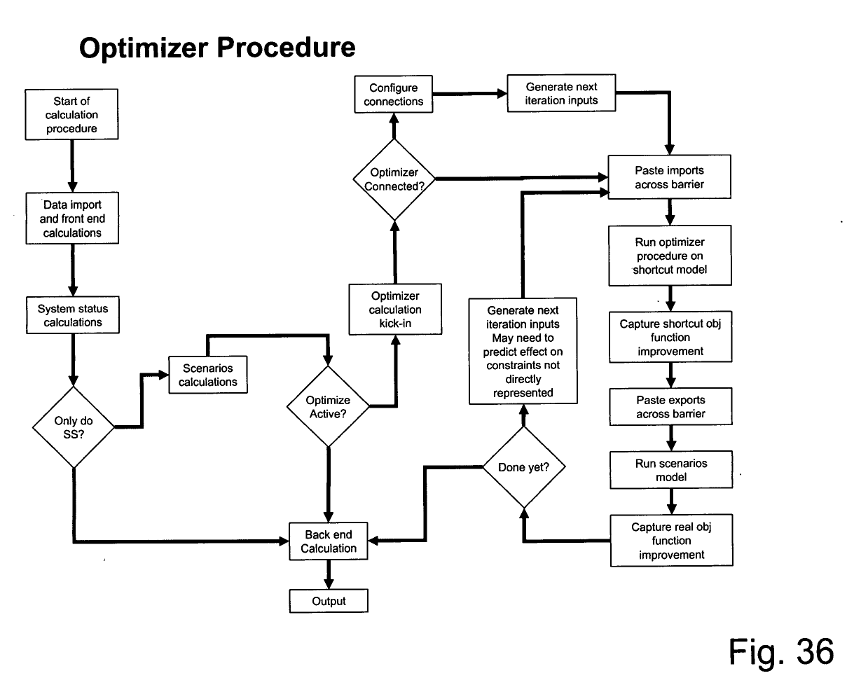

FIG. 37 is a schematic flow chart showing an aspect of the present invention.

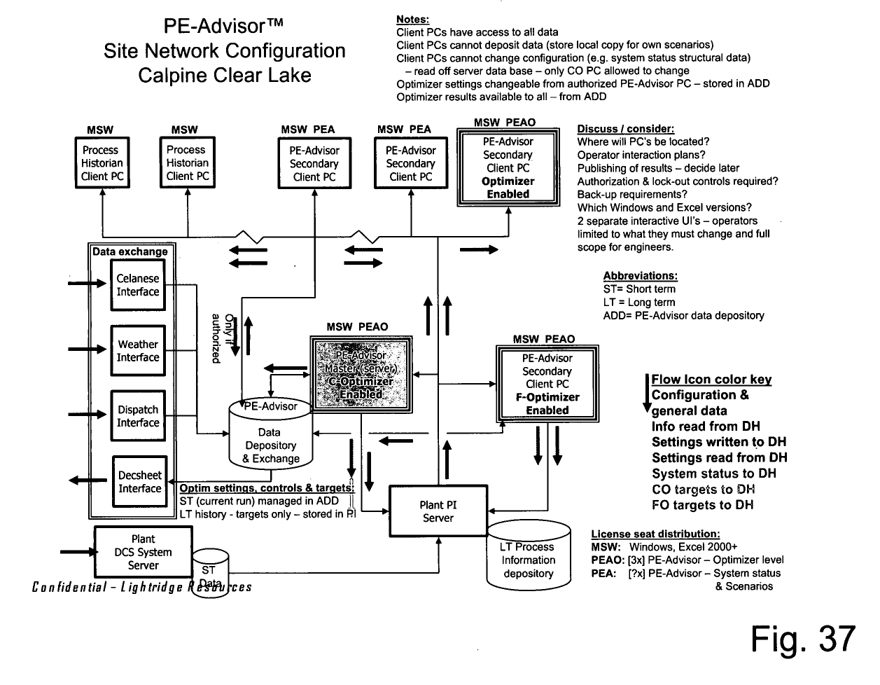

FIG. 38 is an output graph showing an aspect of the present invention.

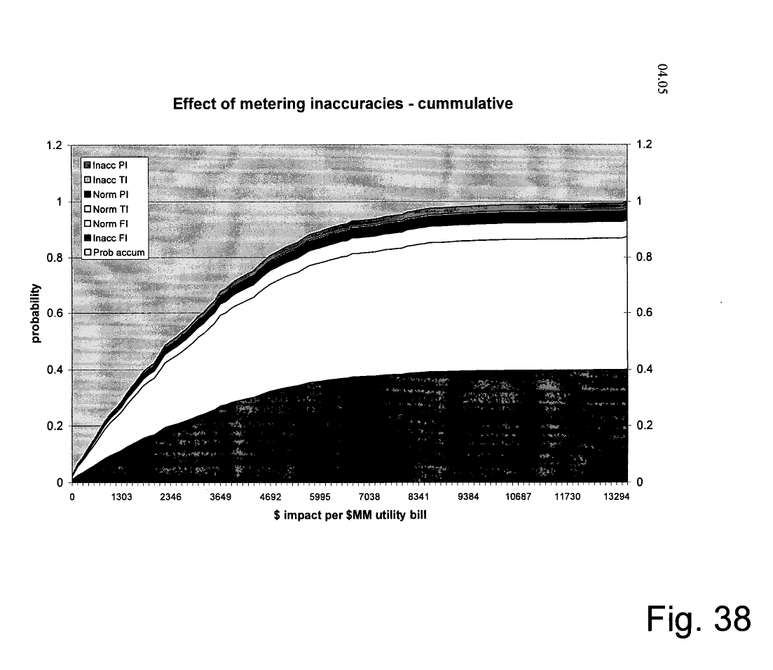

FIG. 39 is an output graph showing an aspect of the present invention.

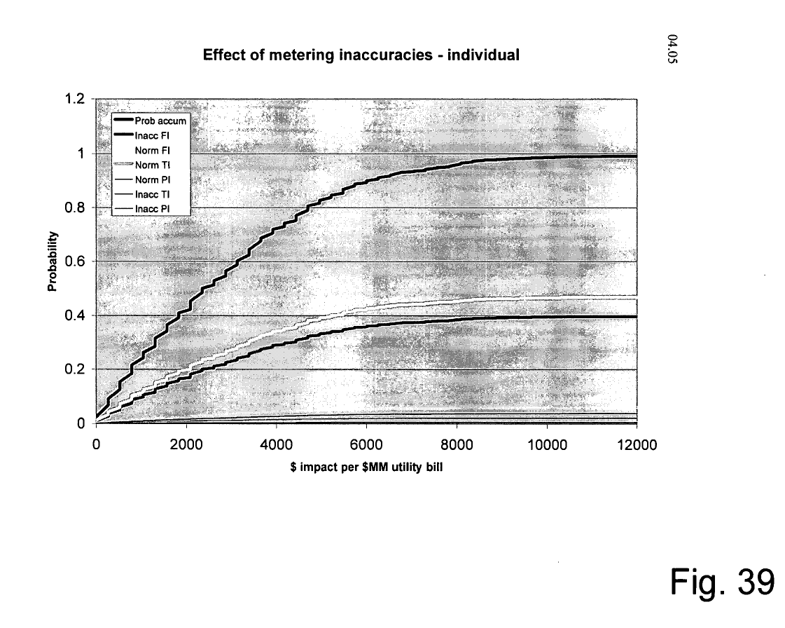

FIG. 40 is a tabular flow chart showing an aspect of the present invention.

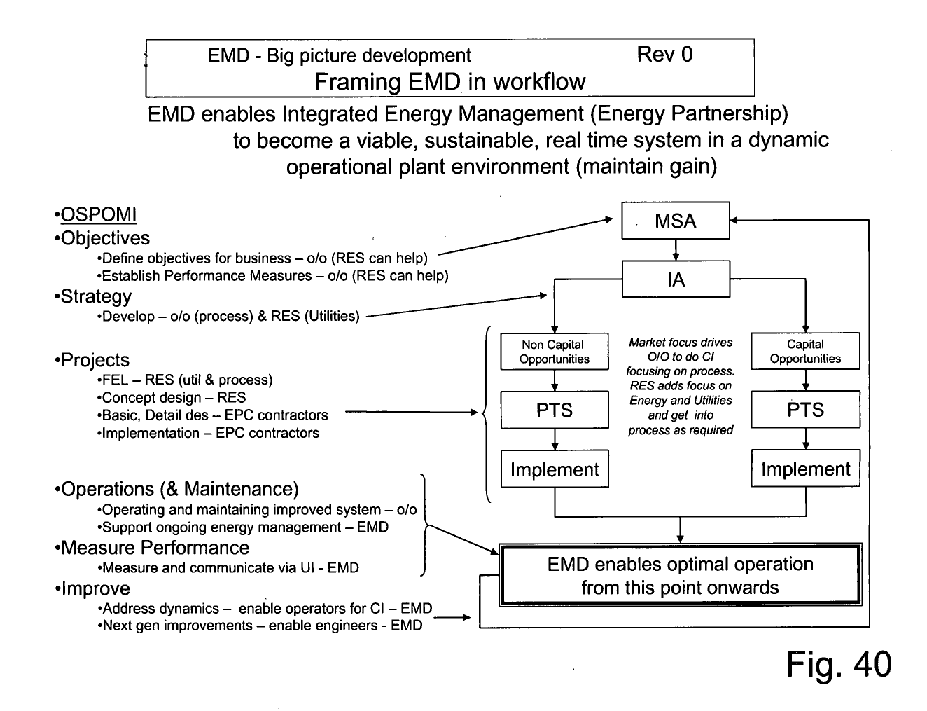

FIG. 41 is a schematic relationship chart showing an aspect of the present invention.

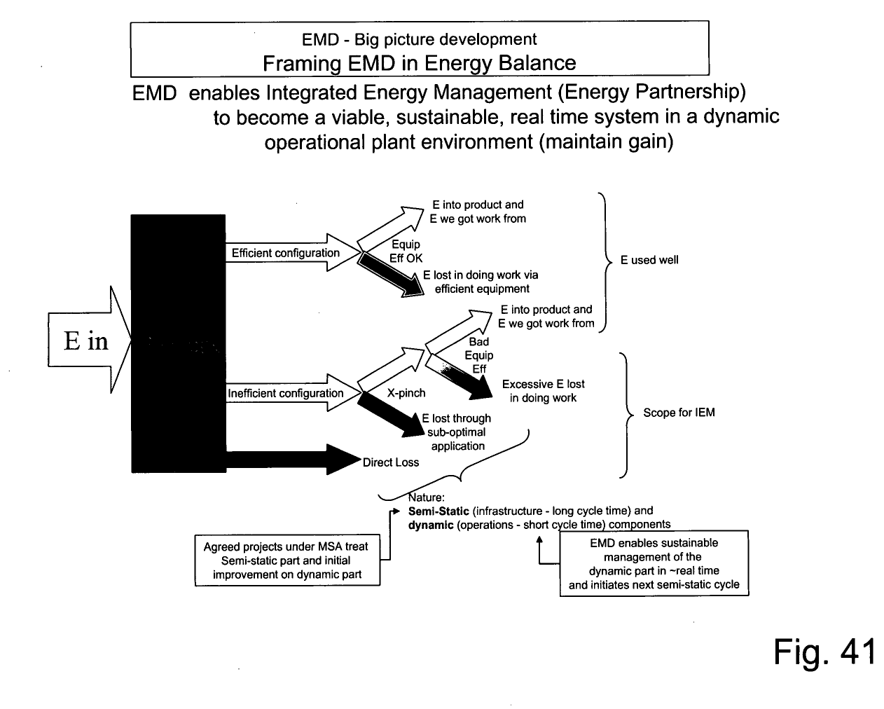

FIG. 42 is a schematic relationship chart showing an aspect of the present invention.

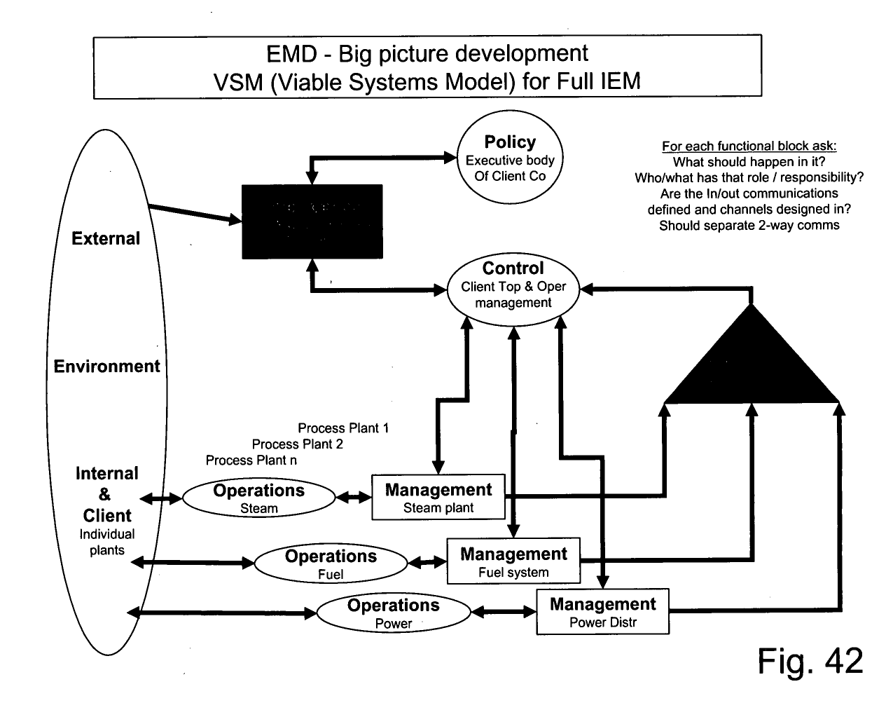

FIG. 43 is a multi-dimensional graph showing an aspect of the present invention.

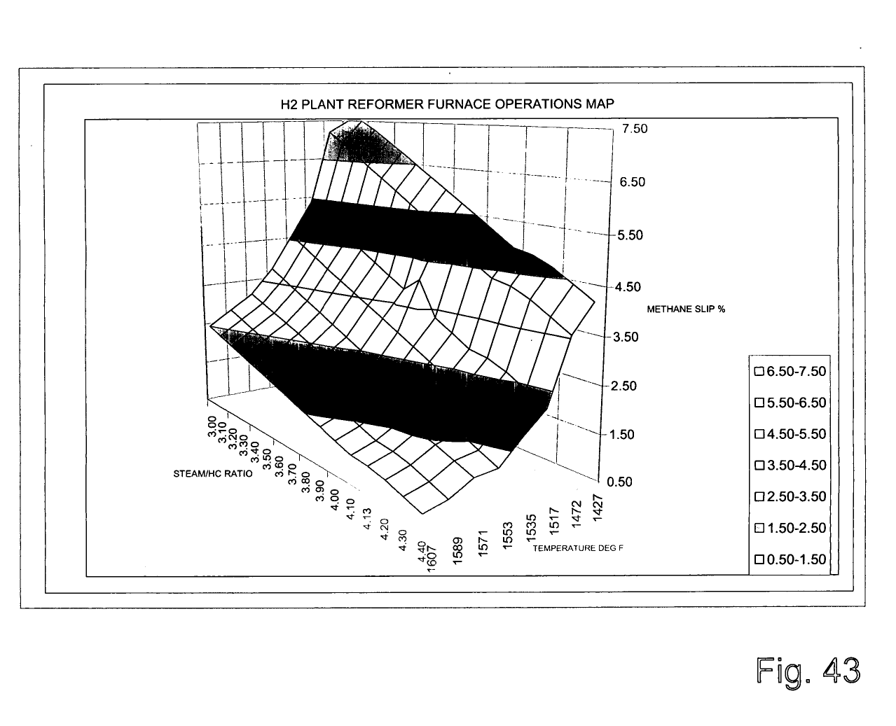

FIG. 44 is a screenshot output showing an aspect of the present invention.

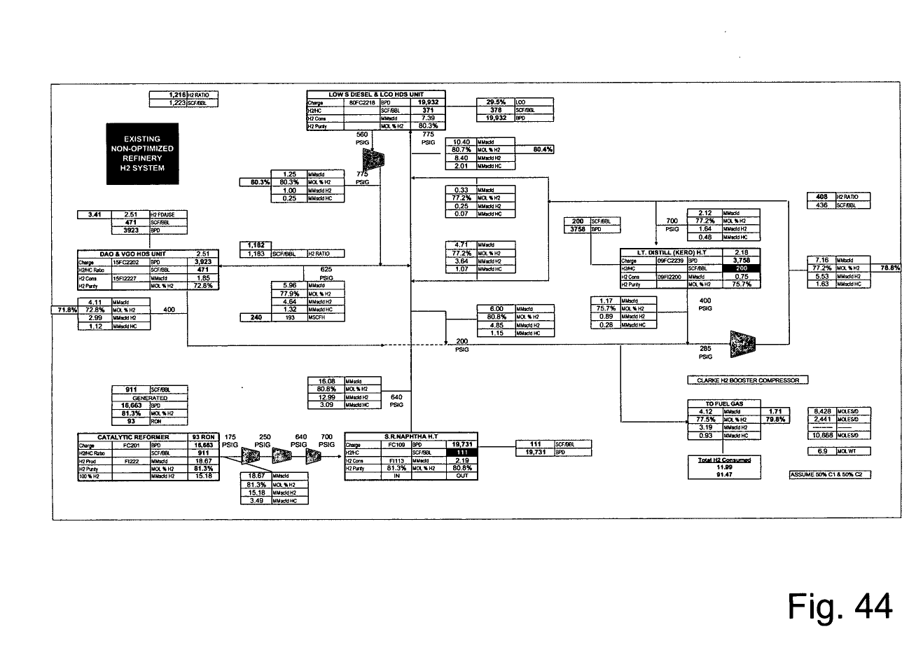

FIG. 45 is a screenshot output showing an aspect of the present invention.

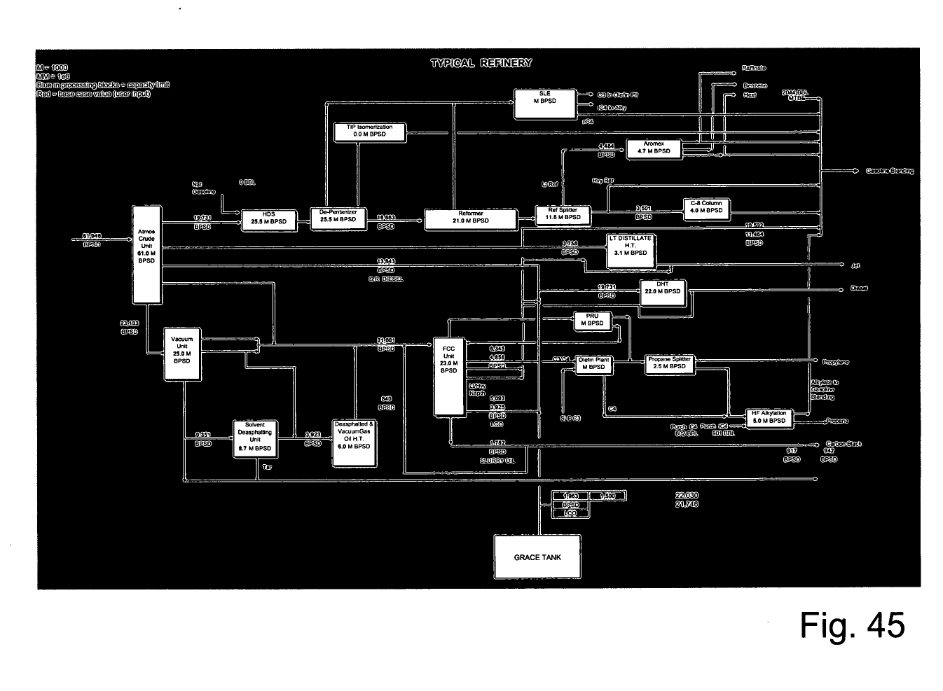

FIG. 46 is a schematic relationship chart showing an aspect of the present invention.

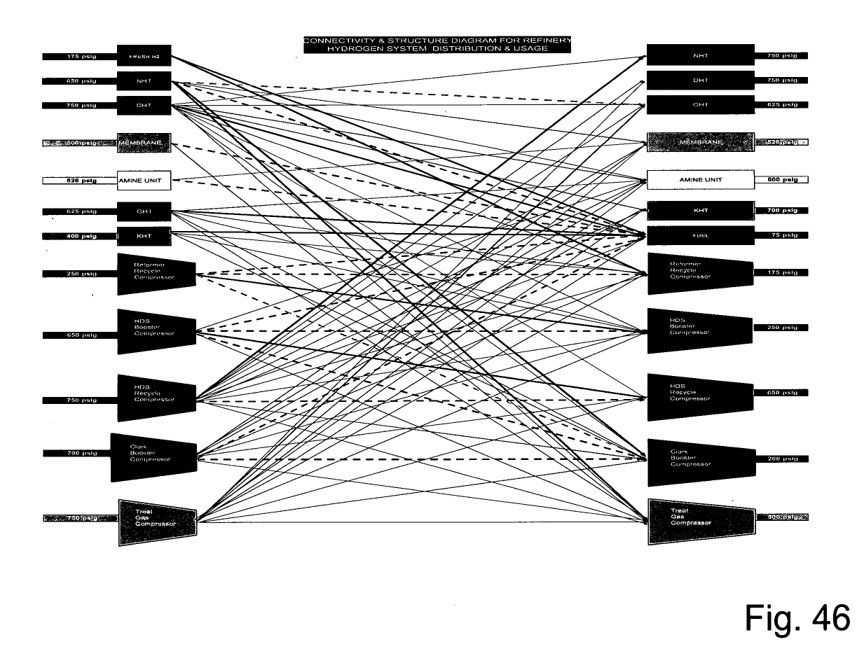

FIG. 47 is an output graph showing an aspect of the present invention.

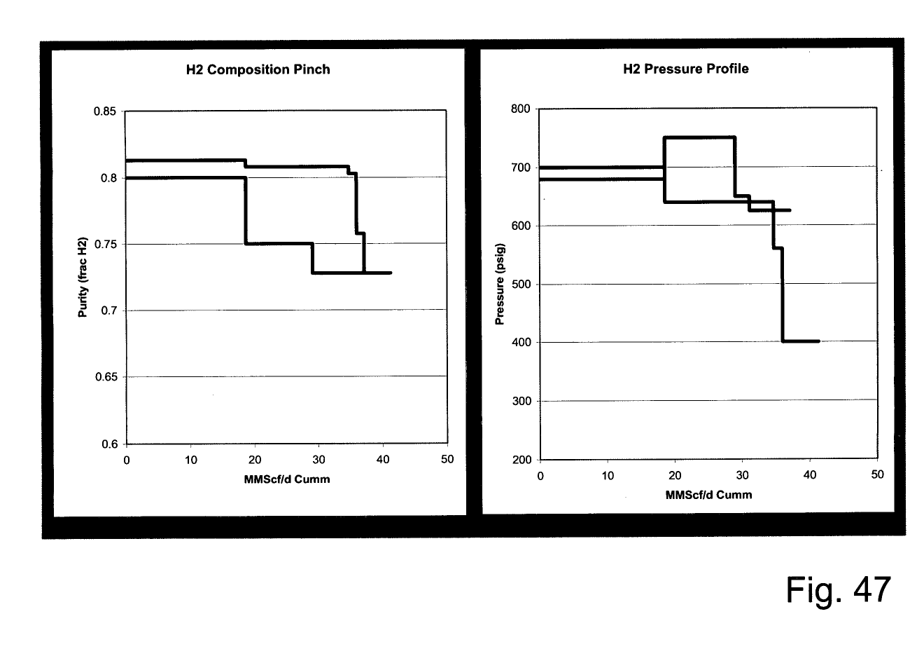

FIG. 48 is an output graph showing an aspect of the present invention.

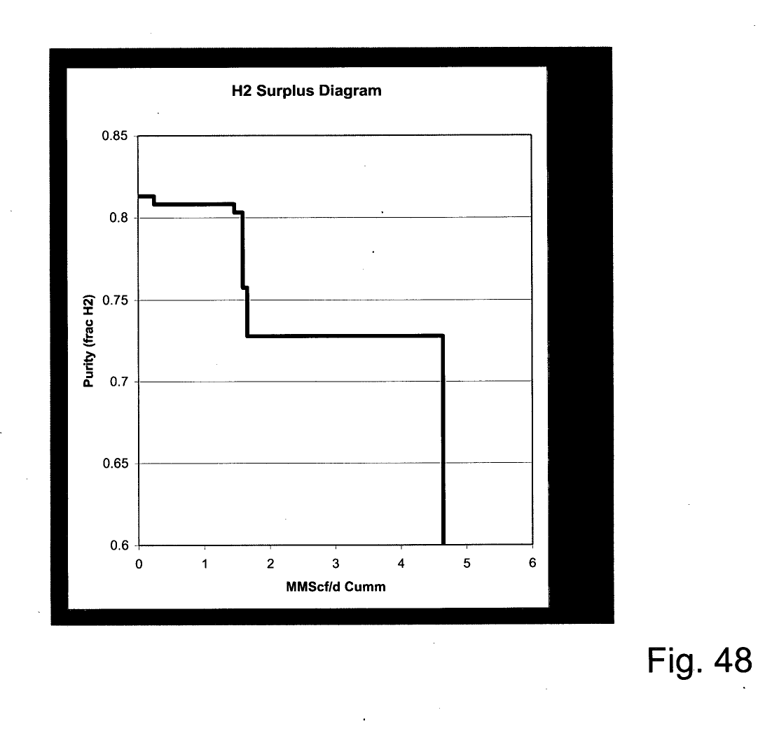

FIG. 49 is a screenshot output showing an aspect of the present invention.

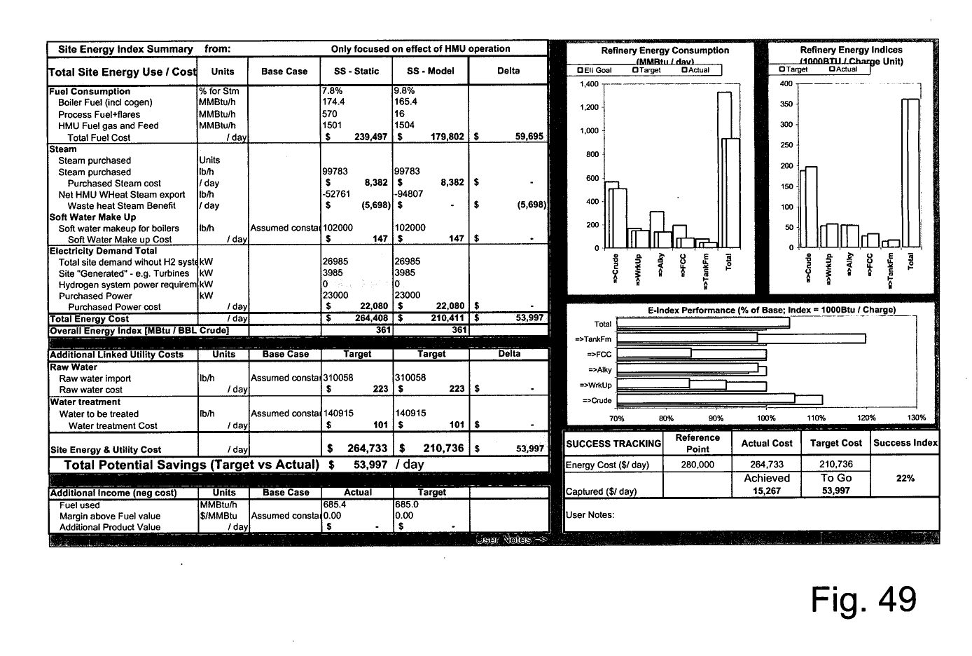

FIG. 50 is a screenshot output showing an aspect of the present invention.

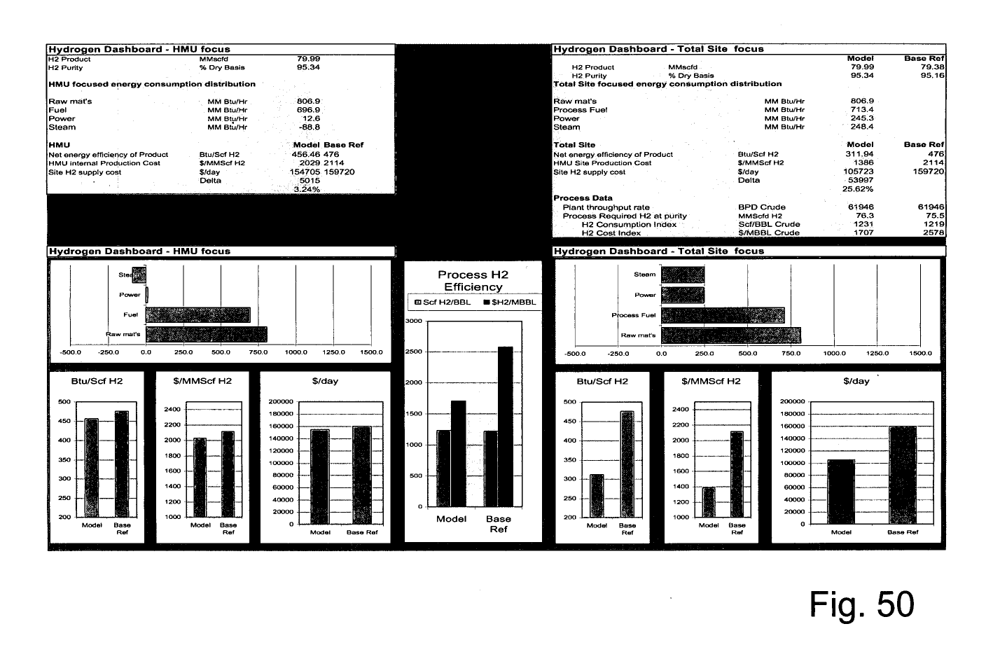

FIG. 51 is a screenshot output showing an aspect of the present invention.

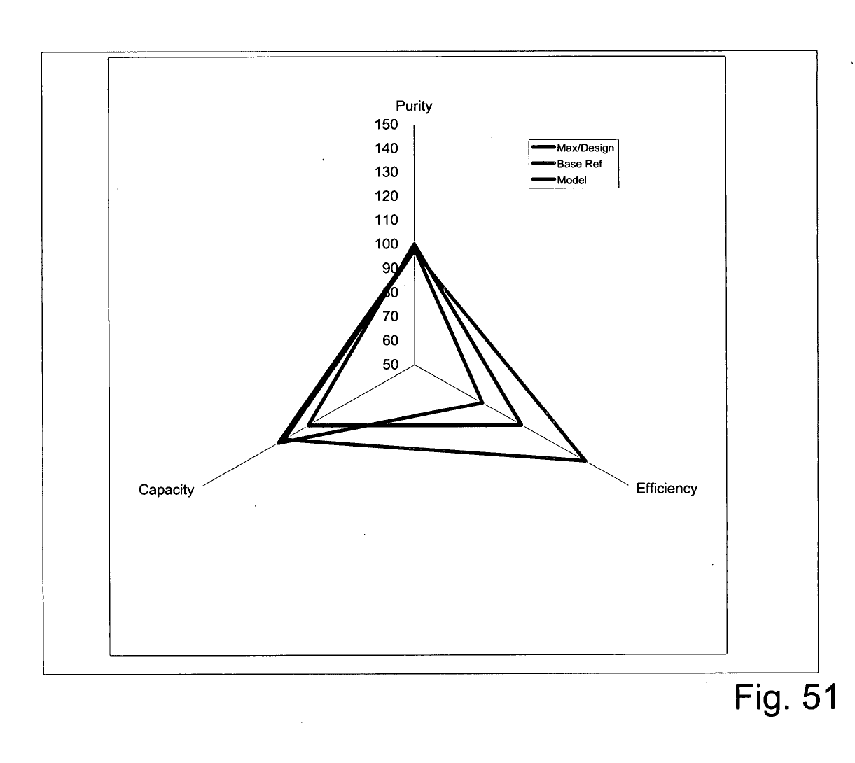

FIG. 52 is a screenshot output showing an aspect of the present invention.

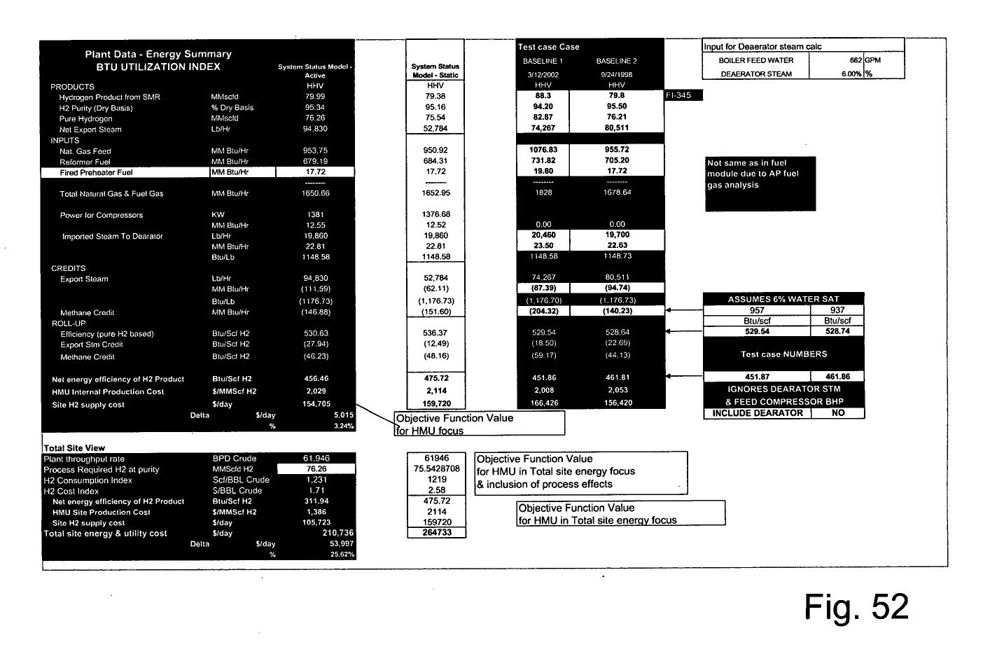

FIG. 53 is a screenshot output showing an aspect of the present invention.

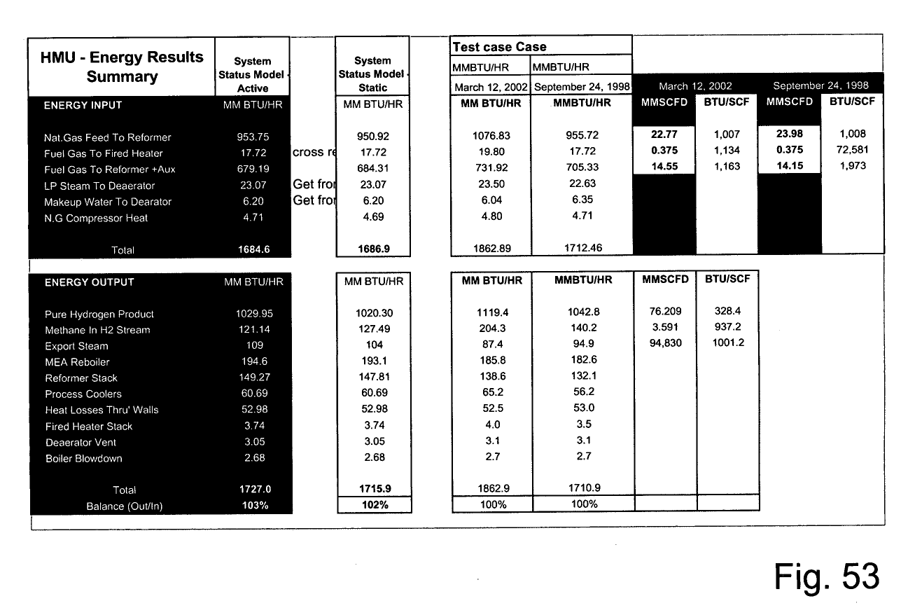

FIG. 54 is a flow chart showing an aspect of the present invention.

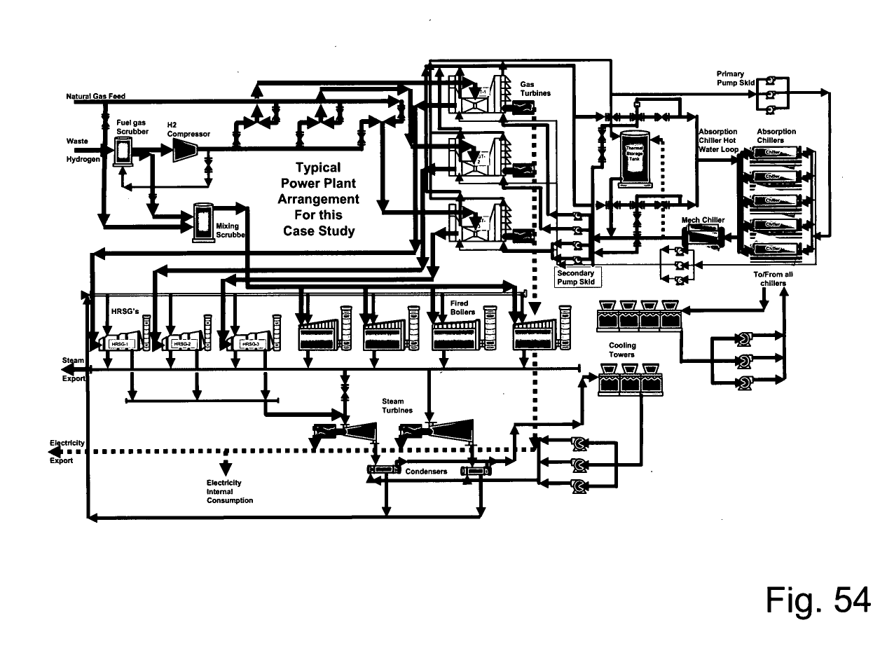

FIG. 55 is a screenshot output showing an aspect of the present invention.

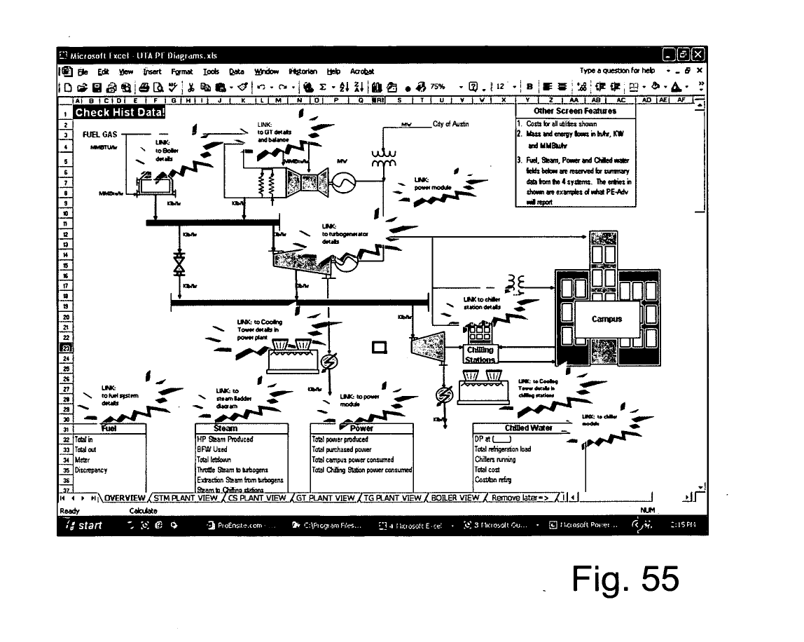

FIG. 56 is a screenshot output showing an aspect of the present invention.

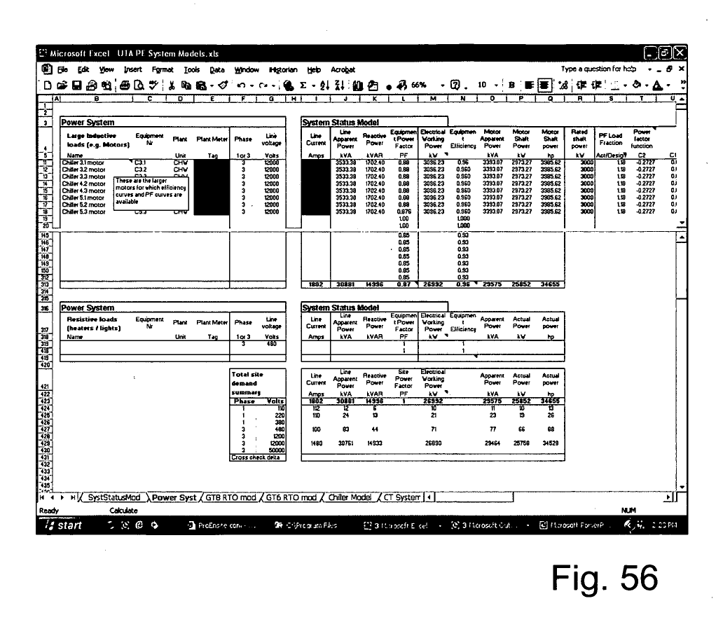

FIG. 57 is a screenshot output showing an aspect of the present invention.

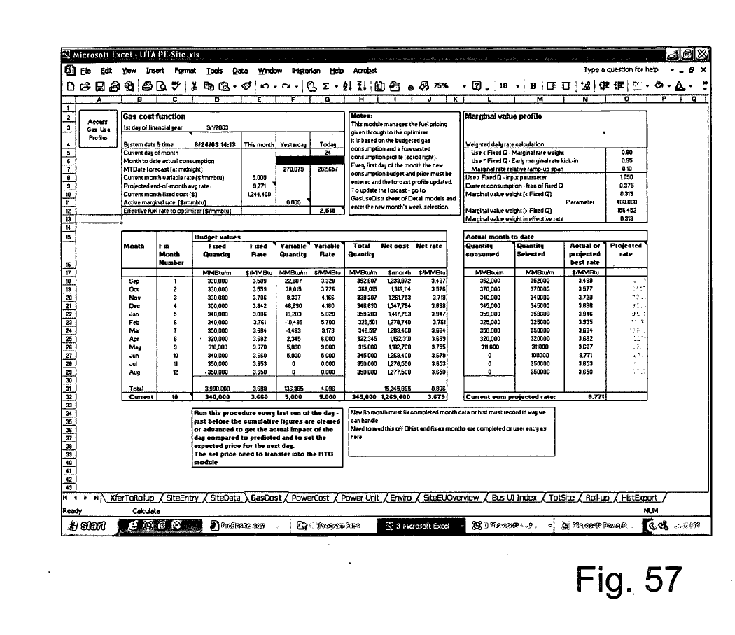

FIG. 58 is a screenshot output showing an aspect of the present invention.

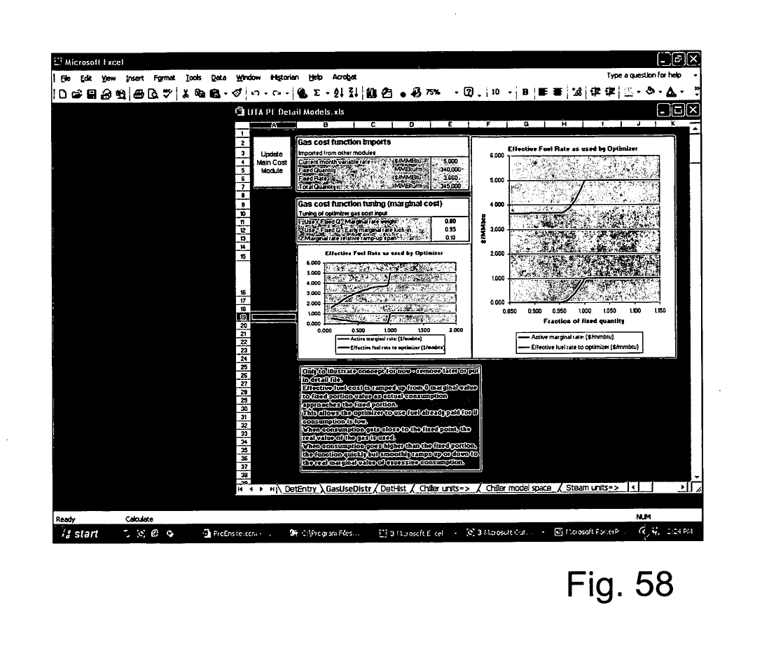

FIG. 59 is a screenshot output showing an aspect of the present invention.

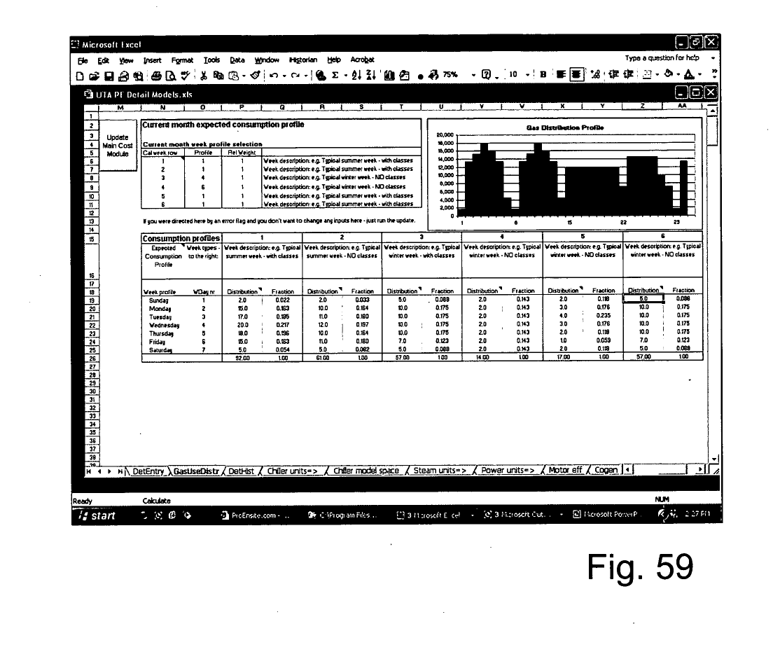

FIG. 60 is a screenshot output showing an aspect of the present invention.

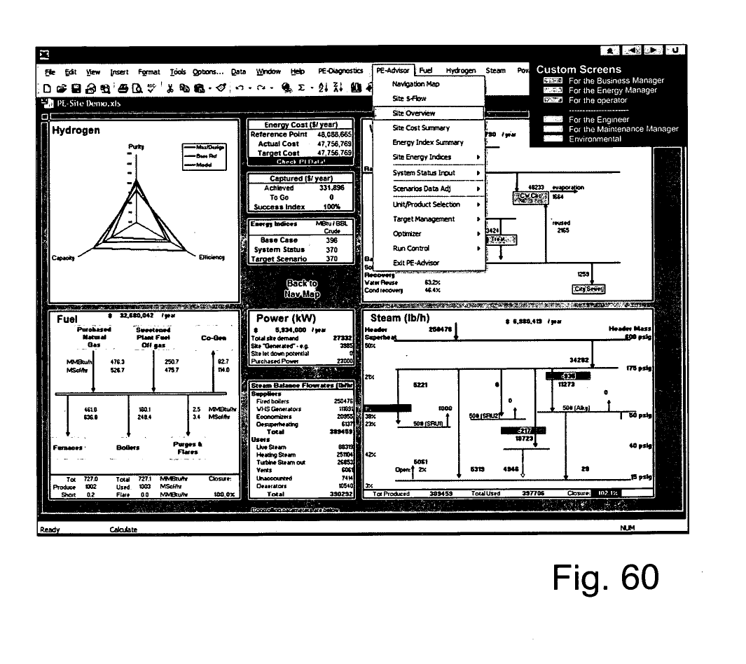

FIG. 61 is a schematic relationship chart showing an aspect of the present invention.

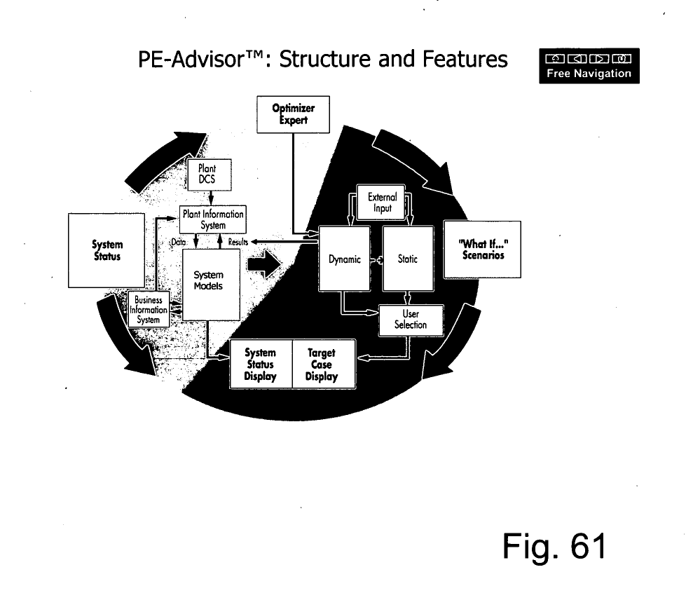

FIG. 62 is a screenshot output showing an aspect of the present invention.

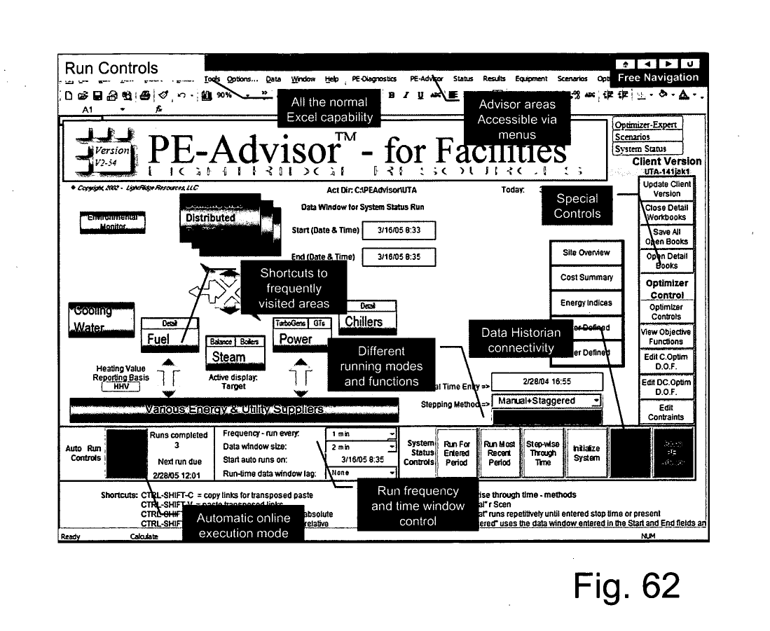

FIG. 63 is a screenshot output showing an aspect of the present invention.

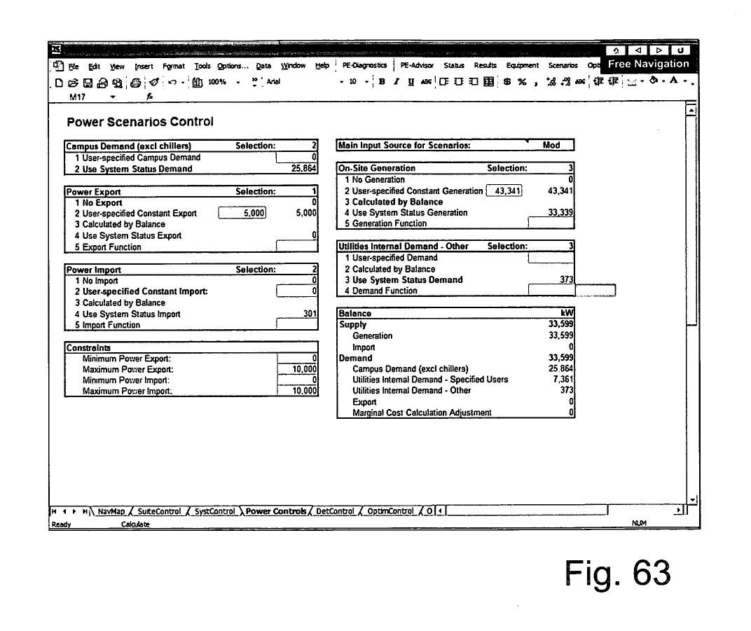

FIG. 64 is a screenshot output showing an aspect of the present invention.

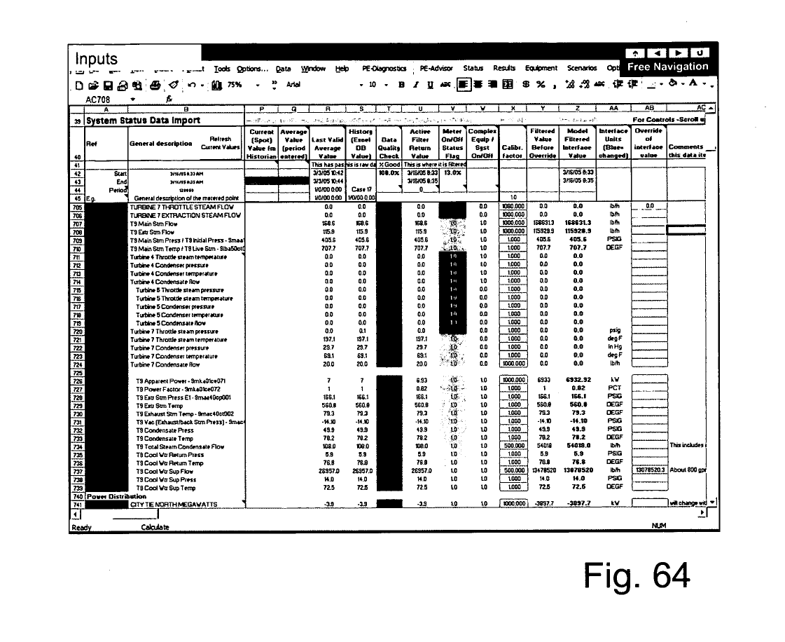

FIG. 65 is a screenshot output showing an aspect of the present invention.

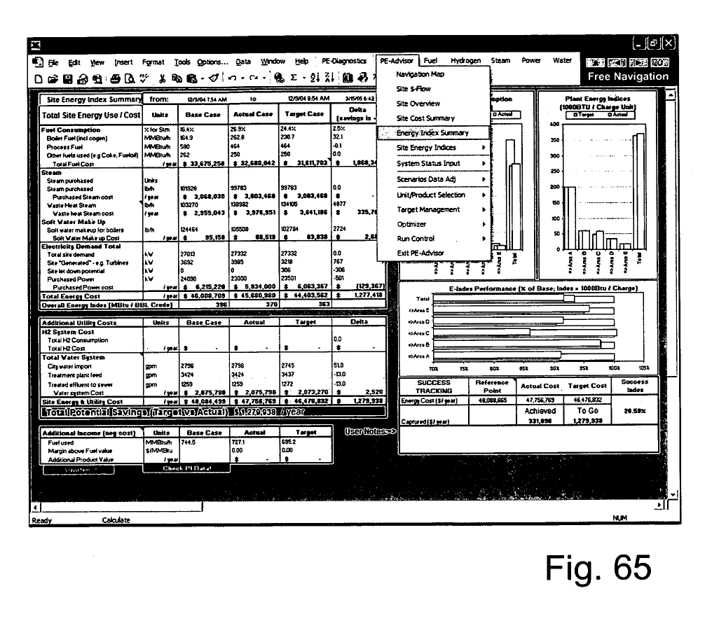

FIG. 66 is a screenshot output showing an aspect of the present invention.

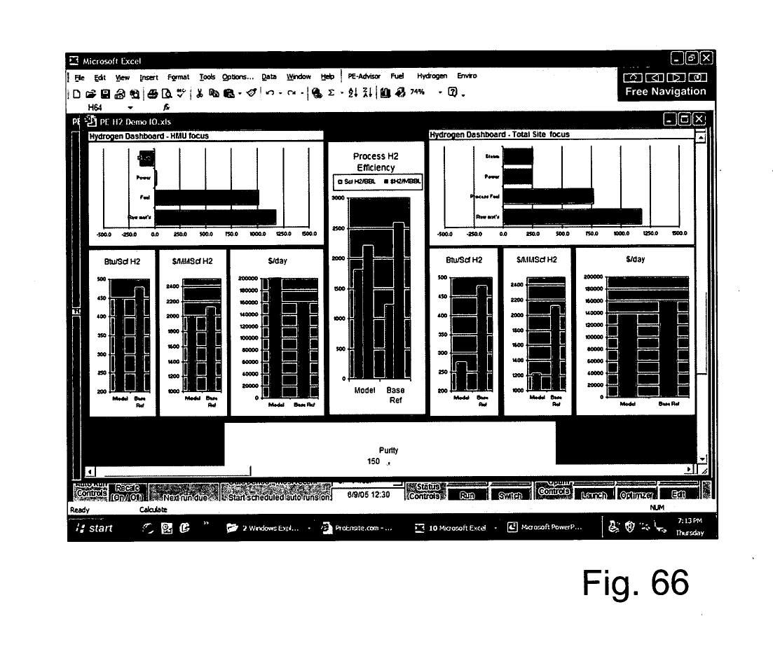

FIG. 67 is a screenshot output showing an aspect of the present invention.

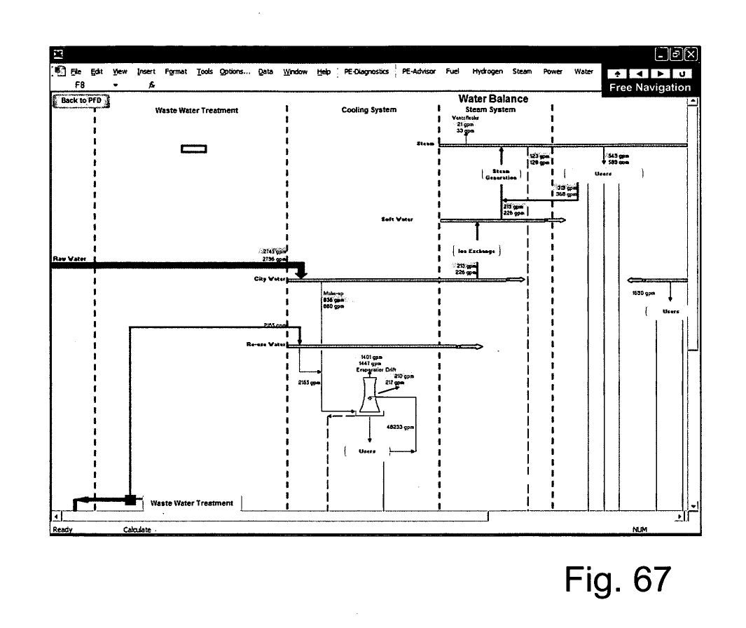

FIG. 68 is a screenshot output showing an aspect of the present invention.

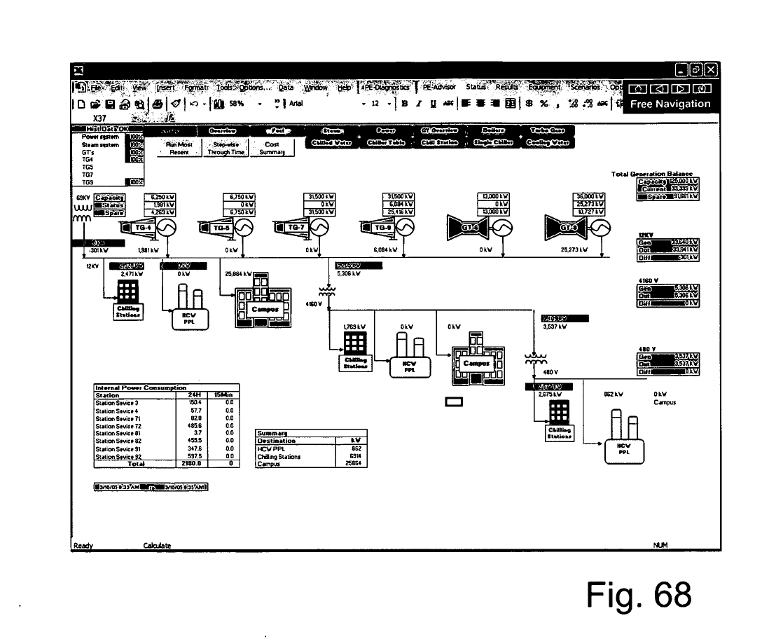

FIG. 69 is a screenshot output showing an aspect of the present invention.

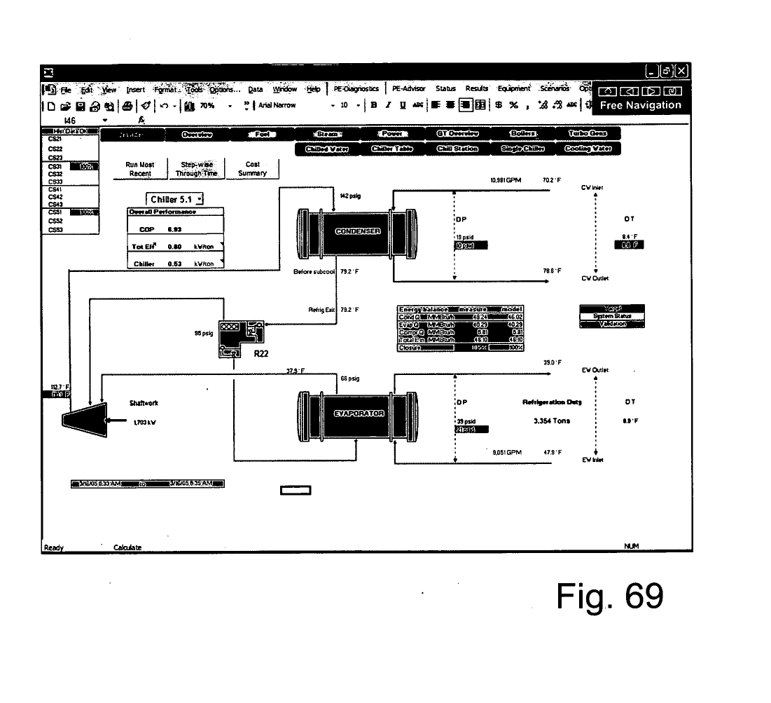

FIG. 70 is a screenshot output showing an aspect of the present invention.

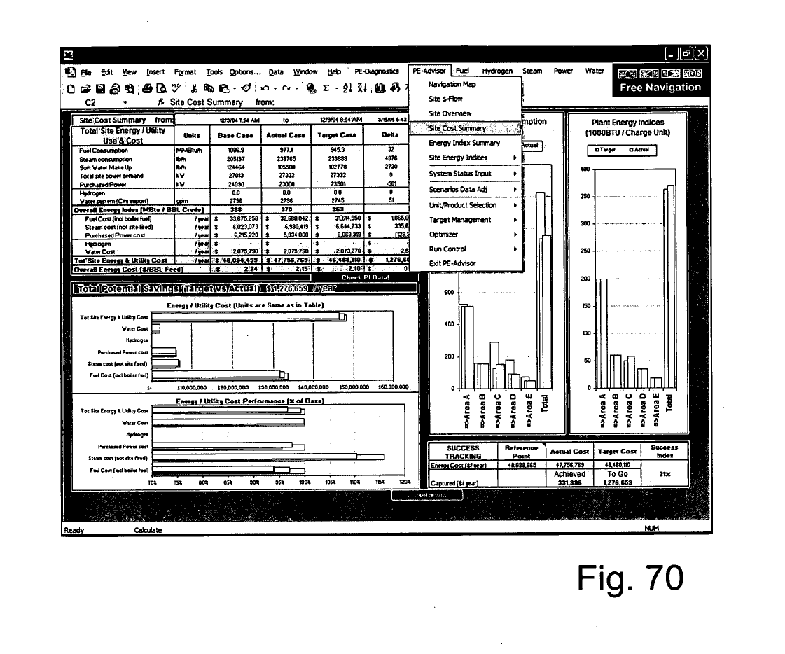

FIG. 71 is a screenshot output showing an aspect of the present invention.

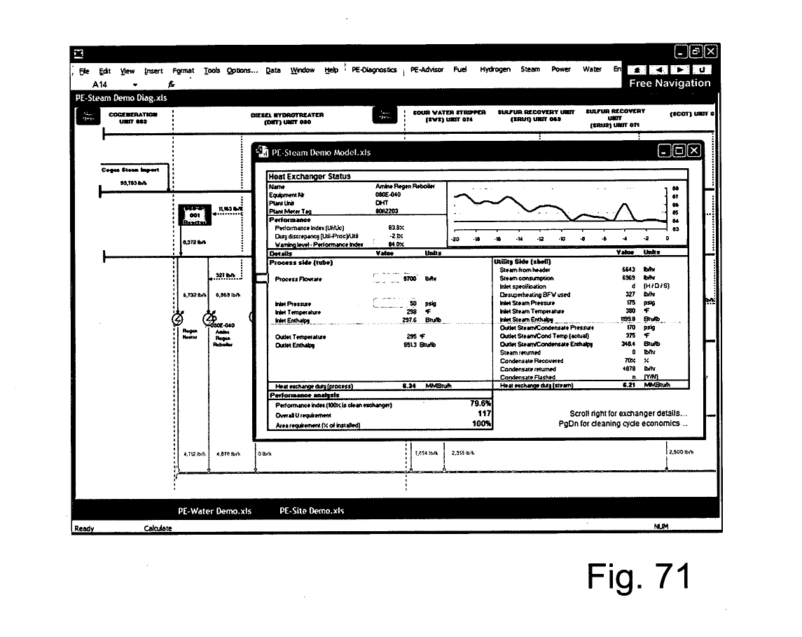

FIG. 72 is a screenshot output showing an aspect of the present invention.

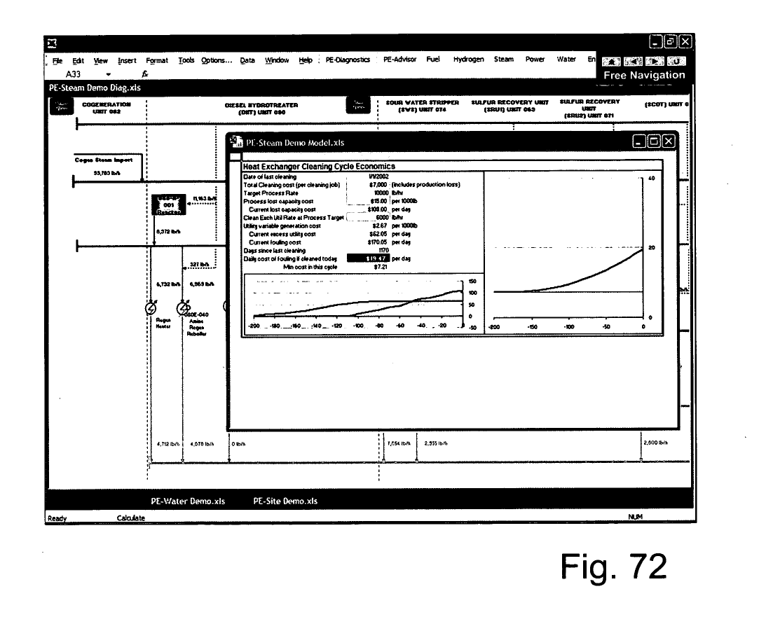

FIG. 73 is a screenshot output showing an aspect of the present invention.

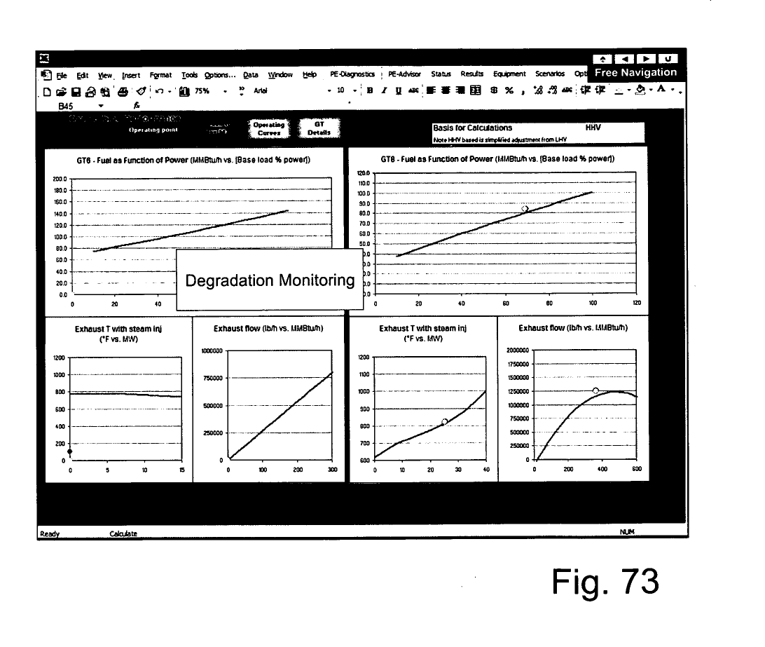

FIG. 74 is a screenshot output showing an aspect of the present invention.

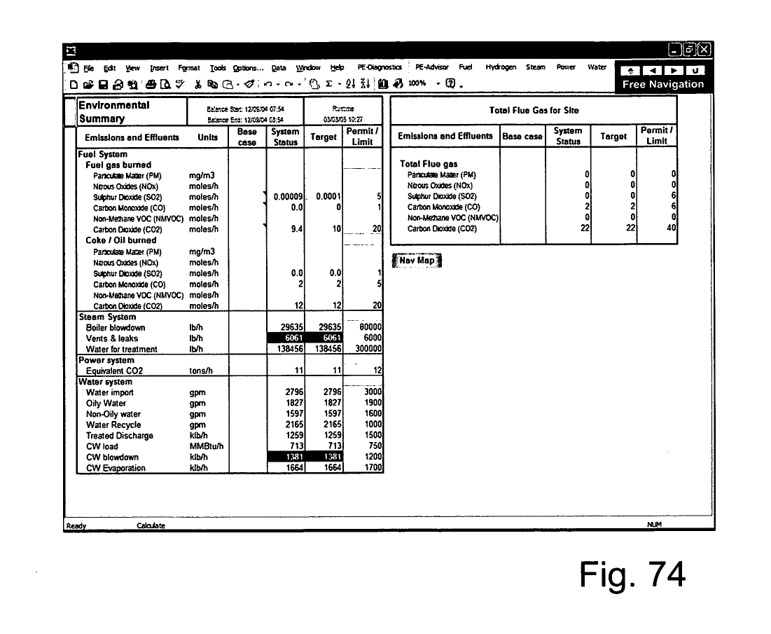

FIG. 75 is a screenshot output showing an aspect of the present invention.

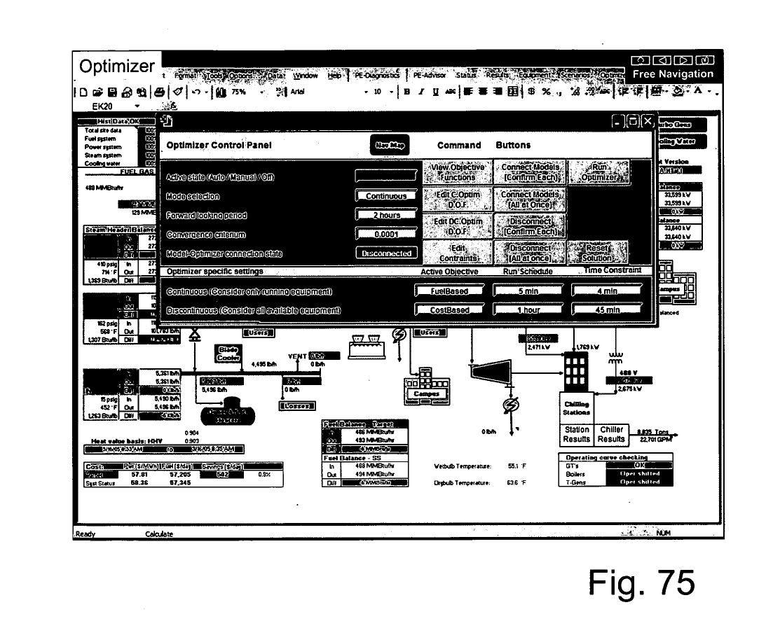

FIG. 76 is a screenshot output showing an aspect of the present invention.

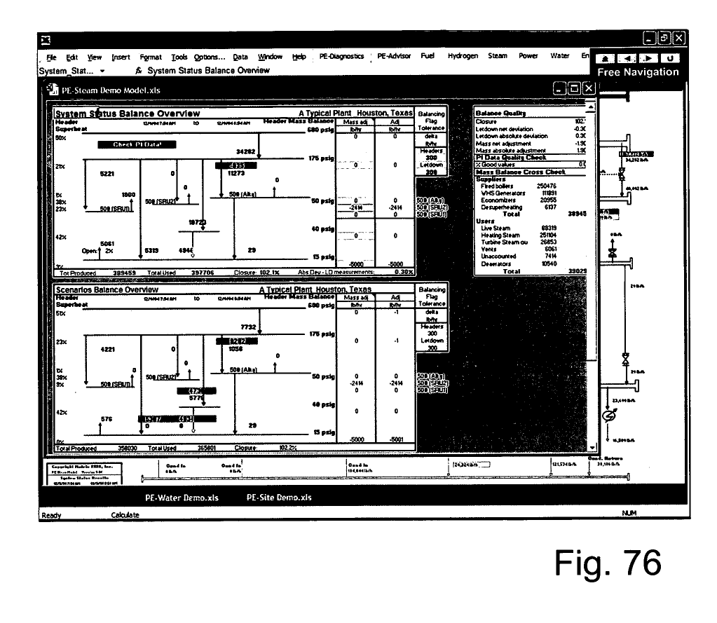

FIG. 77 is a screenshot output showing an aspect of the present invention.

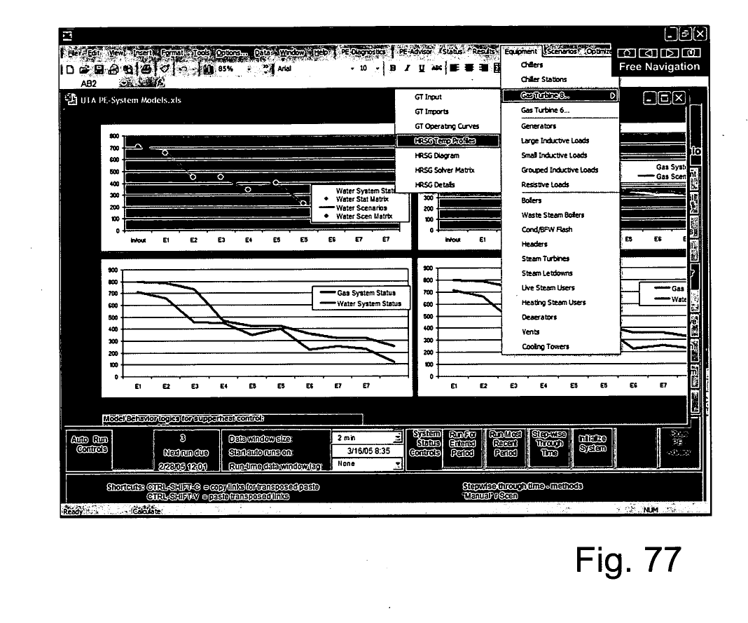

FIG. 78 is a screenshot output showing an aspect of the present invention.

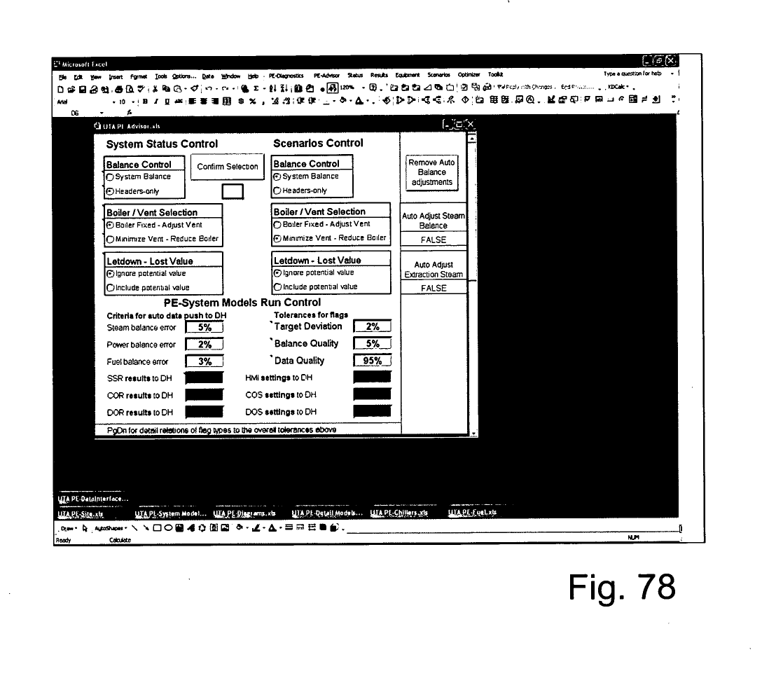

FIG. 79 is a screenshot output showing an aspect of the present invention.

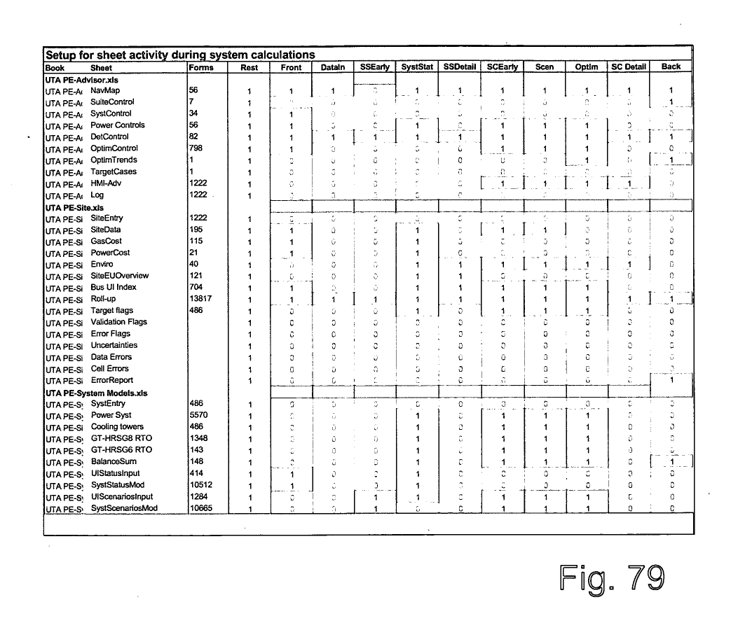

FIG. 80 is a schematic relationship chart showing an aspect of the present invention.

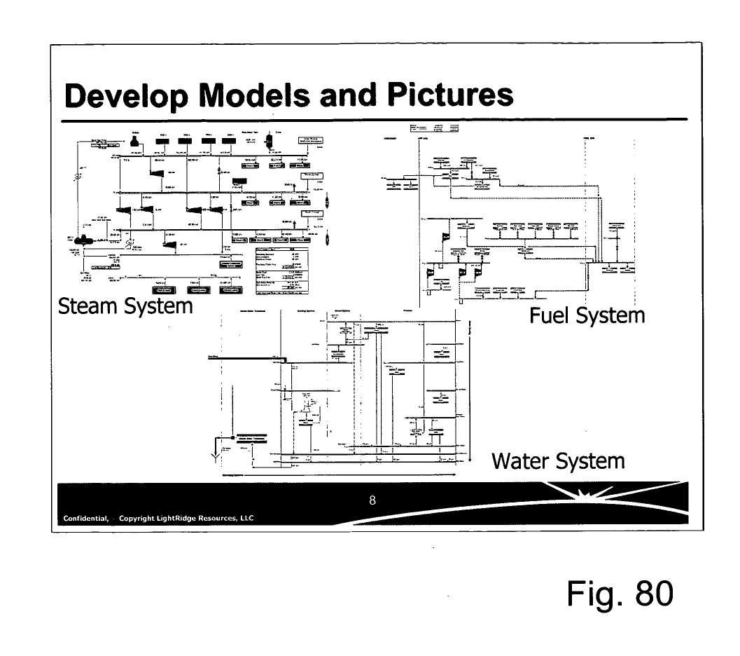

FIG. 81 is a schematic relationship chart showing an aspect of the present invention.

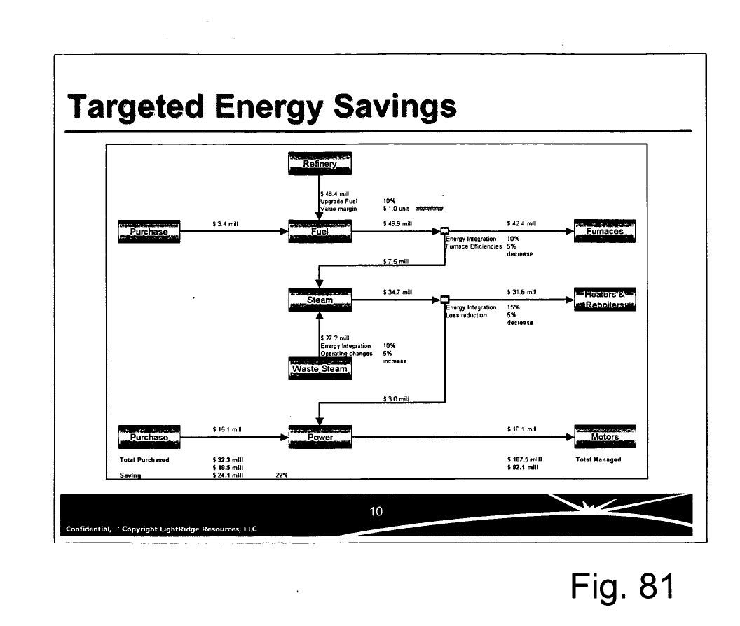

FIG. 82 is a schematic relationship chart showing an aspect of the present invention.

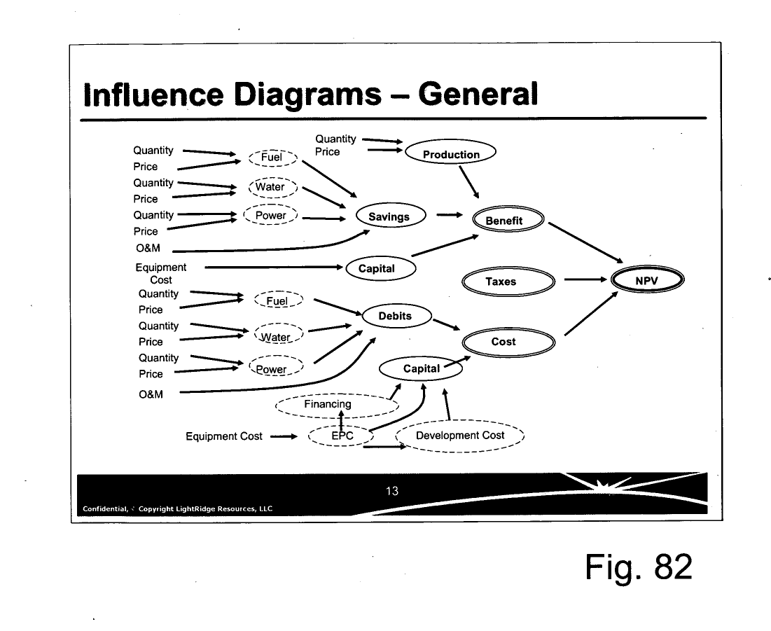

FIG. 83 is a schematic relationship chart showing an aspect of the present invention.

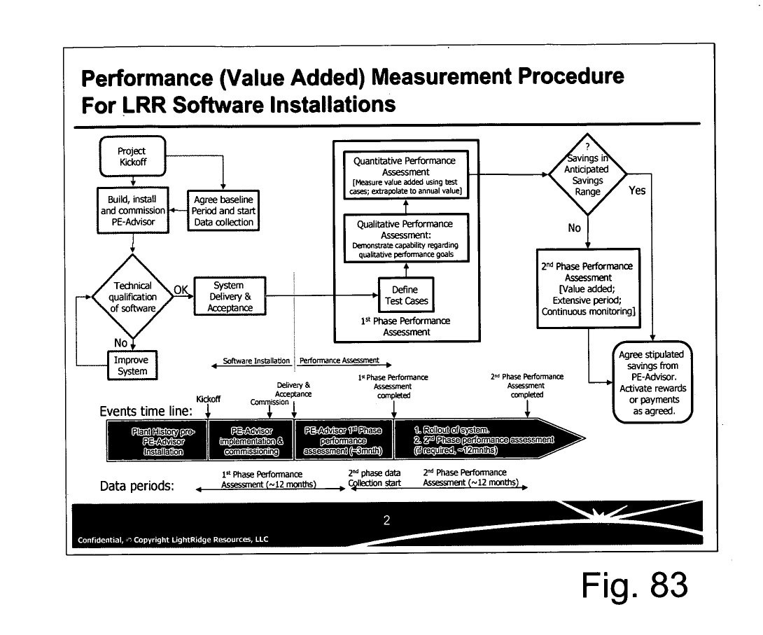

FIG. 84 is a schematic relationship chart showing an aspect of the present invention.

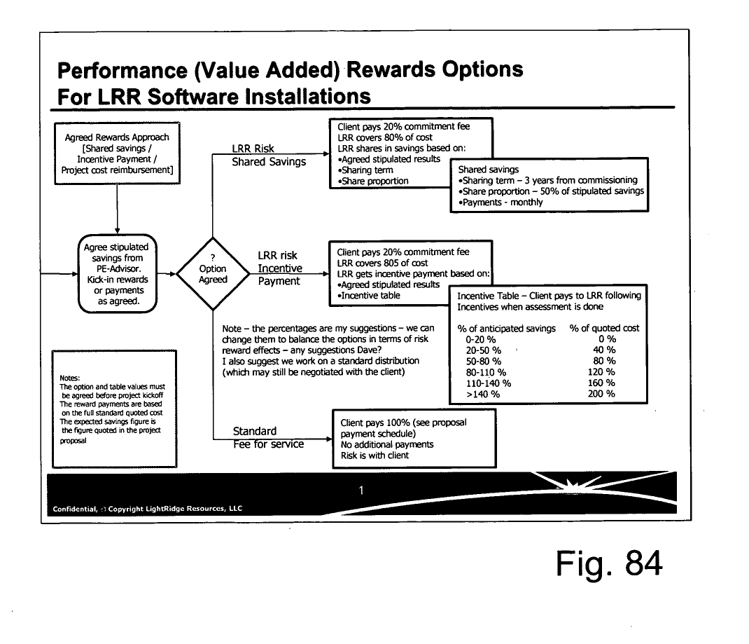

FIG. 85 is a flow chart showing an aspect of the present invention.

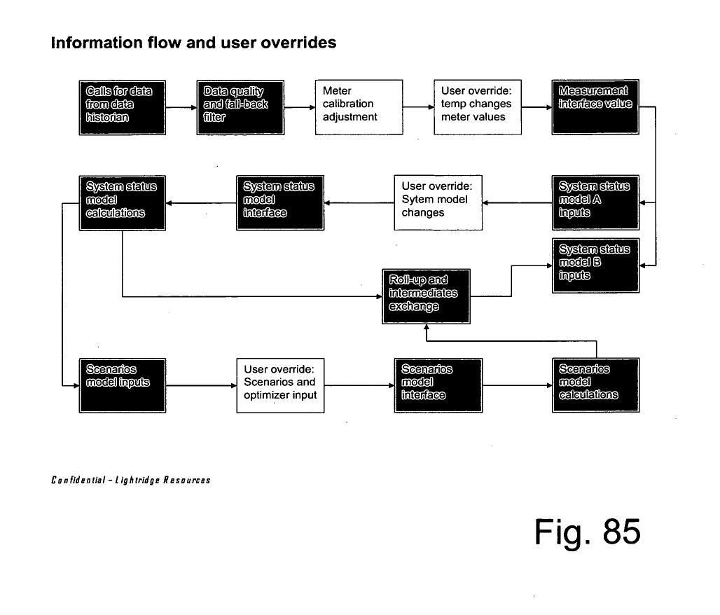

FIG. 86 is a screenshot output showing an aspect of the present invention.

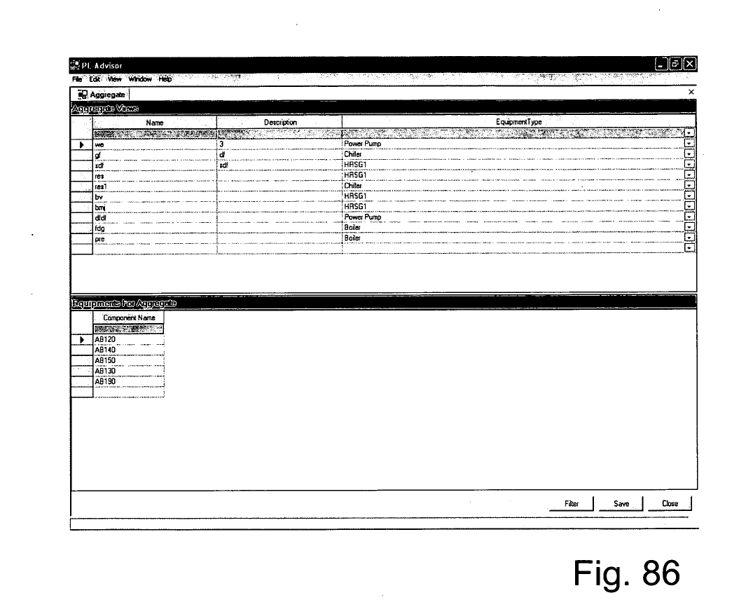

FIG. 87 is a screenshot output showing an aspect of the present invention.

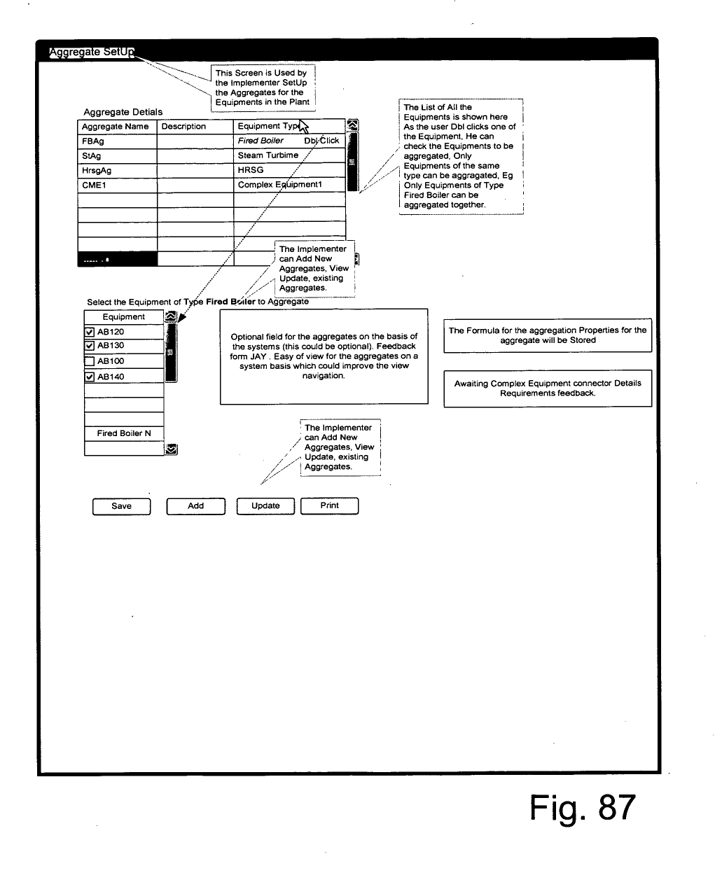

FIG. 88 is a screenshot output showing an aspect of the present invention.

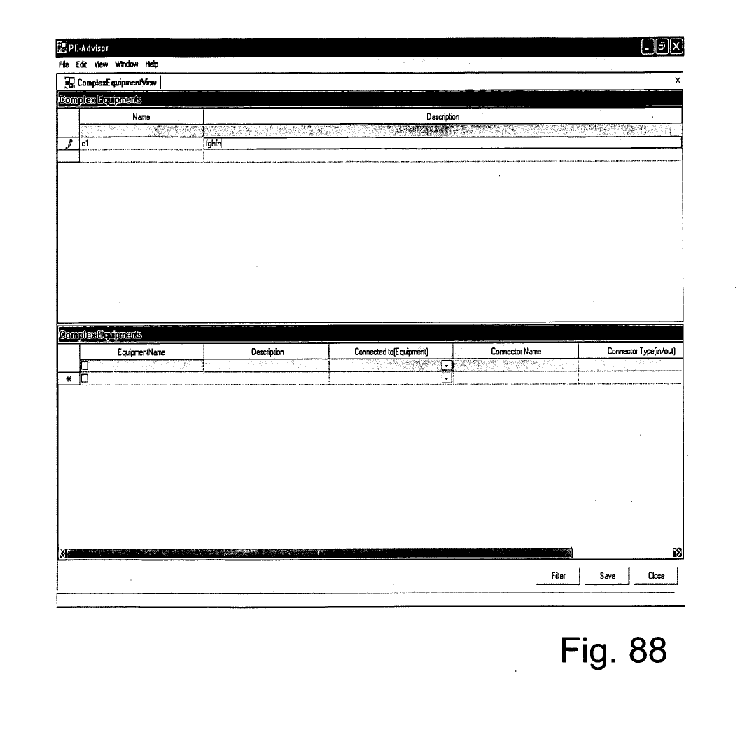

FIG. 89 is a screenshot output showing an aspect of the present invention.

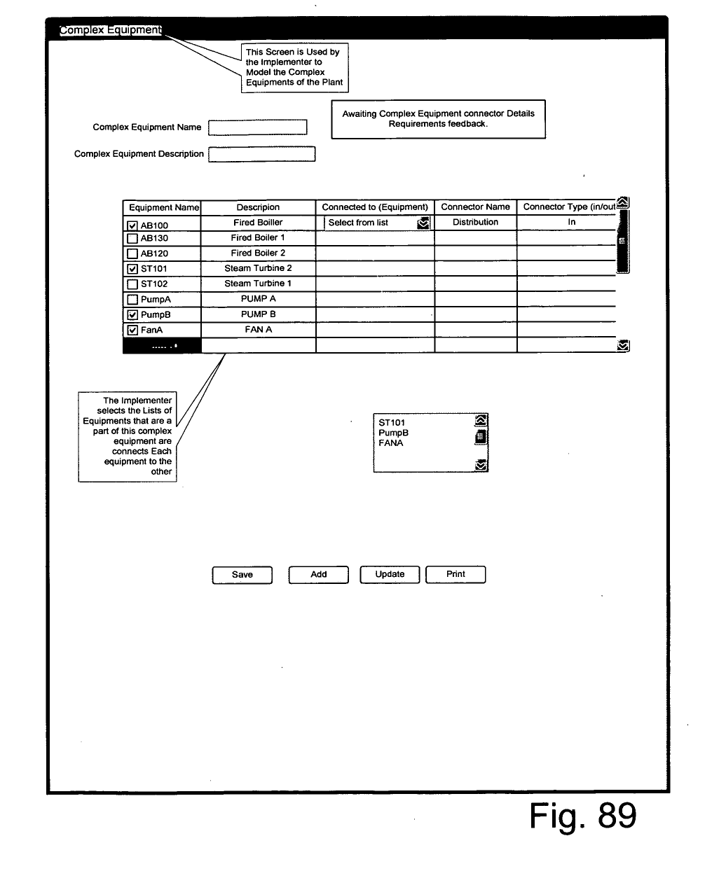

FIG. 90 is a screenshot output showing an aspect of the present invention.

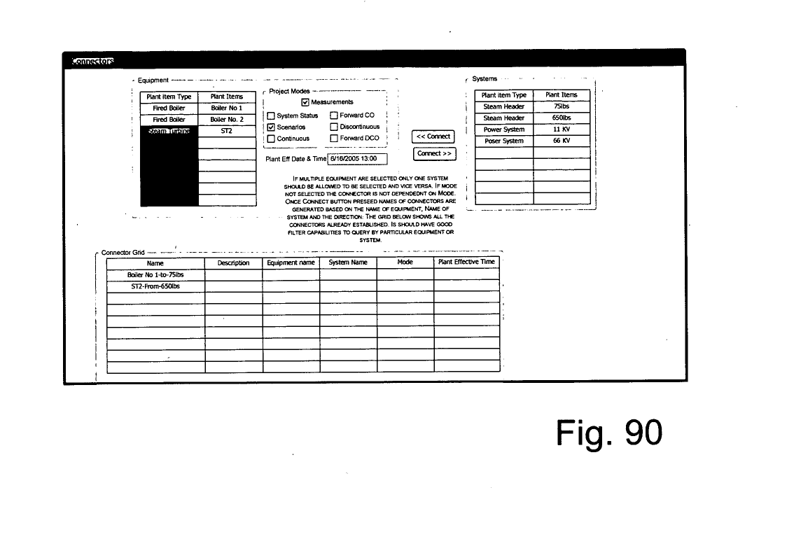

FIG. 91 is a screenshot output showing an aspect of the present invention.

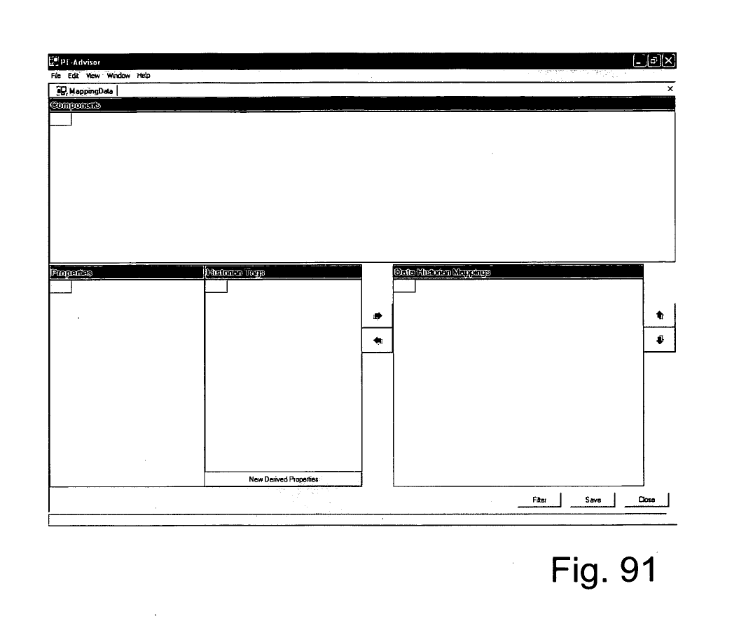

FIG. 92 is a screenshot output showing an aspect of the present invention.

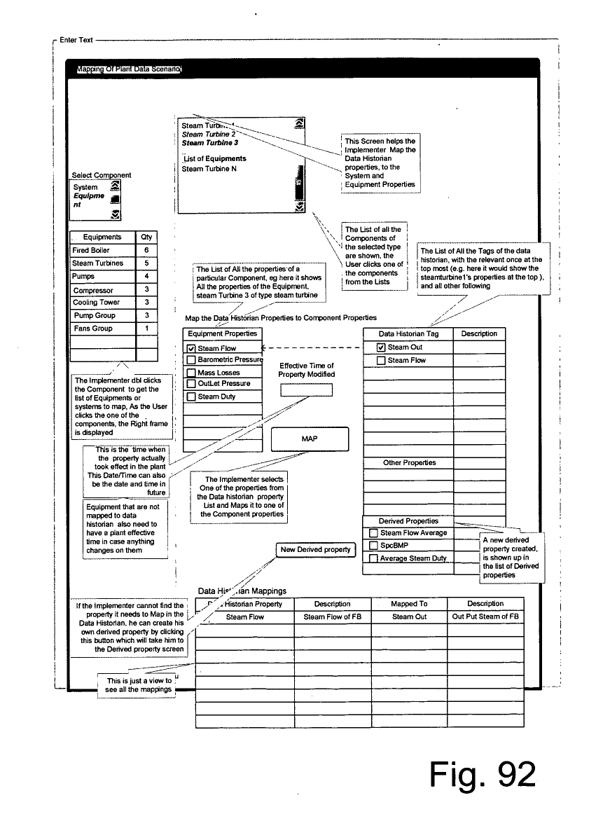

FIG. 93 is a screenshot output showing an aspect of the present invention.

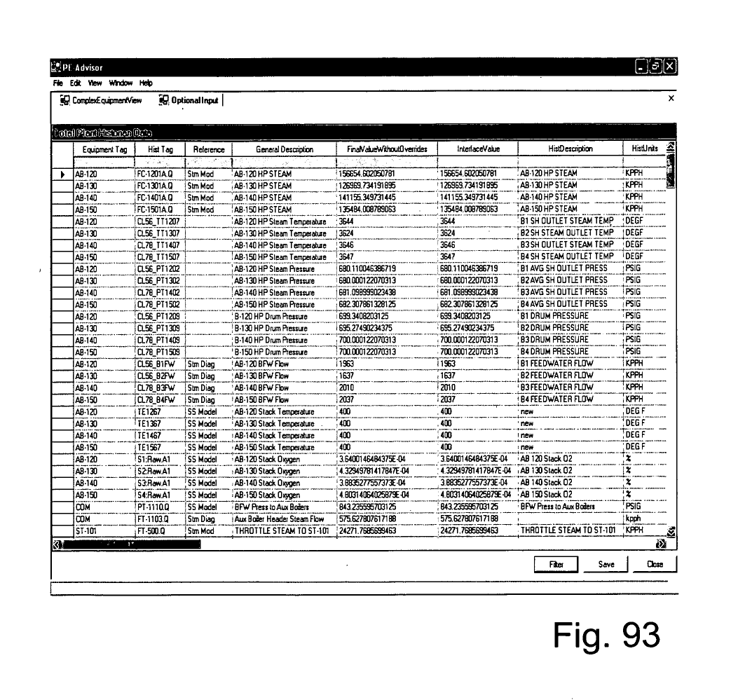

FIG. 94 is a screenshot output showing an aspect of the present invention.

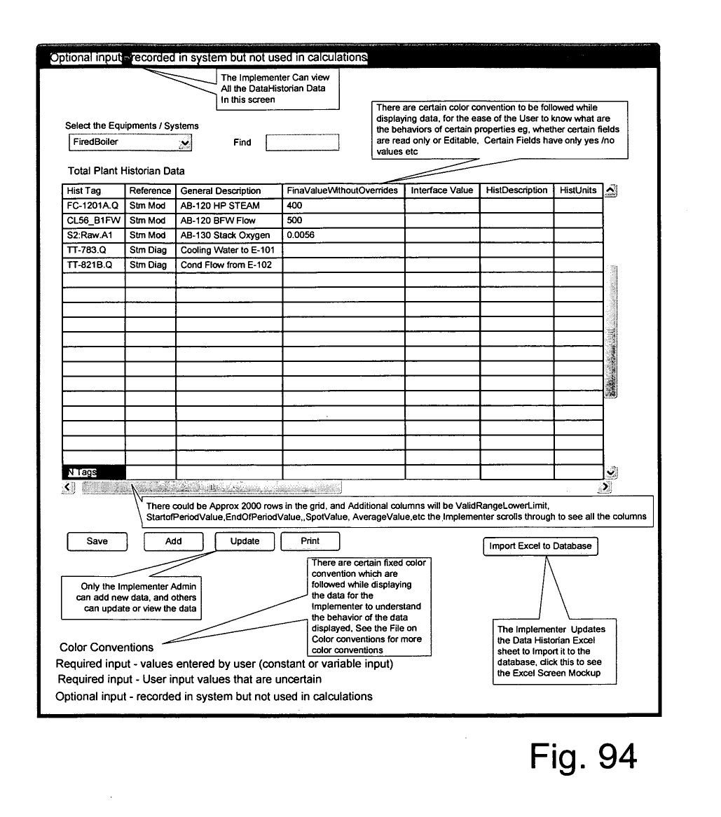

FIG. 95 is a screenshot output showing an aspect of the present invention.

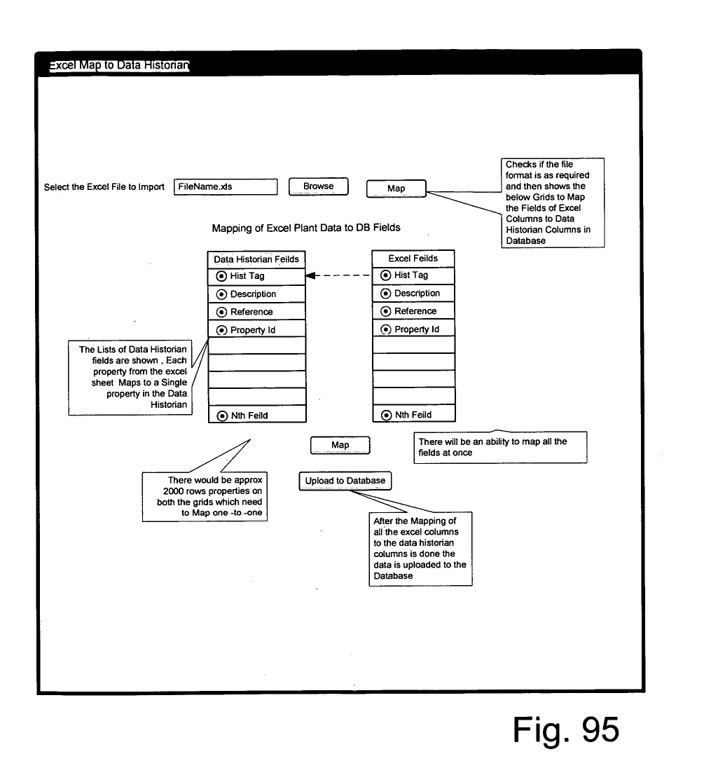

FIG. 96 is a screenshot output showing an aspect of the present invention.

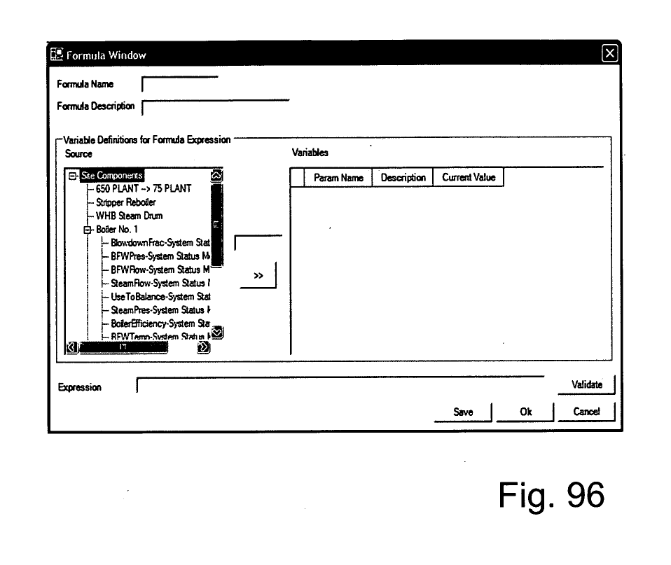

FIG. 97 is a screenshot output showing an aspect of the present invention.

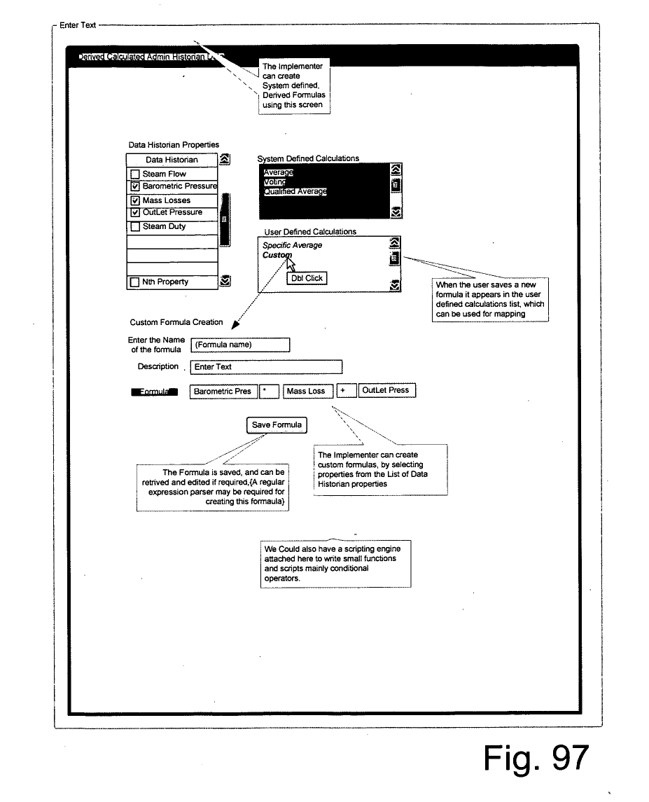

FIG. 98 is a screenshot output showing an aspect of the present invention.

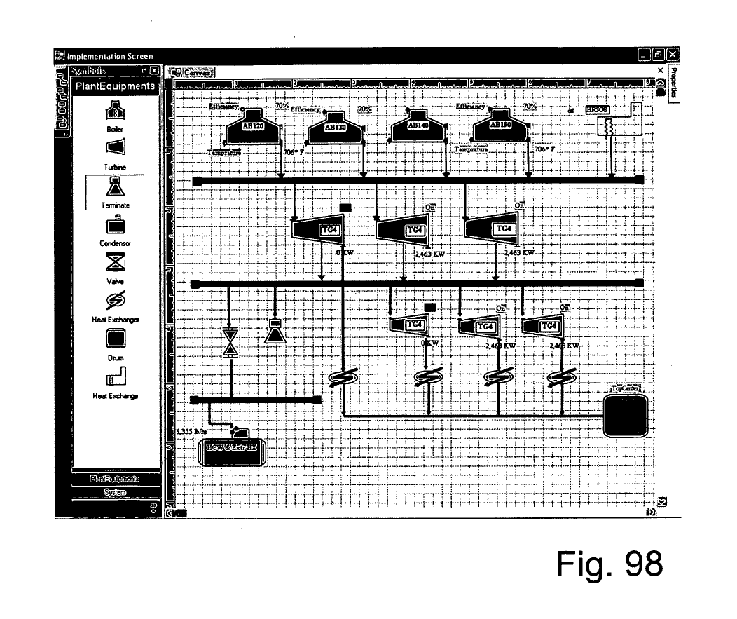

FIG. 99 is a screenshot output showing an aspect of the present invention.

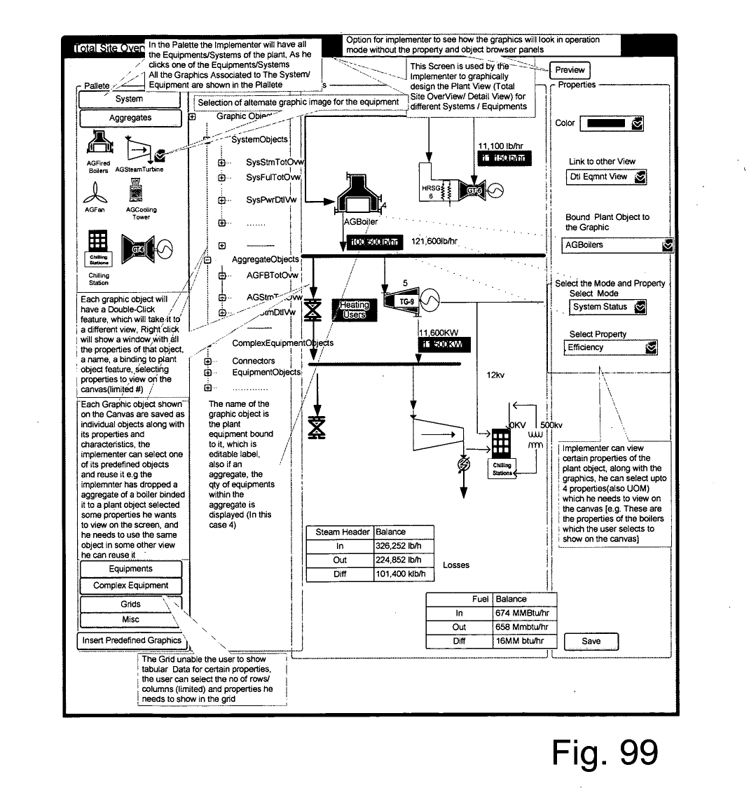

FIG. 100 is a schematic relationship chart showing an aspect of the present invention.

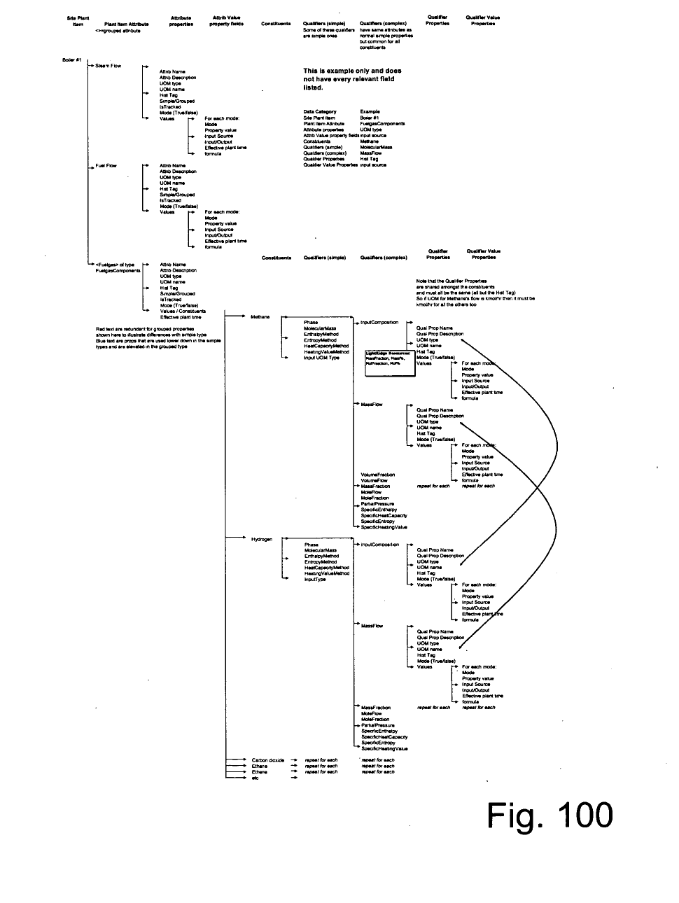

FIG. 101 is a screenshot output showing an aspect of the present invention.

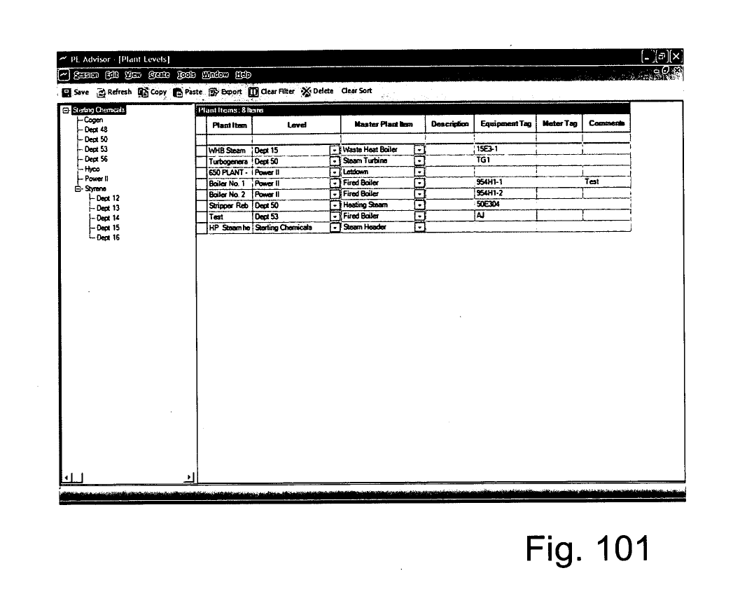

FIG. 102 is a screenshot output showing an aspect of the present invention.

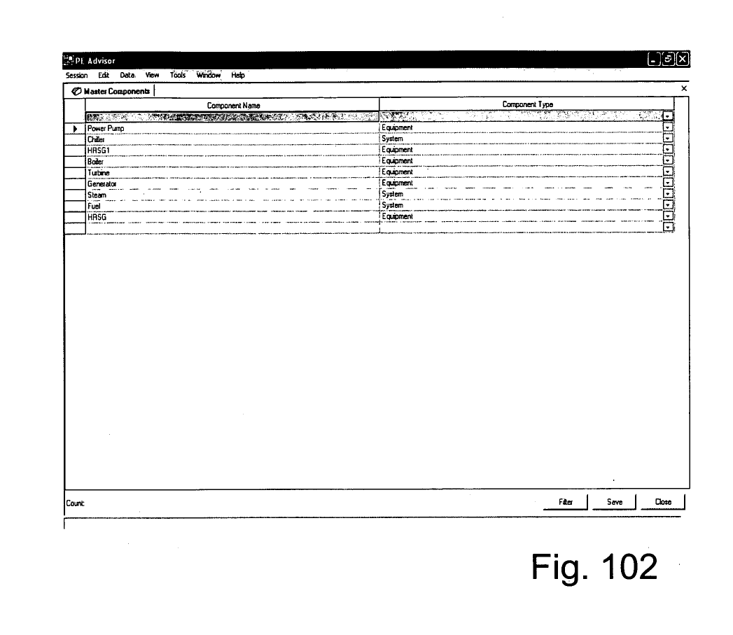

FIG. 103 is a screenshot output showing an aspect of the present invention.

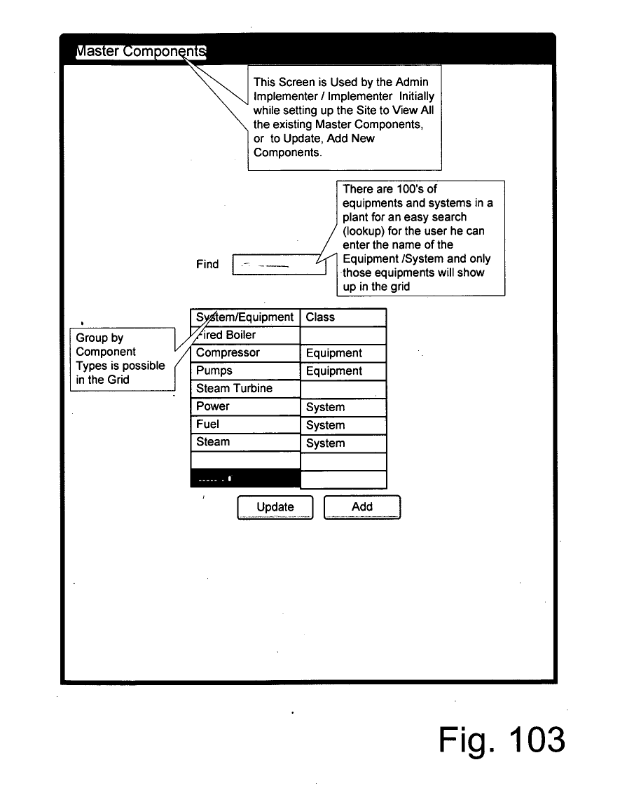

FIG. 104 is a screenshot output showing an aspect of the present invention.

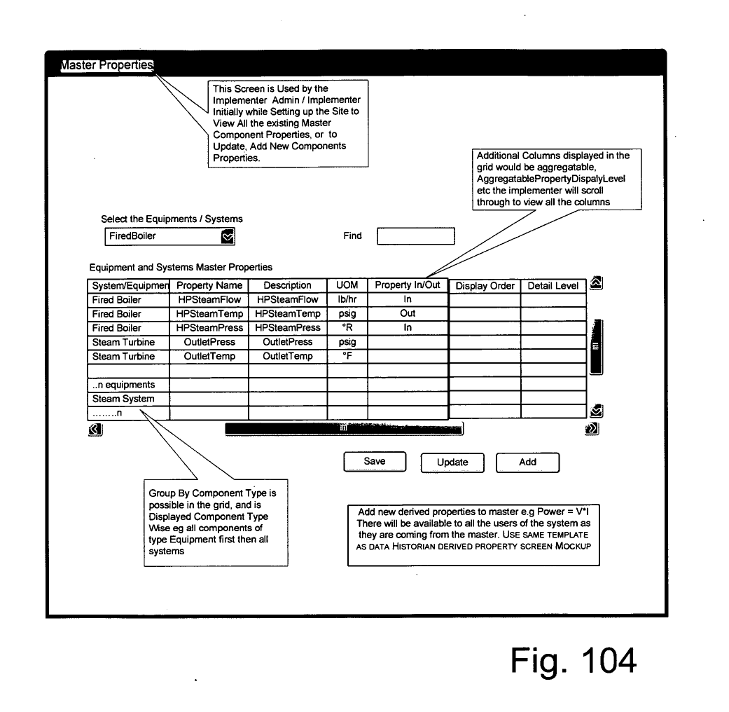

FIG. 105 is a schematic flow chart showing an aspect of the present invention.

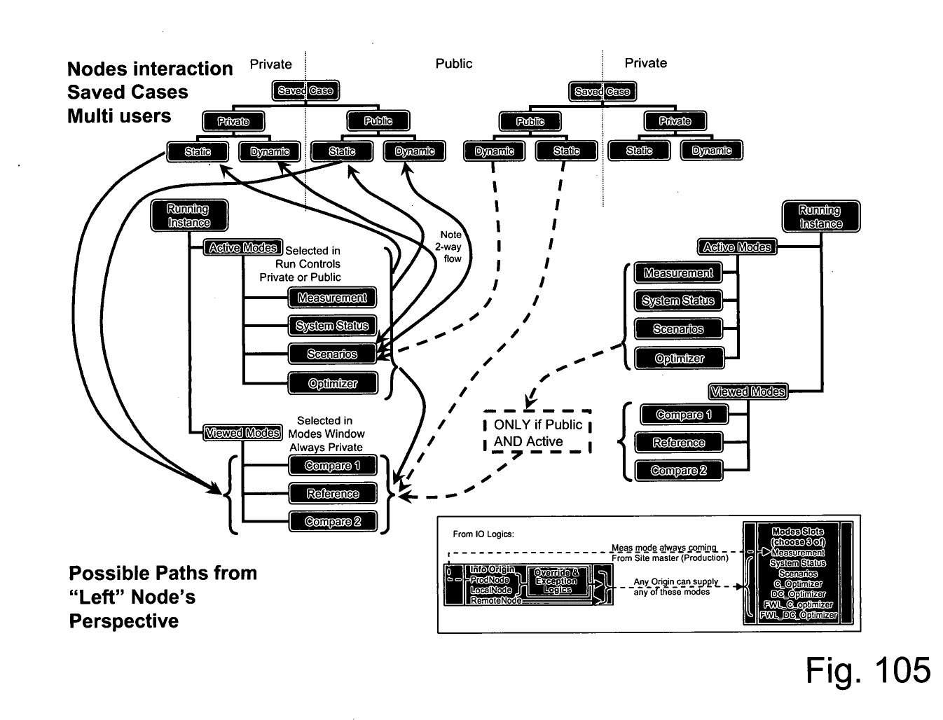

FIG. 106 is a schematic flow chart showing an aspect of the present invention.

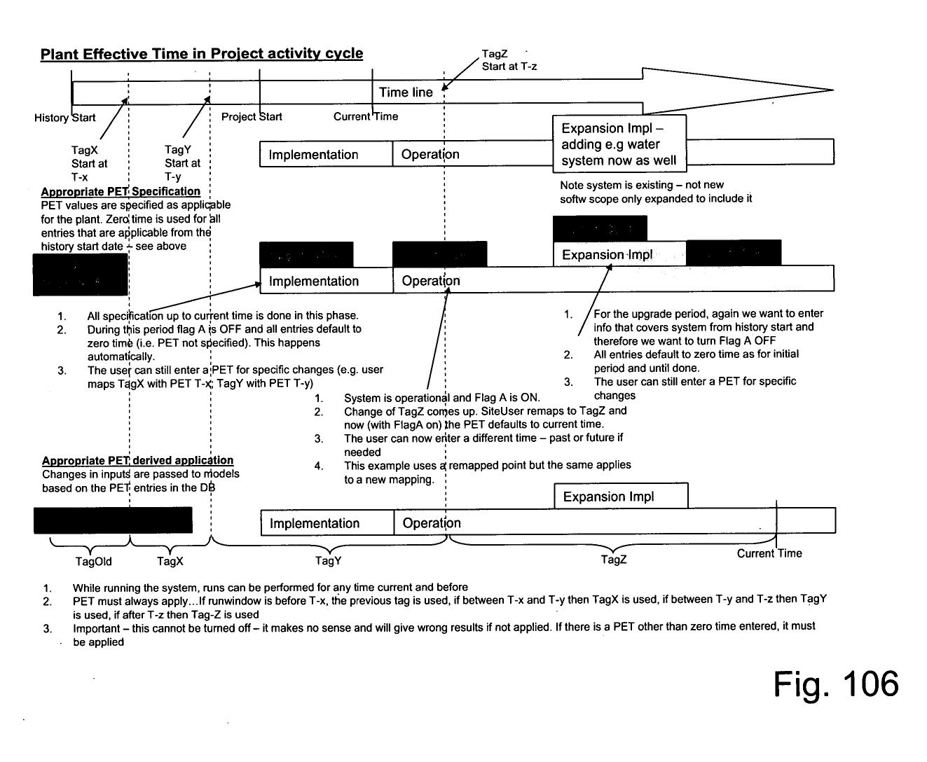

FIG. 107 is a screenshot output showing an aspect of the present invention.

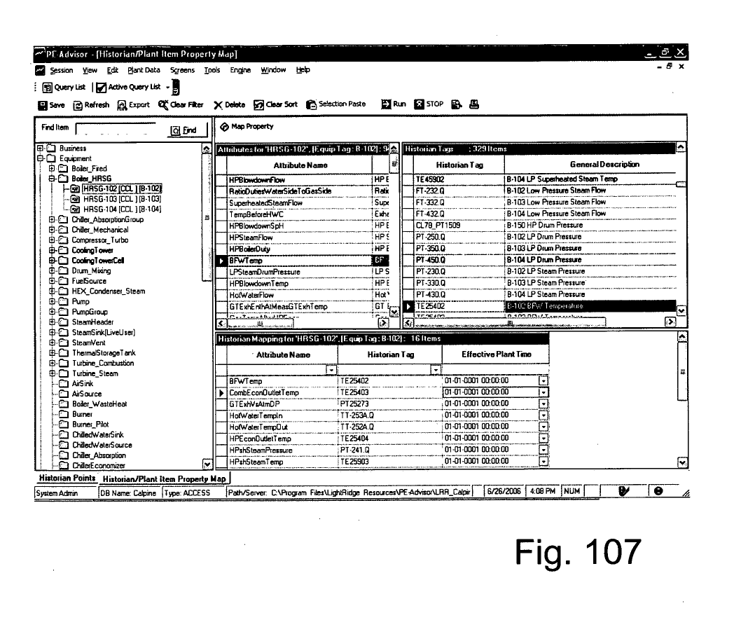

FIG. 108 is a screenshot output showing an aspect of the present invention.

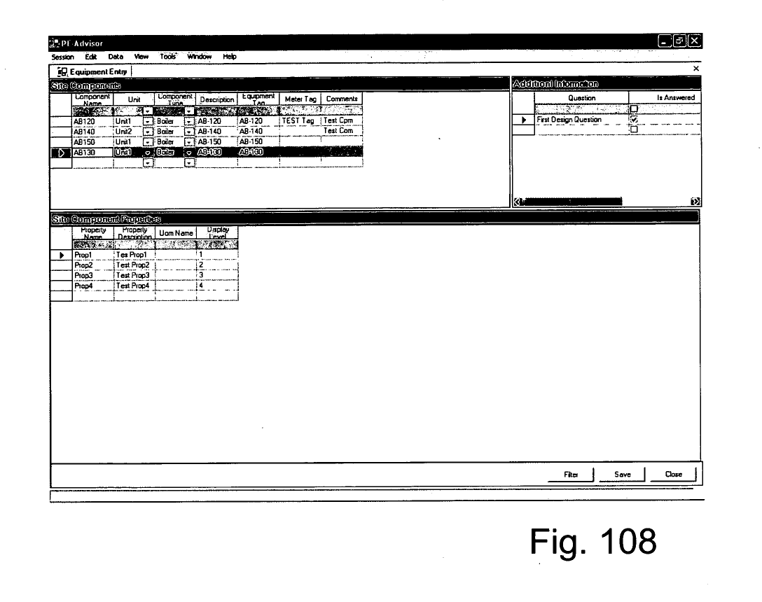

FIG. 109 is a screenshot output showing an aspect of the present invention.

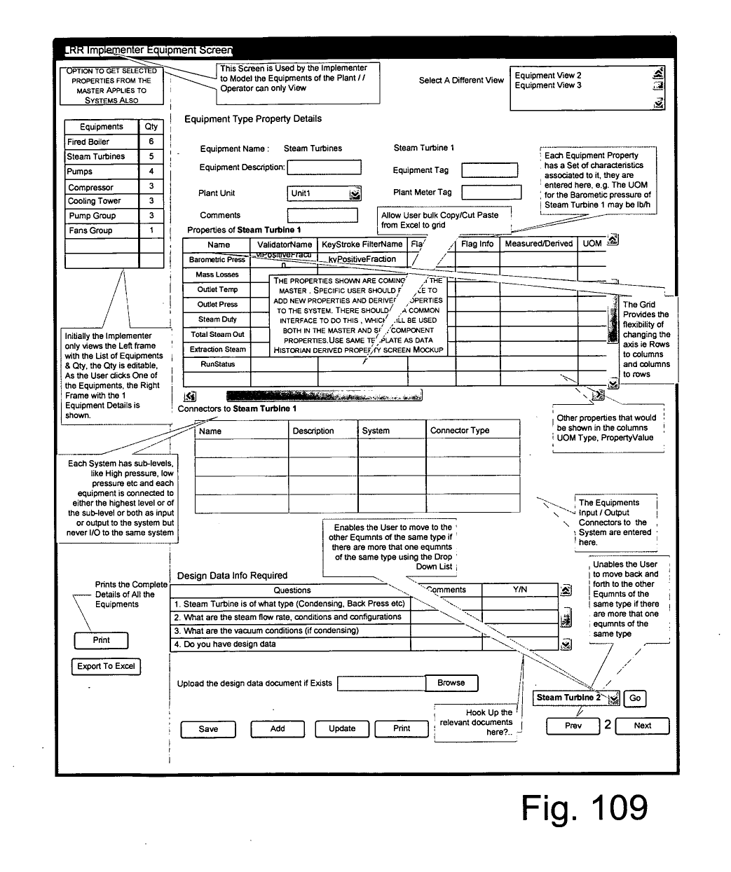

FIG. 110 is a screenshot output showing an aspect of the present invention.

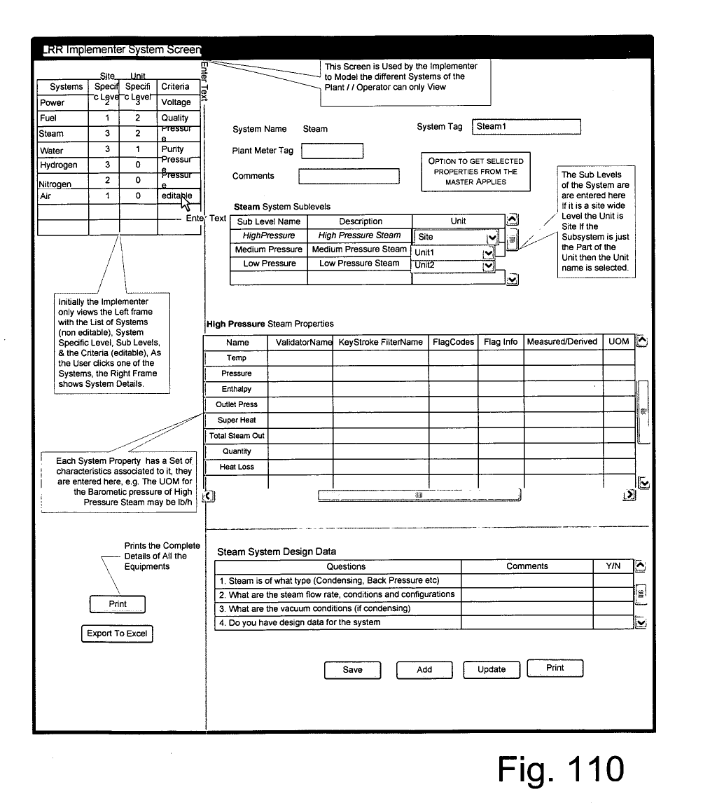

FIG. 111 is a screenshot output showing an aspect of the present invention.

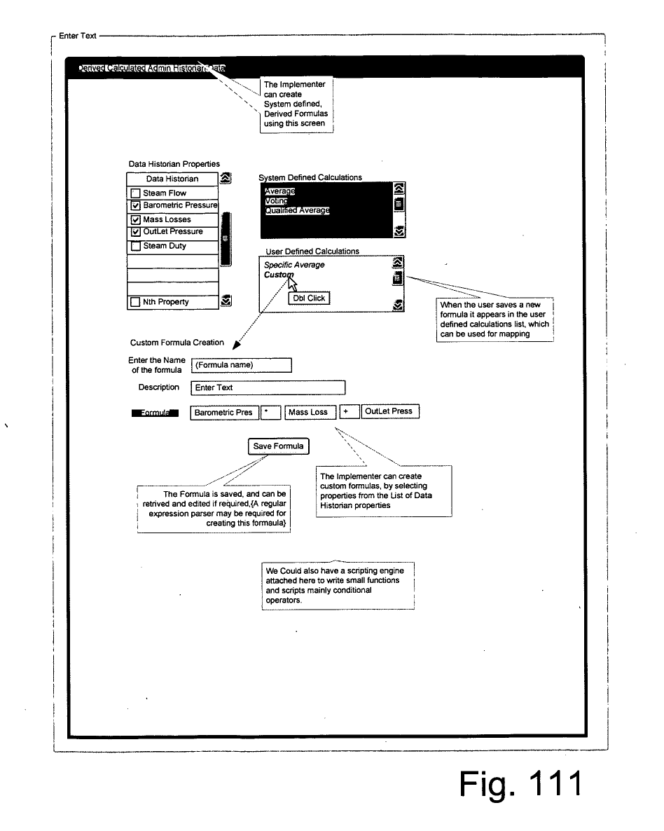

FIG. 112 is a screenshot output showing an aspect of the present invention.

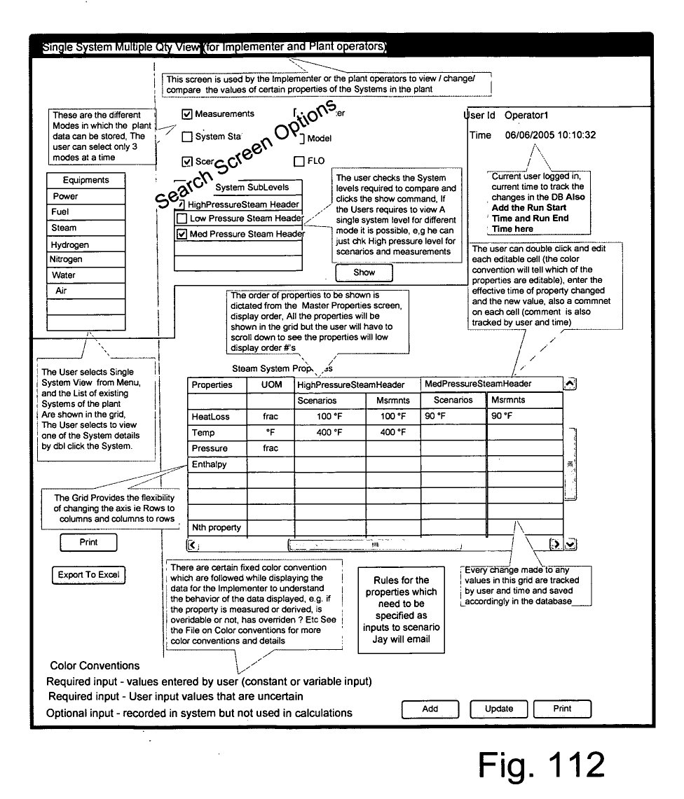

FIG. 113 is a screenshot output showing an aspect of the present invention.

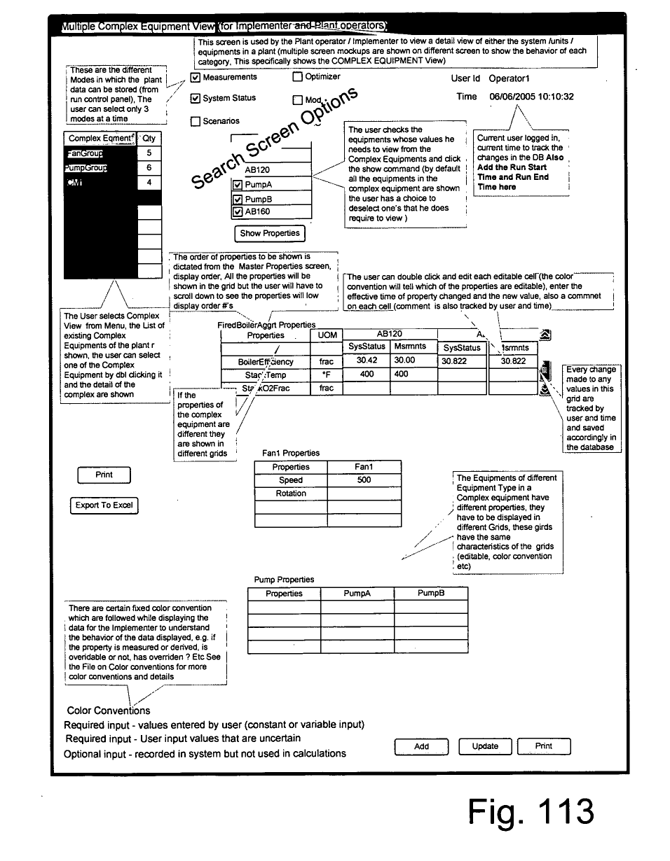

FIG. 114 is a screenshot output showing an aspect of the present invention.

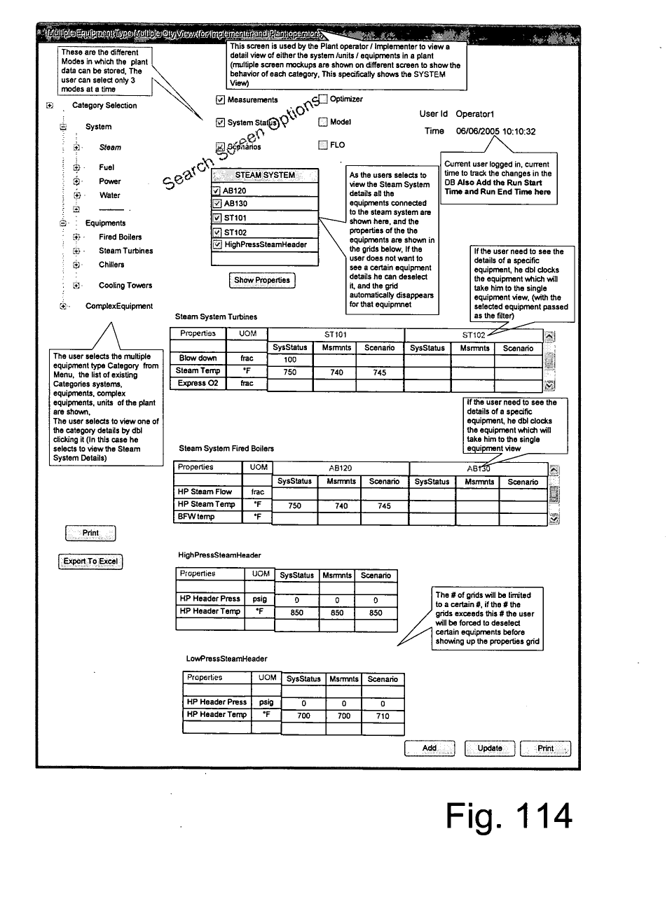

FIG. 115 is a screenshot output showing an aspect of the present invention.

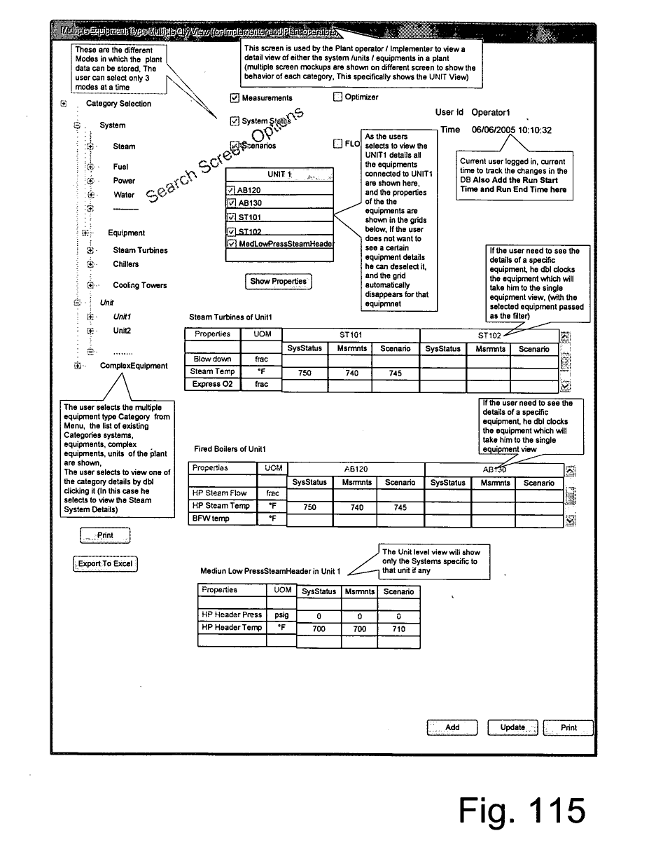

FIG. 116 is a screenshot output showing an aspect of the present invention.

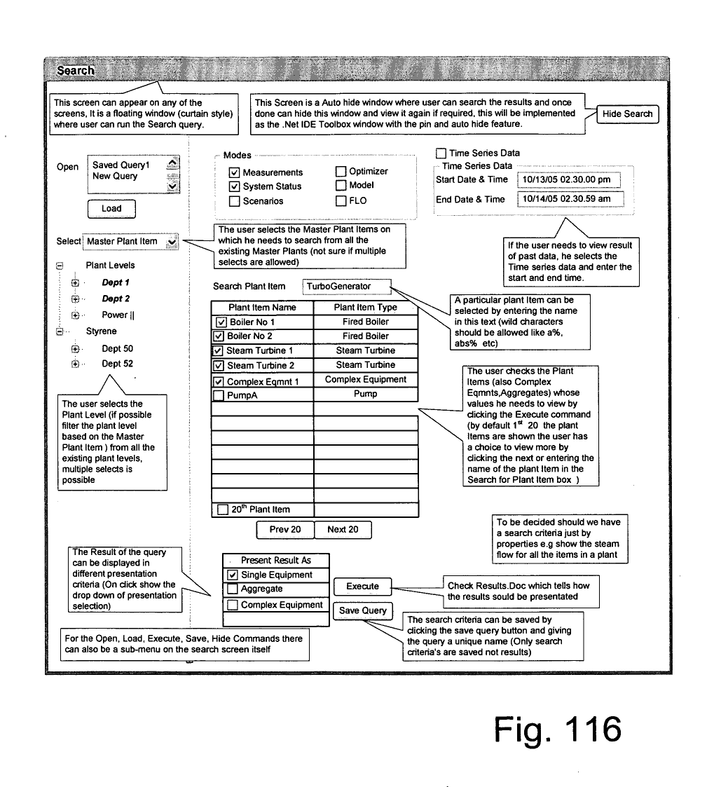

FIG. 117 is a schematic relationship chart showing an aspect of the present invention.

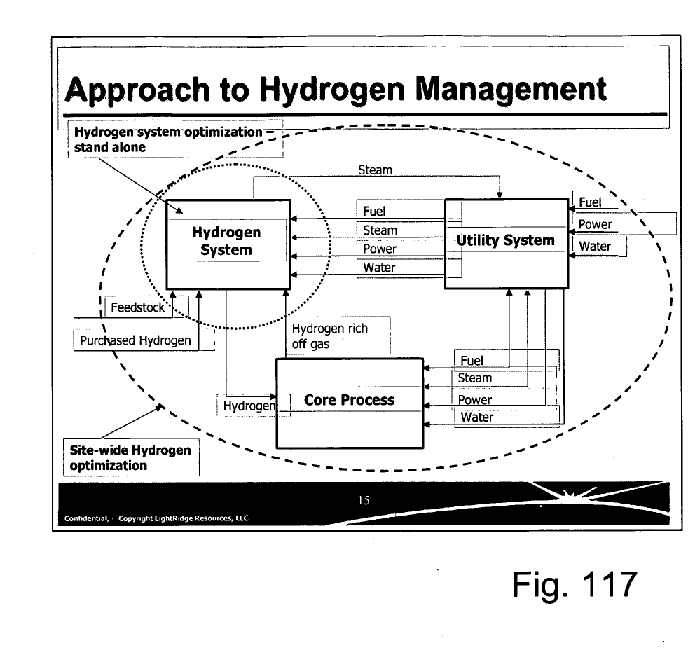

FIG. 118 is a schematic relationship chart showing an aspect of the present invention.

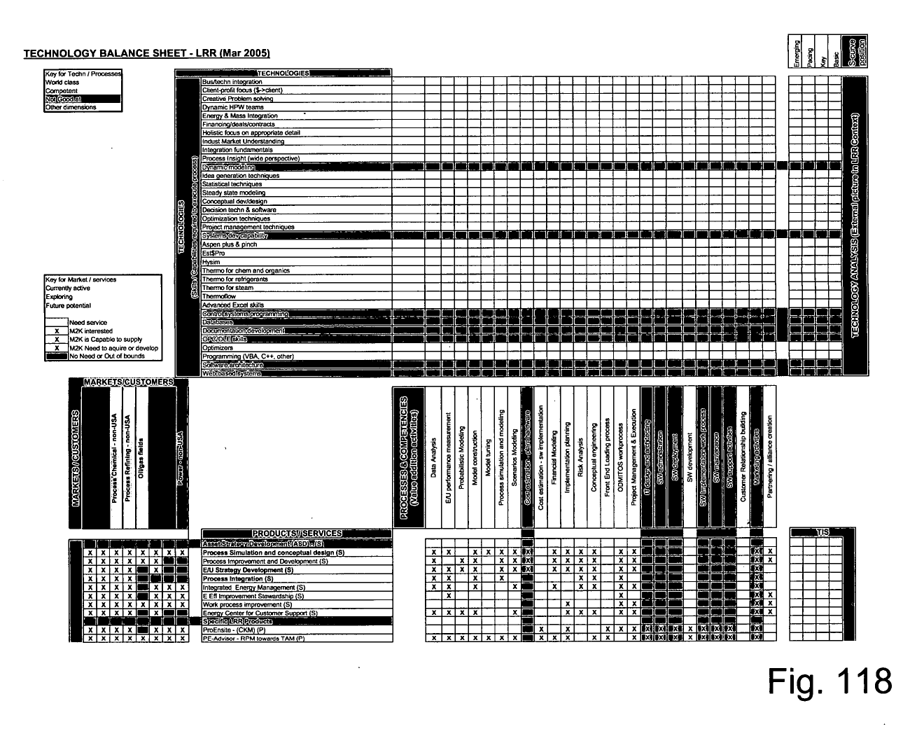

FIG. 119 is a schematic relationship chart showing an aspect of the present invention.

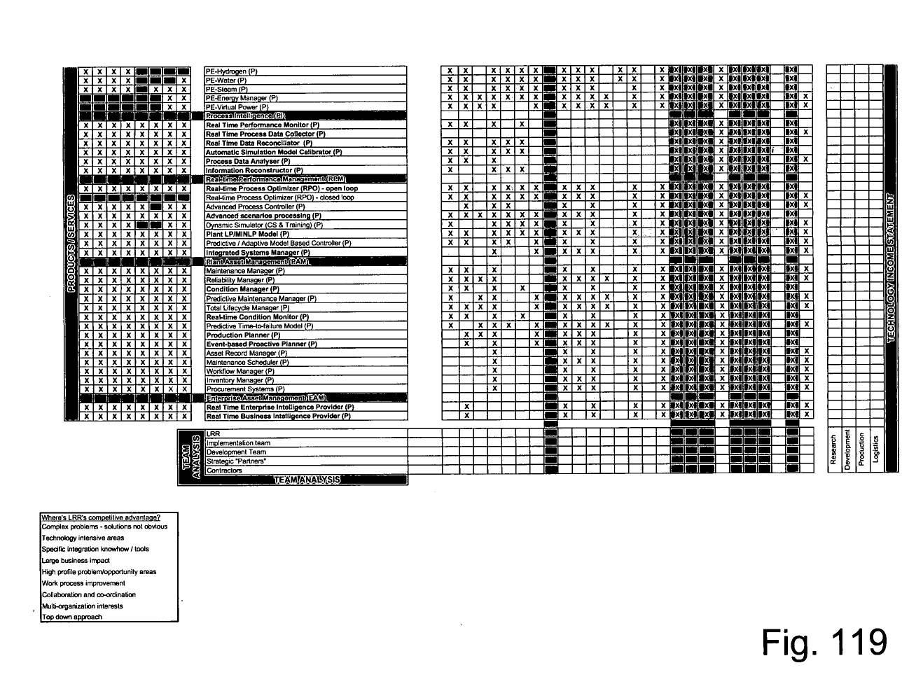

FIG. 120 is a hierarchy chart showing an aspect of the present invention.

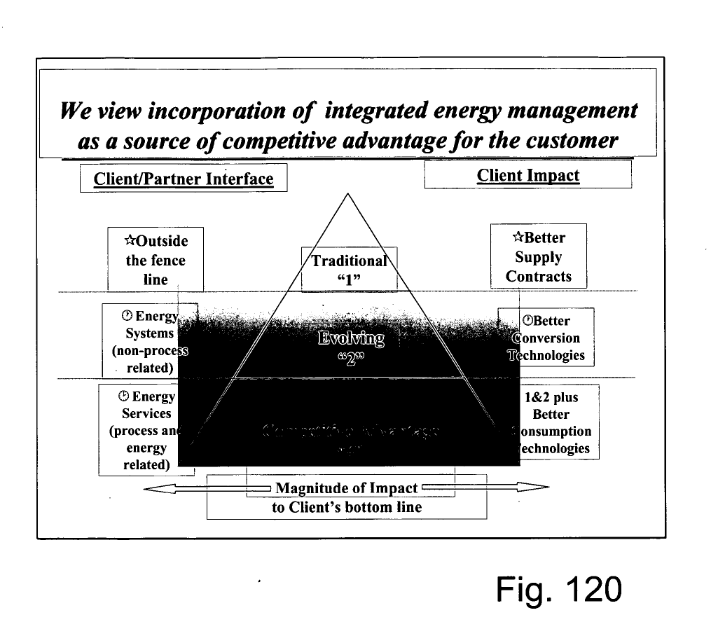

FIG. 121 is a schematic relationship chart showing an aspect of the present invention.

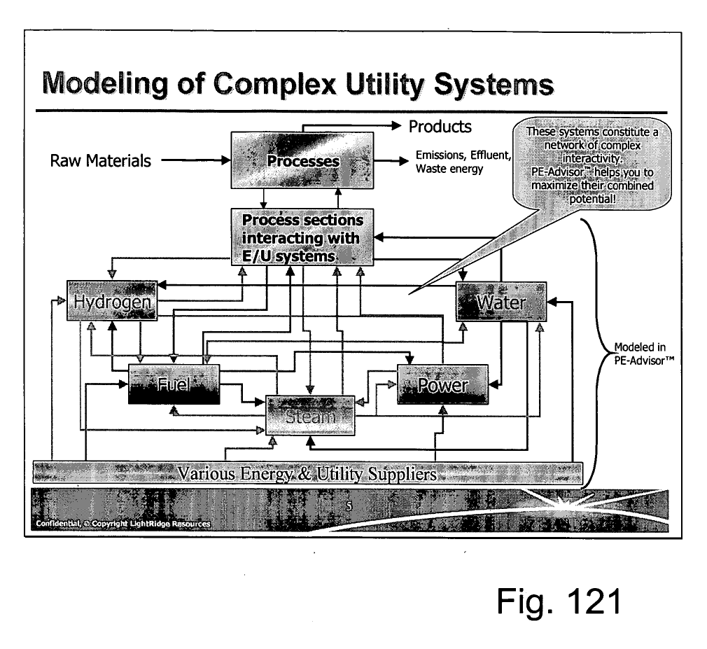

FIG. 122 is an output graph showing an aspect of the present invention.

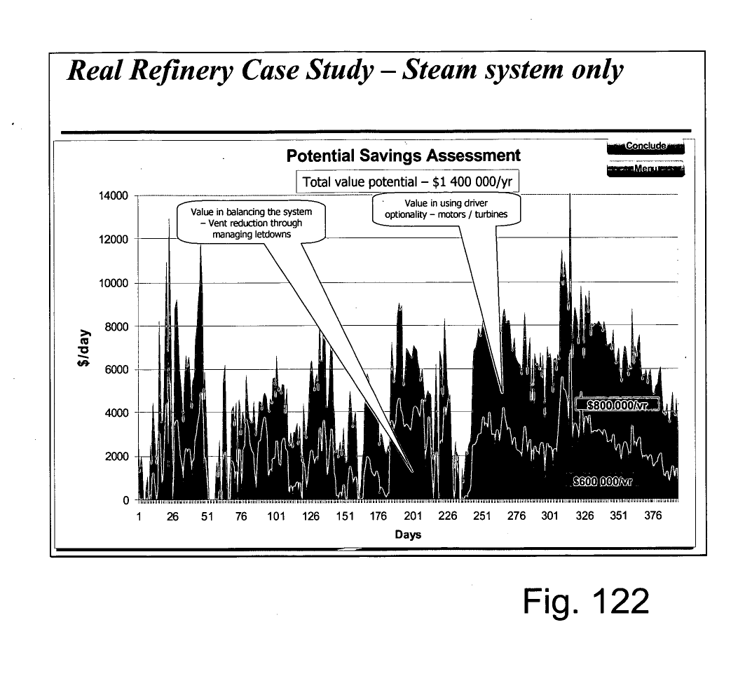

FIG. 123 is a schematic relationship chart showing an aspect of the present invention.

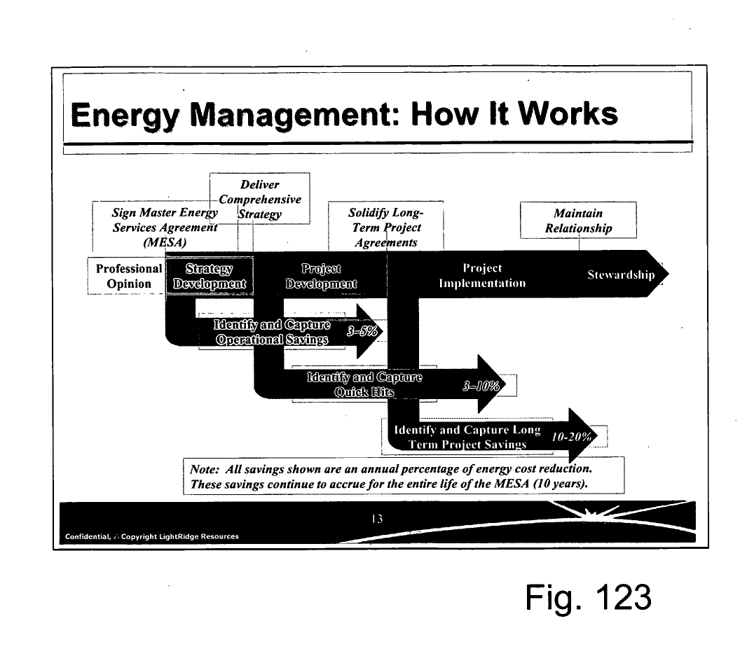

FIG. 124 is a schematic relationship chart showing an aspect of the present invention.

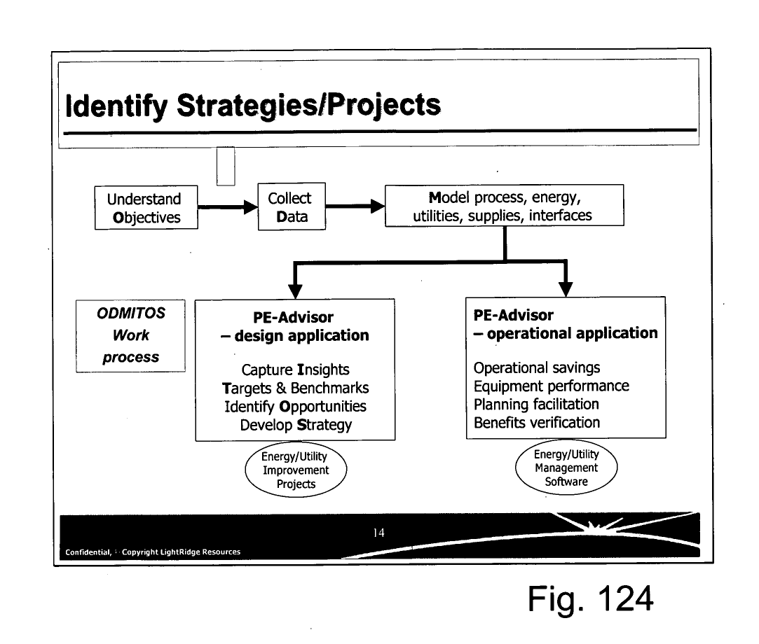

FIG. 125 is a schematic flow chart showing an aspect of the present invention.

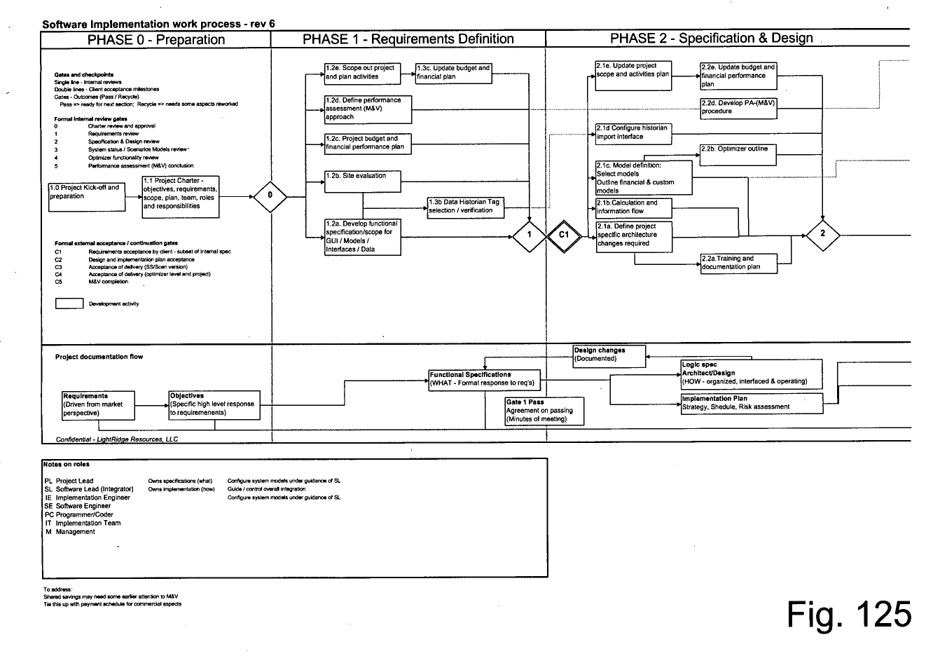

FIG. 126 is a schematic flow chart showing an aspect of the present invention.

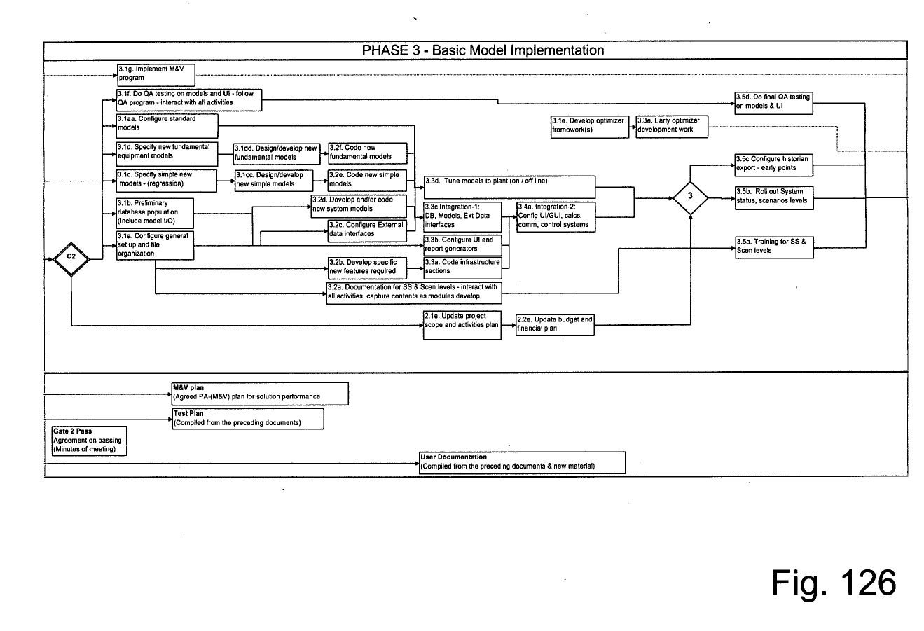

FIG. 127 is a schematic flow chart showing an aspect of the present invention.

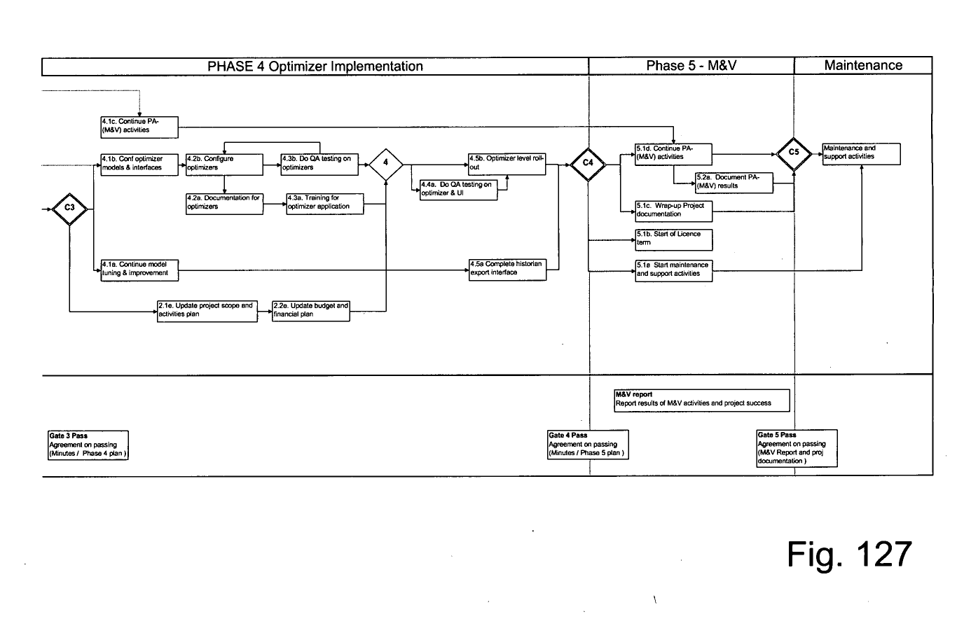

### DETAILED DESCRIPTION

The problem.

Energy and utility optimization is one of the key issues facing industrial process, power and institutional facilities today. Generally process plants are well instrumented on the process side of the systems (chemicals being processed). However the utility side (media used for heating and cooling, separation and to do work) the metering is generally very sparse and not as well maintained as the process side. Data are generally abundant but not useful for decision making as data are rarely consistent and accurate enough in the raw format so that huge discrepancies go unnoticed and typically lead to sub-optimal operations and wrong decisions.

Utility systems transporting commodities in plants are highly complex in configuration and therefore difficult to operate optimally as the optimal point is dynamic, influenced by many internal and external factors, complex to determine and not obvious. This leads to significant energy and species loss as well as monetary value loss. Minimizing energy and species consumption is not only a business problem but especially also an environmental and sustainable earth problem.

Furthermore, in the power market especially (but not exclusively) the demand varies a lot through the day, giving rise to the problem all power generators and consumers face—that of deciding what capacity to invest in—considering where peak pricing will pitch as a result (as far as the generator is concerned) and investment in self generation to offset peak pricing (as far as the consumer is concerned). The result is that plants have power generation ability installed but through the collective operation of a multitude of smaller pieces of equipment versus the large generators of power generating companies. These assets however are managed by plants without the direct exposure to the market pricing dynamics that power suppliers face and are also shielded from these through longer term supply contracts. The result is that there is, collectively, a large body of potential power generators already installed (but underutilized) and these generators can provide power at marginal rates that are generally substantially lower than the market rates (especially during peak times).

The solution.

ESUMS (Energy-Species-Utility Management System) is a methodology, integrated software system and IT infrastructure arrangements configured to efficiently and comprehensively address the stated problems above. It will incorporate 1, 2 or 3 (depending on plant requirements and consortium composition) of LRR's process energy software products (PE-Advisor™ (in development), PE-Dispatch Manager™ (future) and PE-Virtual Power™ (future)) arranged in co-operative fashion to achieve the collective ESUMS goals.

This invention covers the complete ESUMS system, methodology and also all three products and their independent and/or co-operative application.

This invention is about: 1) reducing the energy/species consumption at commodity customer sites to optimize individual site operation and 2) harnessing the collective potential of a number of power generating and consumer sites for making power available to power suppliers through the distributed installed base of “small” generators.

This invention includes an integrated technical and business methodology embedded in an integrated software suite (family of software products) and applied through an IT system created through the integration of various IT components at multiple client sites (multiple clients each with one or more sites—co-operating in a consortium or co-operative fashion).

The Invention is a multi-layered, Three-tiered, Simultaneous Multi-modal, Integrated Energy and/or Chemical Species Management System (ESUMS) applied to the Utility systems in process plants, power plants, district energy and utility plants and any other industrial facilities that produce or consume energy and chemical species. It involves integrated management and coordination of the plant process information and business information; the physical energy and/or chemical species commodities; the utility assets used to transport and process them and also the business processes that support their management and operation.

The invention overcomes the problem of silo operation of multiple, large software tools through an approach of integrating the essence of the functionality of all those tools that would be required to make the best decisions in the energy and chemical species (E/CS) management space without duplicating the much more elaborate complete tools available in the market. The principle is thus to ensure data quality and information generated is of high integrity but to do so through the minimum functionality addition required. As a result the invention includes essential elements of the following technologies (only the essence) in various degrees and applied only to the data that matters in the E/CS decision space. This leads to results that are much more accurate and reliable and therefore better operating, tactical and strategic decisions. The essential elements integrated into this are related to Process intelligence (Real time performance monitoring, Real Time Data Reconciliation, Real Time Process Data Collection, Process Data Analysis, Information Reconstruction, Real Time Simulation Model Calibration); Near-Real-time Performance Management (Integrated Systems Modeling, Utility System MINLP Modeling, Near-Real-Time Process Optimization, On-line Process Optimization; Asset Strategy Development (Scenarios Modeling, Process Integration, Process Simulation); Enterprise Asset Management (Production Planning, Real Time Condition Monitoring, Real Time Enterprise Intelligence, Event-Based Proactive Planning, Procurement Management, Maintenance Scheduling)

The invention can be applied to both Energy and Chemical Species in an integrated way or to any one of the two independently depending on the needs of the plant site. E.g. in a power plant the E-application will be relevant while the CS-application will and relevant in a waste water treatment plant and the integrated E/CS-application in a refinery or pulp and paper plant.

“E/CS” for the purpose of this patent means all utility commodities (Energy and Chemical Species) that are handled through utility systems and used as utilities in some form or the other in these industries (Examples are various fuels and waste fuels, electricity, steam, hydrogen, nitrogen, air, water, chilled water and others).

Solution structure.

The Invention's proposed method is applied in various hierarchical recursions. At the lowest recursion the method is applied through a PE-Advisor™ system. This system can be applied for a collection of plant units (focused on optimization of utility systems within individual or grouped plant units) or for the total site to drive global optimization for the site (more common scope). This is the 1^{st} Tier. To further extend the reach and value addition of the method, another tier called PE-Dispatch Manager™ can be included to coordinate a group of plant sites and optimize the dispatch of products from the various sites. This is mainly focused on the power generation industry and not a requirement for the overall system. It is rather an optional intermediate layer that can be used to simplify the job of the top layer or, for smaller scope like a fleet of power generating plants, can be used as the top layer but then without the virtual power aspect. If the 2^{nd} tier is present, it interacts with the total site PE-Advisor™ systems to coordinate and optimize utilities amongst the different sites in an enterprise. Finally a top tier called PE-Virtual Power™ could be added to interact with markets (demand and pricing) and to lead the consortium elements through the PE-Advisor™ systems at each site (and/or the PE-Dispatch Manager™ systems where applicable) to drive operations such that opportunities in the market fluctuations can be exploited; determine best overall use/dispatch of power generation assets for the utility company; exploit the unused capacity for power generation in distributed utility company customer sites and make this additional power available to the market as “virtual power”—power created without increasing load on the utility companies assets.

All these different tiers of the method are focused on improving business top and bottom-line results through focus on utility efficiency at the site and consortium levels. The method can be applied to various hierarchical levels i.e. all the higher levels are not necessarily required for the system to add value to the enterprise. Higher levels can be added in discretionary fashion to increase the reach of the system. Each higher level applies similar methodology but is configured differently and operates on different energy and utility related variables in the enterprise or broader consortium. The PE-Virtual Power™ tier is required to apply the system to the consortium level and it does require the base layer (PE-Advisor™) or some similar technology at each consortium site.

PE-Advisor™ is an economic-centric energy/utility performance management tool that utilizes advanced engineering models and techniques as a basis for monitoring and providing near-real-time visibility to energy/utility activities, driving operating improvements and efficiencies and developing asset strategies. It is applied globally in a total-site, integrated-systems approach wherein the purchase, supply and usage of energy and utilities are modeled and optimized to support energy management business objectives. It is used to Monitor energy/utility asset performance and emissions in near-real-time to comprehend a facility's global energy/utility infrastructure, operations and spend; Optimize energy/utility systems operations; Perform “what-if” analysis on a historical, near-real-time and predictive basis; Proactively manage energy supply contracts and exports (grid/general market or cogeneration); Monitor, track and manage to emissions limits; Improve utilities supply planning and demand forecasting and predict impacts from anticipated changes in production demands and other dynamic variables; Analyze and verify energy impacts of investments in the facilities; Act as a common platform to facilitate collaborative risk management and decision support across the total organization; Improve utilities supply planning and demand forecasting and predict impacts from anticipated changes in production demands and other dynamic variables; Analyze and verify energy impacts of investments in the facilities.

Act as a common platform to facilitate collaborative risk management and decision support across the total organization. The PE-Virtual Power™ tier is focused around making excess generation capacity from industry available to the power market. For a single site, this can be done with only the first tier installed. As more sites are added, the total optimization problem becomes more complicated and generally more and higher tier systems will be required to optimize overall consortium profitability. However some of this benefit (from virtual power sales) can also be captured through the 1^{st} tier functions of marginal cost calculations and decision support regarding when it is profitable to make power available even though it will be more difficult to drive to the optimal point.

The invention is also multi-modal. The following modes are typically available at the 1^{st} tier: Measurements mode; System Status mode; Scenarios mode (static and dynamic); Continuous Optimization mode at point in time; Forward-looking Continuous Optimization mode; Discontinuous Optimization mode at point in time; Forward-looking Discontinuous Optimization mode. Each one of the tiers can operate simultaneously in multiple modes. For example a node can operate simultaneously in the measurement, system status, scenarios and one of the four optimization modes. The invention can also operate with historical, current and forward looking perspective.

The method also includes a business process automation layer (BizPAL) in a different dimension at each of these levels. To further enhance the results, the BizPAL layer focuses on business process effectiveness by interacting with or driving relevant business processes. Relevant business processes are those business activities that relates to the energy and utility information and operation of the site. This layer is not a requirement but rather further enhancement.

Furthermore various alternative schemes are envisaged to, independently or in co-operative fashion, administer and manage the real time forecasting of demand and supply as well as the trading of such virtual power capacity. The following options are considered at this stage: Trading on an auction basis between power houses and industrial plants with virtual capacity; Trading through online, streaming data supply platforms like for example “Nrgstream”; Incentives through pricing contracts; Direct, co-operative arrangements with co-running optimization systems; Trading via normal trading channels augmented with accurate information from the different tiers of this invention.

The concept of Virtual power has been tested on a year's data for ERCOT and indications are that it has potential for significant financial impact for a consortium as described here or for individual plants wanting to make some arrangements along these lines with their commodity suppliers. Further extensions of functionality at any/all tiers are also envisaged to enhance the value addition capability of the method. Examples are the inclusion of statistical process control applied to the key energy indices and measurements; automated analysis of trends and data relationships to provide additional insight; automated regeneration of the equipment performance models and inclusion of special reports and outputs to support six sigma initiatives.

Solution Elements.

Technical and Business Integration and comprehensive method—An integrated technical and business method for comprehensive, integrated ESUM and optimization;

Automation—An automated methodology of data processing and information generation aimed at regular advisory feedback to the user based on a concept of dual, reversed models to support scenarios capability whilst providing a complete and detailed reference case to compare against;

Calculation engine and data—Process modeling methodology and techniques that, apart from standard techniques, also involve specific techniques like a hybrid sequential modular and simultaneous equation method that takes advantage of sub system characteristics to improve solving speed. The problem is arranged differently depending on solving purpose (e.g. for the simulation purposes vs. optimization). The main target here is execution speeds well beyond normal flow sheet simulator performance.

Model calibrations—A methodology of automatic model calibration that performs calibration of the process as well as business models during every execution run

Contract modeling—Supply contract modeling that incorporates predictive modeling into optimization objective function through controlled smooth-blending of discontinuities in supply contracts coupled with load profiles and auto-calibration of such load profiles.

BizPAL—A Business Process Automation Layer interfaced around the utility system advisory service and for which the operator can tailor or select specific applicable work processes for inclusion.

System/IT section—A dynamic, flexible and extensible data system for capturing, controlling and managing plant simulation model configuration, inputs, execution and outputs, the method including but not limited to tracking/allowing changes in model inputs and configuration by user, mode, time and plant effective time; sharing data and results from different ESUMS information generation sources in an integrated and open system with user selectable layout.

Virtual Power—defined as power that is generated for the market indirectly through a method for determining the collective optimal point across assets for the supply of a given load level of MW capacity at the lowest overall cost, and the systems required to co-ordinate the generation and trading of such power

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Thus, the foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to explain the best mode for practicing the invention, and to enable others skilled in the art to utilize the invention and such or other embodiments and with various modifications required by the particular applications or uses of the invention. It is intended that the appended claims be construed to include alternative embodiments to the extent that is permitted by prior art.

What is claimed is:

1. A method for performance management of industrial plants, the method comprising the steps of:
establishing at least one plant unit, each plant unit being associated with at least one plant site;
establishing at least one plant site, each plant site being associated with at least one business enterprise;
collecting plant data for at least one of said at least one plant unit;
collecting business data;
collecting market data;
collecting meteorological data;
filtering said collected plant data, business data, market data, and meteorological data, thereby producing filtered data;
performing data validation and status detection on said filtered data, thereby producing validated data;
applying a first model to said validated data;
generating a system status representation of at least one of said at least one plant unit based on said filtered data and said first model;
applying said system status representation for calibration of a second model;
applying said second model for generation of what-if scenarios; and
selecting at least one processing step from a group of processing steps, said group of processing steps comprising:
determining optimized conditions for at least a portion of the operation of at least one of said at least one plant unit;
identifying at least one required operating condition deviation for at least one of said at least one plant unit; and
translating said at least one required operating condition deviation into operational advice; and
executing said at least one processing step.
